(19) United States
(12) Patent Application Publication
(10) Pub. No.: US 2009/0171998 A1
(43) Pub. Date: Jul. 2, 2009

(54) SYSTEM AND METHOD FOR CAPTURING AND STORING HOSPITALITY INFORMATION IN A RELATIONAL DATABASE SYSTEM

(76) Inventors: Pieter Lessing, Los Angeles, CA (US); David Hubbard, Greensboro, GA (US); Mark Crosby, Venice, CA (US)

Correspondence Address: JAMES M. STOVER;TERADATA CORPORATION, 2835 MIAMI VILLAGE DRIVE, MIAMISBURG, OH, 45342, US

(21) Appl. No.: 12/339,807

(22) Filed: Dec. 19, 2008

Related U.S. Application Data
(60) Provisional application No. 61/018,128, filed on Dec. 31, 2007.

(51) Int. Cl. G06F 17/30

(52) U.S. Cl. 707/101; 707/E17.045

(57) ABSTRACT

A database management system for a hospitality business. The database management system comprises a relational database for storing information concerning customers of the hospitality business and customer activities, activities hosted by the hospitality business, and products and services provided by the hospitality or gaming business. Data is stored and organized within the database in accordance with a logical data model comprising a plurality of entities and relationships organized within subject areas defining the manner in which the information concerning customers, dining services, group activities, room services and charges, and other products and services is stored and organized within the relational database.

### CROSS REFERENCE TO RELATED APPLICATIONS

This application claims priority under 35 U.S.C. §119(e) to the following co-pending and commonly-assigned patent application, which is incorporated herein by reference:

Provisional Patent Application Ser. No. 61/018,128, entitled “SYSTEM AND METHOD FOR CAPTURING AND STORING HOSPITALITY INFORMATION IN A RELATIONAL DATABASE SYSTEM”; filed on Dec. 31, 2007 by Pieter Lessing, David W. Hubbard, and Mark L. Crosby.

This application is related to the following co-pending and commonly-assigned patent applications, which are incorporated by reference herein:

application Ser. No. 10/027,967, entitled “SYSTEM AND METHOD FOR CAPTURING AND STORING BUSINESS INFORMATION FOR THE TRAVEL AND TRANSPORTATION INDUSTRIES”; filed on Dec. 21, 2001 by Pieter Lessing, William Black, John Kumar, David Hubbard, and Kim Nguyen-Hargett;

application Ser. No. 10/888,765, entitled “SYSTEM AND METHOD FOR CAPTURING, STORING AND ANALYZING REVENUE MANAGEMENT INFORMATION FOR THE TRAVEL AND TRANSPORTATION INDUSTRIES”; filed on Jul. 9, 2004 by Pieter Lessing, David W. Hubbard and Sreedhar Srikant; and

application Ser. No. 11/016,002; entitled “SYSTEM AND METHOD FOR CAPTURING, STORING AND ANALYZING TRANSACTION AND INTERACTION INFORMATION FOR THE HOSPITALITY AND GAMING INDUSTRIES”; filed on Dec. 17, 2004 by Sreedhar Srikant, Norman C. Nicholl, Gregory P. Churak, and Pieter Lessing.

### FIELD OF THE INVENTION

The present invention relates generally to Data Warehouse solutions, and more particularly, to systems and methods for capturing, storing and using detailed transaction and interaction information for hospitality industries. Still more particularly, the present invention is related to a logical data model to logically model the key business information needs of the Hospitality industry from an enterprise perspective, with focus on Lodging, Special and Group Events, and Fine Dining venues.

### BACKGROUND OF THE INVENTION

The Enterprise Data Warehouse (EDW) has proved a strategic weapon for most modern organizations. It should be active, dynamic and flexible in order to cope with changing business requirements. It should provide a strategic background to support changing consumer-provider relationships.

The foundation of the enterprise data warehouse is a comprehensive and responsive logical data model addressing challenges in the near future without compromising existing business processes. A logical data model is a graphical representation of the way data is organized in a data warehouse environment. The logical data model specifically defines which individual data elements can be stored and how they relate to one another to provide a model of the business information. The data model ultimately defines which business questions can be answered from the data warehouse and thus determines the business value of the entire decision support system.

A properly designed LDM provides a foundation for more effective sales, marketing and customer management and supports the customer relationship management (CRM) requirements related to identifying, acquiring, retaining and growing valuable customers. A logical data model for the hospitality industries reflects the operating principles and policies of these industries and provides the underlying structure for the data imported into the data warehouse.

### BRIEF DESCRIPTION OF THE DRAWINGS

The present invention is illustrated by way of example, and not by limitation, in the Figures of the accompanying drawings, wherein elements having the same reference numeral designations represent like elements throughout and wherein:

FIG. 1 provides an overview of the hardware components of a data warehouse system;

FIG. 2 illustrates the core, industry, revenue management, and casino segments supported by a travel and hospitality logical data model, in accordance with the preferred embodiment of the present invention;

FIGS. 3A through 3R, taken together, provide a conceptual data model view of a travel and hospitality logical data model (LDM) illustrating the most important entities in the LDM and how they generally relate to each other, in accordance with the preferred embodiment of the present invention;

FIG. 4 illustrates an entity-relationship diagram of the ACCOUNT (DEFINITION) Subject Area of the logical data model in accordance with the preferred embodiment of the present invention;

FIG. 5 illustrates an entity-relationship diagram of the ACCOUNT (LOYALTY) Subject Area of the logical data model in accordance with the preferred embodiment of the present invention;

FIG. 6 illustrates an entity-relationship diagram of the ADDRESS (CONTACT) Subject Area of the logical data model in accordance with the preferred embodiment of the present invention;

FIG. 7 illustrates an entity-relationship diagram of the ADDRESS (GEOGRAPHY) Subject Area of the logical data model in accordance with the preferred embodiment of the present invention;

FIG. 8 illustrates an entity-relationship diagram of the ASSOCIATE LABOR Subject Area of the logical data model in accordance with the preferred embodiment of the present invention;

FIG. 9 illustrates an entity-relationship diagram of the DEMOGRAPHICS Subject Area of the logical data model in accordance with the preferred embodiment of the present invention;

FIG. 10 illustrates an entity-relationship diagram of the HOSPITALITY DINING TRANSACTION Subject Area of the logical data model in accordance with the preferred embodiment of the present invention;

FIG. 11 illustrates an entity-relationship diagram of the HOSPITALITY GROUP EVENT Subject Area of the logical data model in accordance with the preferred embodiment of the present invention;

FIG. 12 illustrates an entity-relationship diagram of the HOSPITALITY RETAIL PURCHASE Subject Area of the logical data model in accordance with the preferred embodiment of the present invention;

FIG. 13 illustrates an entity-relationship diagram of the HOSPITALITY ROOM CHARGES Subject Area of the logical data model in accordance with the preferred embodiment of the present invention;

FIG. 14 illustrates an entity-relationship diagram of the ITEM (HOSPITALITY) Subject Area of the logical data model in accordance with the preferred embodiment of the present invention;

FIG. 15 illustrates an entity-relationship diagram of the LOCATION (OVERVIEW) Subject Area of the logical data model in accordance with the preferred embodiment of the present invention;

FIG. 16 illustrates an entity-relationship diagram of the LOCATION (HOSPITALITY/CASINO) Subject Area of the logical data model in accordance with the preferred embodiment of the present invention;

FIG. 17 illustrates an entity-relationship diagram of the PARTY Subject Area of the logical data model in accordance with the preferred embodiment of the present invention;

FIG. 18 illustrates an entity-relationship diagram of the TRAVEL TRANSACTION (OVERVIEW) Subject Area of the logical data model in accordance with the preferred embodiment of the present invention;

FIG. 19 illustrates an entity-relationship diagram of the TRAVEL PURCHASE Subject Area of the logical data model in accordance with the preferred embodiment of the present invention;

FIG. 20 illustrates an entity-relationship diagram of the TRAVEL RESERVATION Subject Area of the logical data model in accordance with the preferred embodiment of the present invention; and

FIG. 21 illustrates an entity-relationship diagram of the TRAVEL TRIP EVENT Subject Area of the logical data model in accordance with the preferred embodiment of the present invention.

### BEST MODE FOR CARRYING OUT THE INVENTION

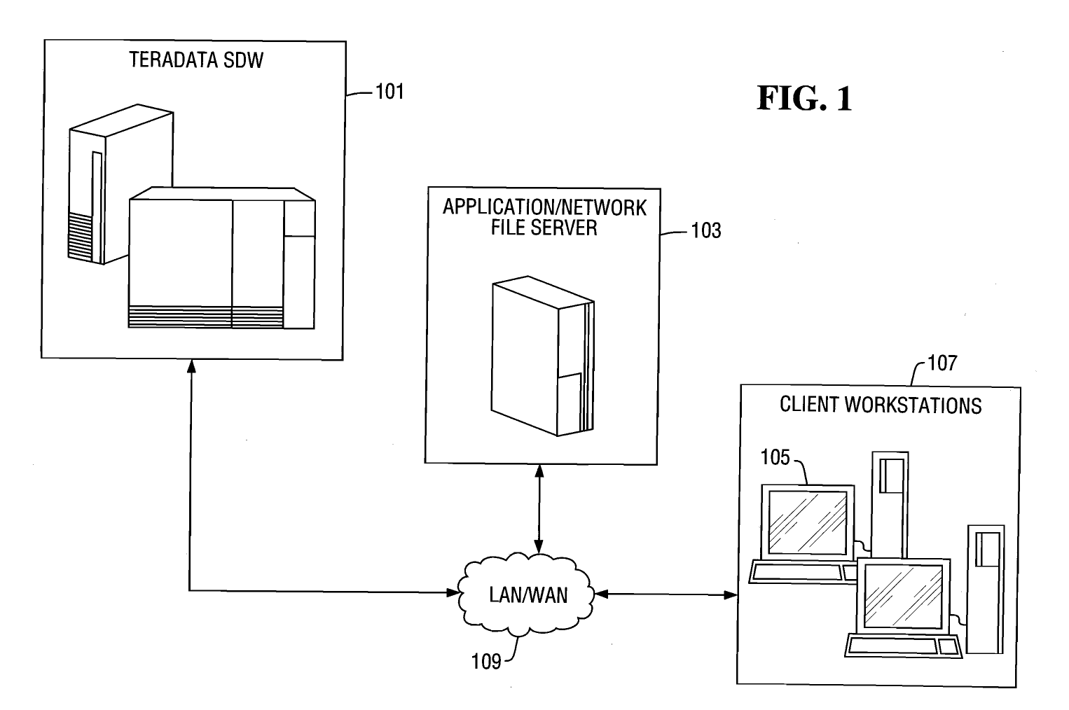

FIG. 1 provides an overview of the hardware required for a data warehouse solution solution. The basic components consist of an NCR Corporation Teradata Scalable Data Warehouse 101, an administrative server 103 supporting analytic and operations applications, and client and administrative workstations 105 and 107, respectively. The components communicate with each other through a Local Area Network (LAN) or Wide Area Network (WAN), identified by reference numeral 109.

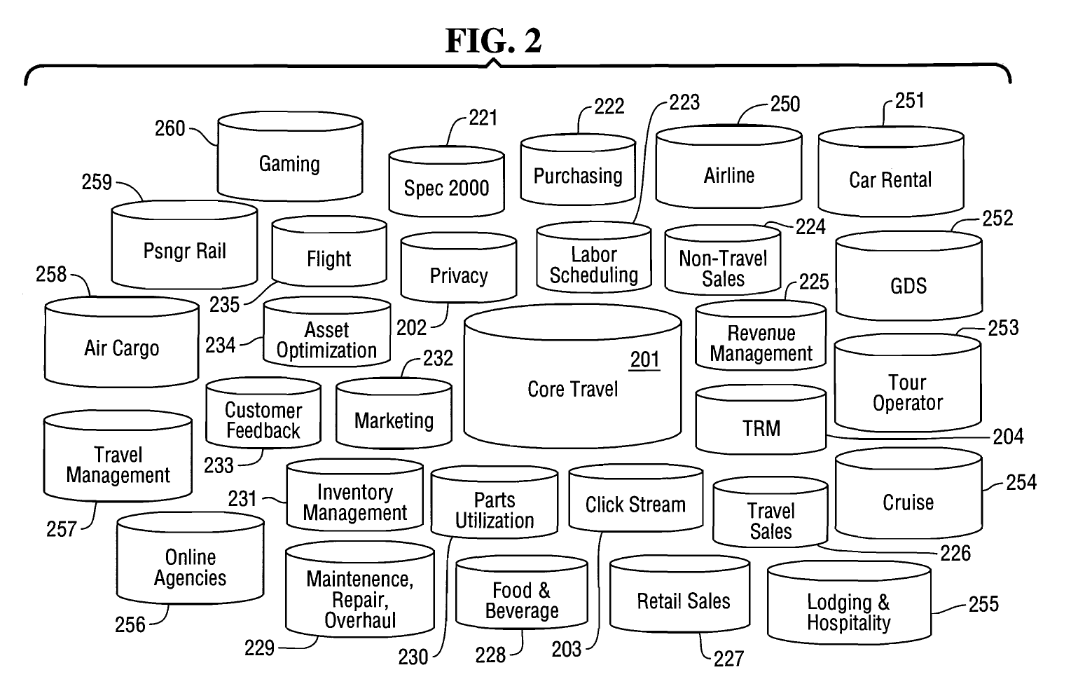

A travel and hospitality industry customer-centric warehouse is established on the Teradata Scalable Data Warehouse 101 as defined by the logical data model (LDM), described below. The logical data model is a consumer-centric data model supporting Revenue Management, Financial Management, Customer Relationship Management, Privacy and Click Stream analysis. It can serve as the base for a full enterprise data warehouse implemented at the client's site. The model has been designed in a modular fashion so non-relevant components can be removed without impacting the consistency of the model. It's an integrated, subject-oriented base of strategic business information that serves as a single source of decision support, providing the travel and hospitality provider with the ability to make simple reports or sophisticated information analysis. FIG. 2 shows the travel and hospitality core, industry, and revenue management segments supported by the LDM. Core segments include Core Travel 201, Privacy 202, Click Stream 203 and TRM 204. Travel and Hospitality segments include Spec 2000 221; Purchasing 222; Labor Scheduling 223; Non-Travel Sales 224; Revenue Management 225; Travel Sales 226; Retail Sales 227; Food & Beverage 228; Maintenance, Repair, Overhaul 229; Parts Utilization 230; Inventory Management 231; Marketing 232; Customer Feedback 233; Asset Optimization 234; and Flight 235. Industry segments include Airline 250, Car rental 251, GDS 252, Tour Operator 253, Cruise 254, Lodging & Hospitality 255, Online Agencies 256, Travel Management 257, Air Cargo 258, Passenger Rail 259, and Gaming 260.

### Logical Data Model Design Basics

As stated earlier, a properly designed logical data model provides a foundation for more effective sales, marketing, and operations management and supports the customer relationship management requirements related to identifying, acquiring, retaining and growing valuable customers.

A logical data model (LDM) is an abstract construct that is physically realized in the database or data warehouse. The data model provides an architecture for the information that will be included in a data warehouse. The database provides the physical realization of that architecture in a form that can be efficiently maintained and used. There may well be some differences between the logical data model and the final database design. The database may include some tables (summary tables, etc.) or columns that have no direct correlation in the logical data model. Elements in the logical model may be grouped differently in the physical database.

A logical data model is organized by Subject Areas, each comprised of numerous Entities, Attributes and Relationships. The data model hierarchy includes one or more Subject Areas. Each Subject Area includes one or more Entities or Tables, each having Attributes and Relationships. Each Attribute describes a fact about an Entity. Relationships between two or more Entities are further defined by Cardinality. The Relationships define which entities are connected to other entities and the cardinality of the relationships. Each of these elements will be described in greater detail below.

### Subject Area

A subject area is a subset of objects taken from the universe of data objects for a particular line of business or industry that focus on a particular Business Process. Typically, a subject area is created to help manage large data architectures that may encompass multiple business processes or business subjects. This is the highest-level data concept within a conceptual entity/relationship (E/R) model. Working with subject areas is especially useful when designing and maintaining a large or complex data model. Dividing the enterprise into several distinct subject areas allows different groups within an organization to concentrate on the processes and functions pertinent to their business area.

### Entity

An Entity represents a person, place, thing, concept, or event (e.g. PARTY, ACCOUNT, PRODUCT, etc.). It represents something for which the business has the means and the desire to collect and store data. An Entity must have distinguishable occurrences, e.g., one must be able to uniquely identify each occurrence of an entity with a primary key (e.g. Party Identifier, Account Identifier, Invoice Number, etc.). An Entity is typically named with a unique singular noun or noun phrase (e.g., PARTY, TRANSPORTED PASSENGER, etc.) that describes one occurrence of the Entity and cannot be used for any other Entity. It should be exclusive of every other Entity in the database. An Entity cannot appear more than once in the conceptual entity/relationship (E/R) model. Each Entity may have relationships to other Entities residing in its own Subject Area or in other Subject Areas.

### Attribute

An Attribute is a data fact about an Entity or Relationship. It is a logical (not physical) construct. It is data in its atomic form. In other words, it is the lowest level of information that still has business meaning without further decomposition. An example would be FIRST NAME, or LAST NAME. An example of an invalid attribute would be PERSON NAME if it includes both the first and last names, as this could be further decomposed into the separate, definable (first name, last name) data facts.

### Relationship

A Relationship is an association that links occurrences of one or more Entities. A Relationship must connect at least one Entity. If only one Entity is connected, the Relationship is said to be Recursive. A Relationship is described by a noun or passive verb or verb phase that describes the action taken in the Relationship. A Relationship represent a static state of being between the occurrences of the Entities it connects. Relationships are not intended to represent processes or data flows. They cannot be linked to another Relationships. They may optionally represent future, present, and/or past relatedness. The time frame must be explicitly defined in the data definition. Relationships may contain attributes. In a normalized model, a Relationship containing Attributes will result in the creation of an Entity.

### Cardinality

In order for a data model to be considered accurate, it must contain both the maximum and minimum number of Entity occurrences expected. This is controlled by rules of cardinality, which describes a relationship between two Entities based on how many occurrences of one Entity type may exist relative to the occurrence of the other Entity. Typically, it is a ratio, commonly depicted as a one-to-one (1:1); one-to-many (1:N); and many-to-many (M:N) relationship.

The maximum cardinality may be an infinite number or a fixed number but never zero. The minimum cardinality may be zero, or some other positive number, but it must be less than or equal to the maximum cardinality for the same relationship.

The logical data model for the E-Business will now be described in more detail. The logical data model uses IDEF1X modeling conventions, as shown in Table 1.

TABLE 1
Entity Conventions

| Convention | Definition |
|---|---|
| 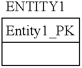 | Independent entity. An entity is depicted as a box, with its name above the box in singular, uppercase form. Square-boxed entities are independent. They rely on no other entity for their identification. Primary keys are attributes that uniquely identify the entity. Primary keys are shown at the top of the box, separated from other listed attributes by a horizontal line. |
| 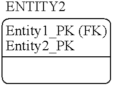 | Dependent entity. Round-cornered entities are dependent on one or more entities for their identification. (FK) following the primary key attribute indicates a foreign key—an attribute in the entity that is the primary key in another, closely related entity. |
| 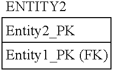 | An independent entity may also include a foreign key as a “non-primary key foreign key”. A non-primary key foreign key is shown below the horizontal line separating primary key attributes from other entity attributes. |

Relationship and cardinality conventions are shown in Table 2.

TABLE 2
Relationship/Cardinality Conventions

| Convention | Definition |
|---|---|
| 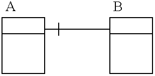 | A single line at the end of a relationship link means that a single record entity B is related to only one record in entity A.. |
| 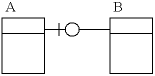 | A circle indicates that the presence of a linked record in entity A is optional. |
| 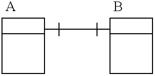 | One-to-one relationship. |
| 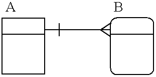 | One-to-many relationship. The crow's foot symbol means that more than one instance of an entity is associated with another entity. |
| 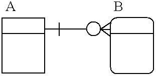 | One-to-zero-one-or-more relationship. A circle with a crow's feet symbol means there may be zero, one, or many instances of the entity associated with the other entity. |
| 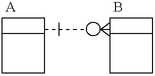 | A dotted relationship line indicates that the identity of entity B is not linked to entity A. |

### Travel and Hospitality Logical Data Model

The Travel and Hospitality Logical Data Model (LDM) is a large data model composed of a large number of tables. To effectively view and understand the data model, the data tables have been logically organized into smaller groups called subject areas. Each subject area is comprised of a set of tables that contain information relevant to a particular entity. In addition, the subject areas address particular business questions.

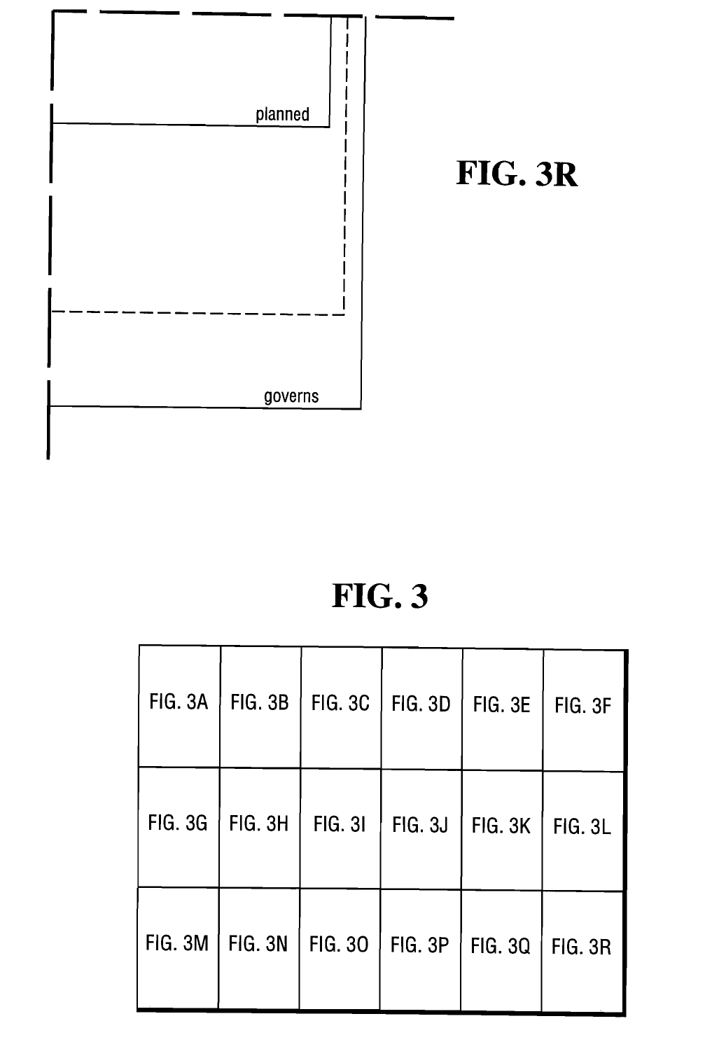

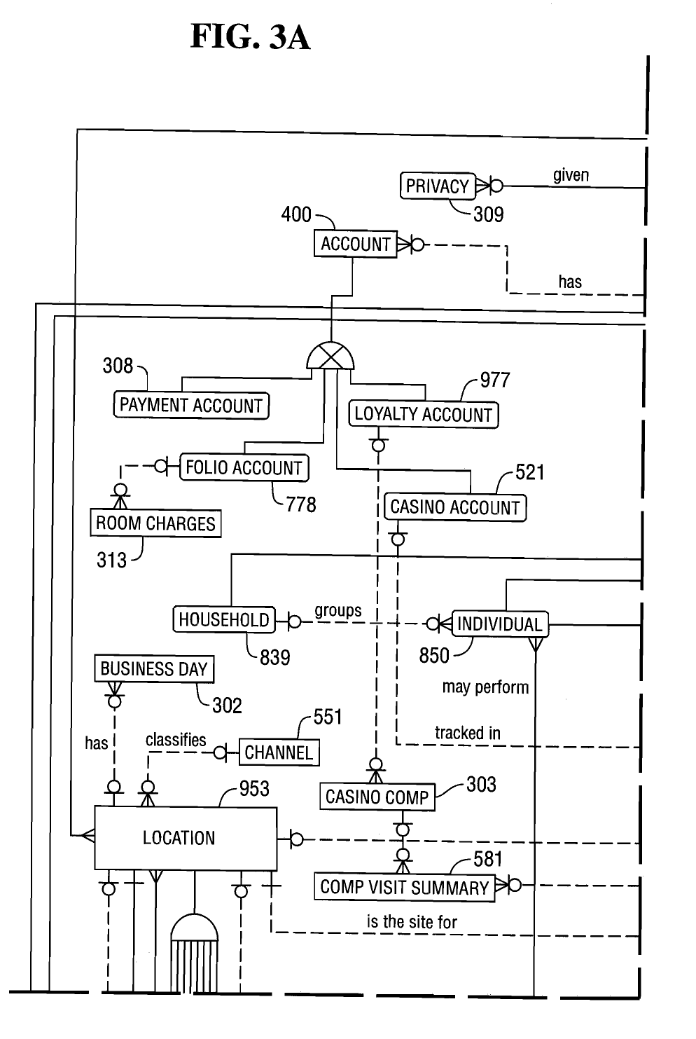

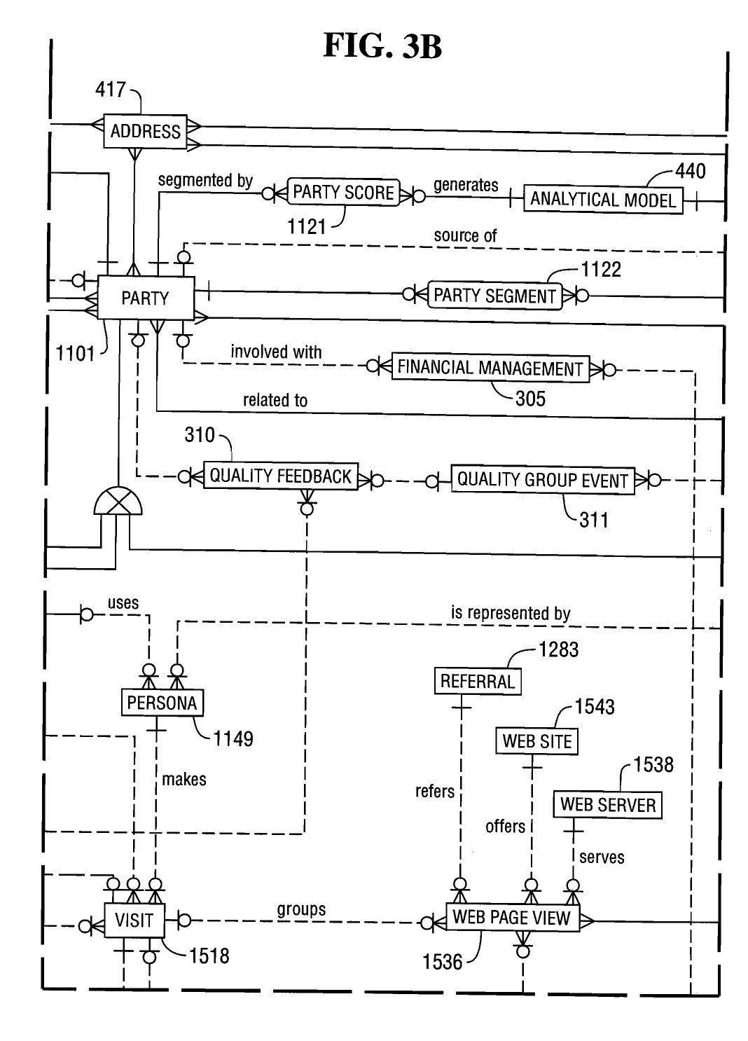

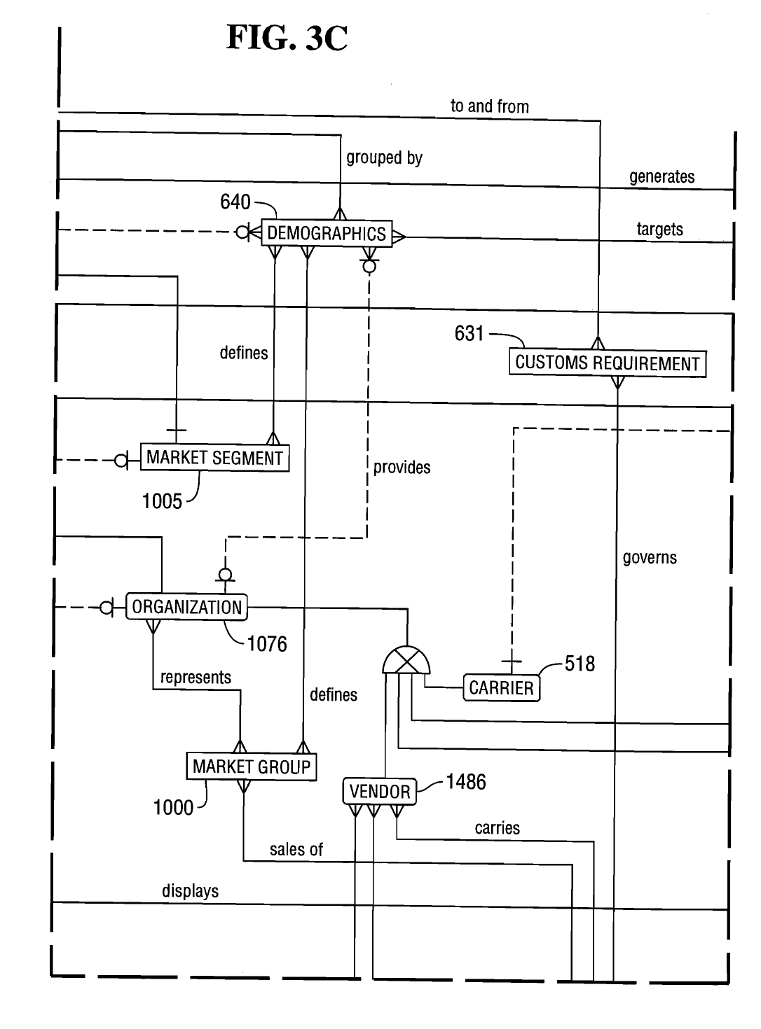

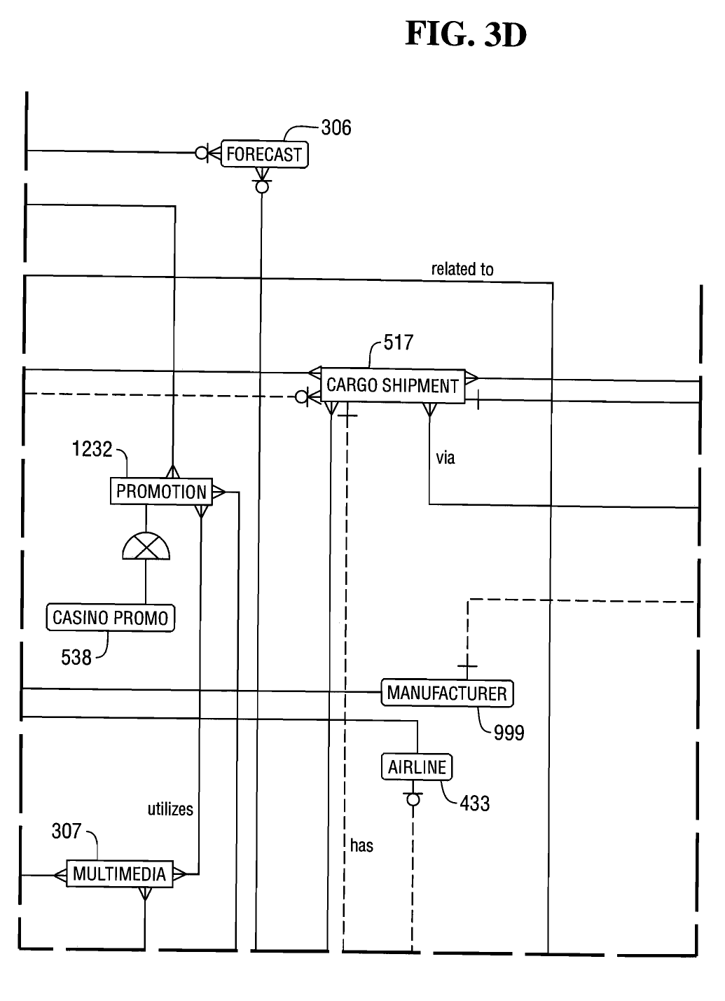

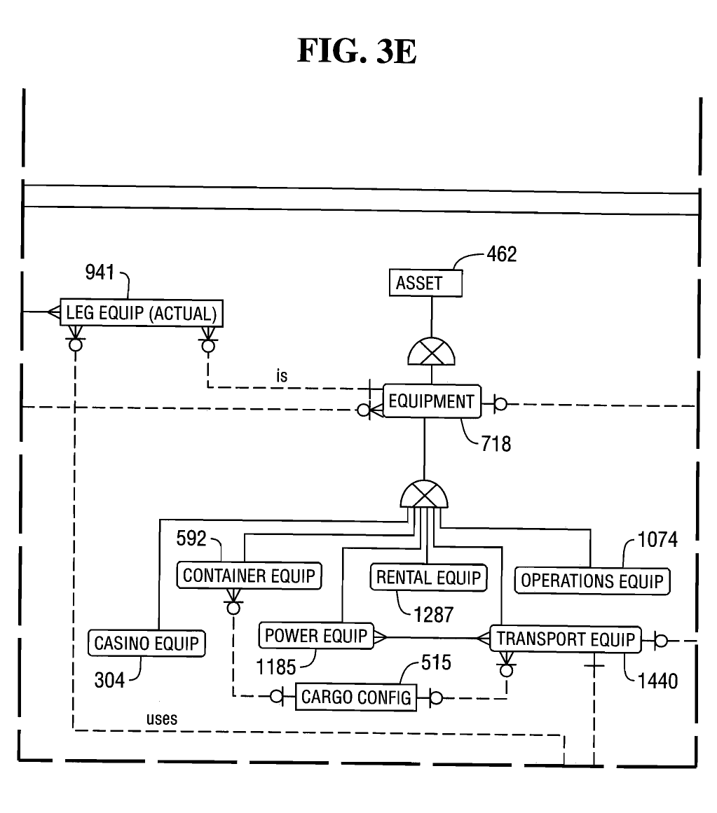

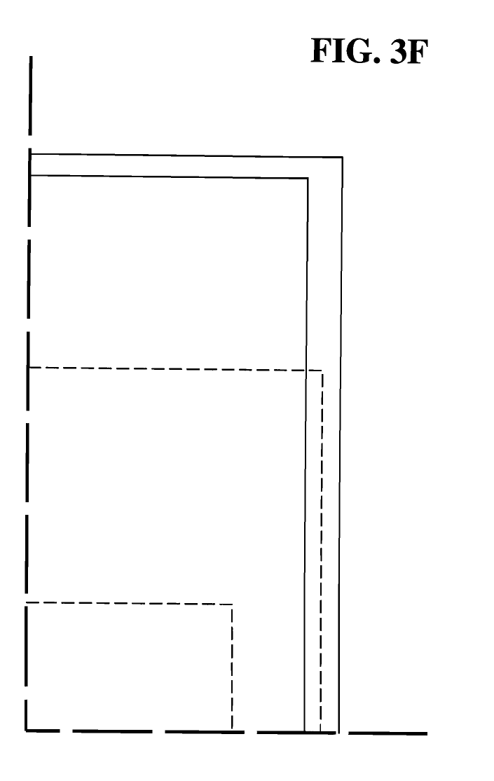

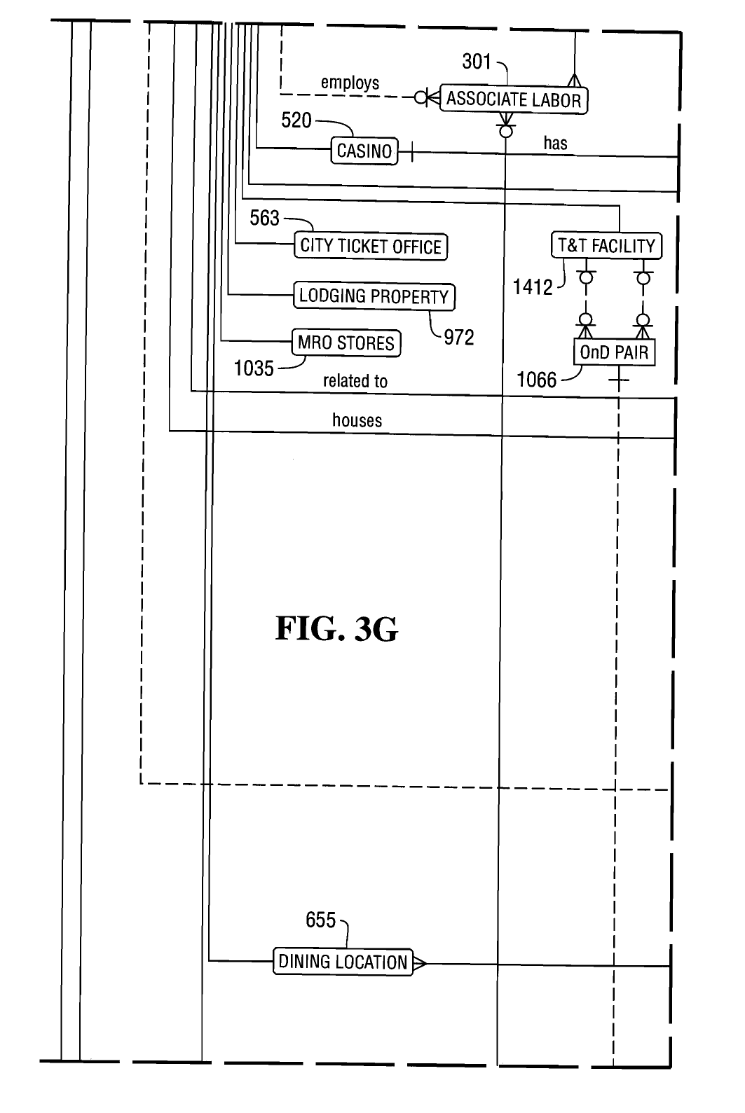

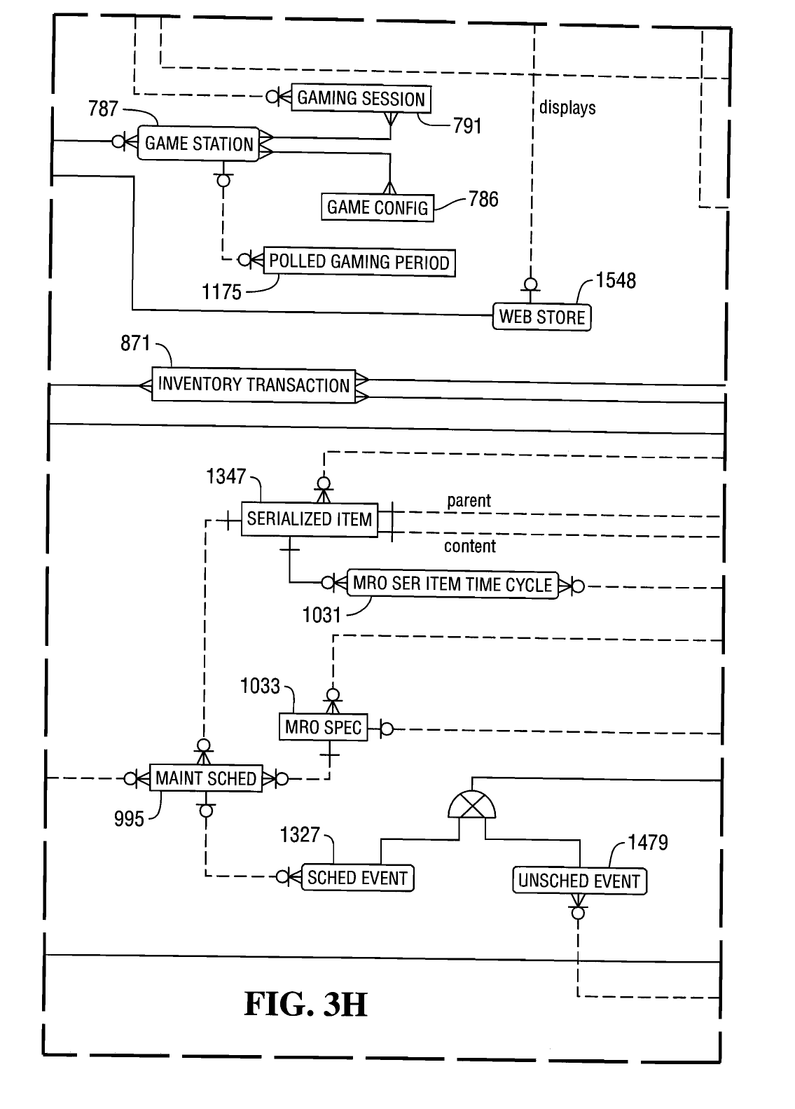

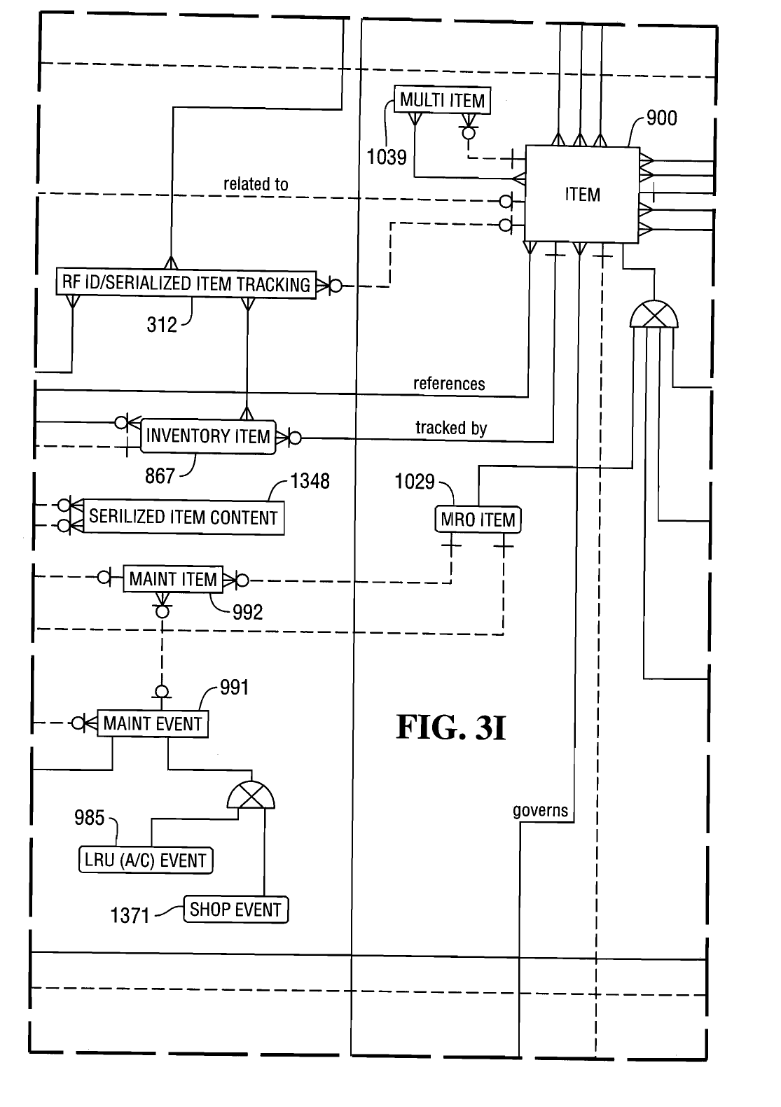

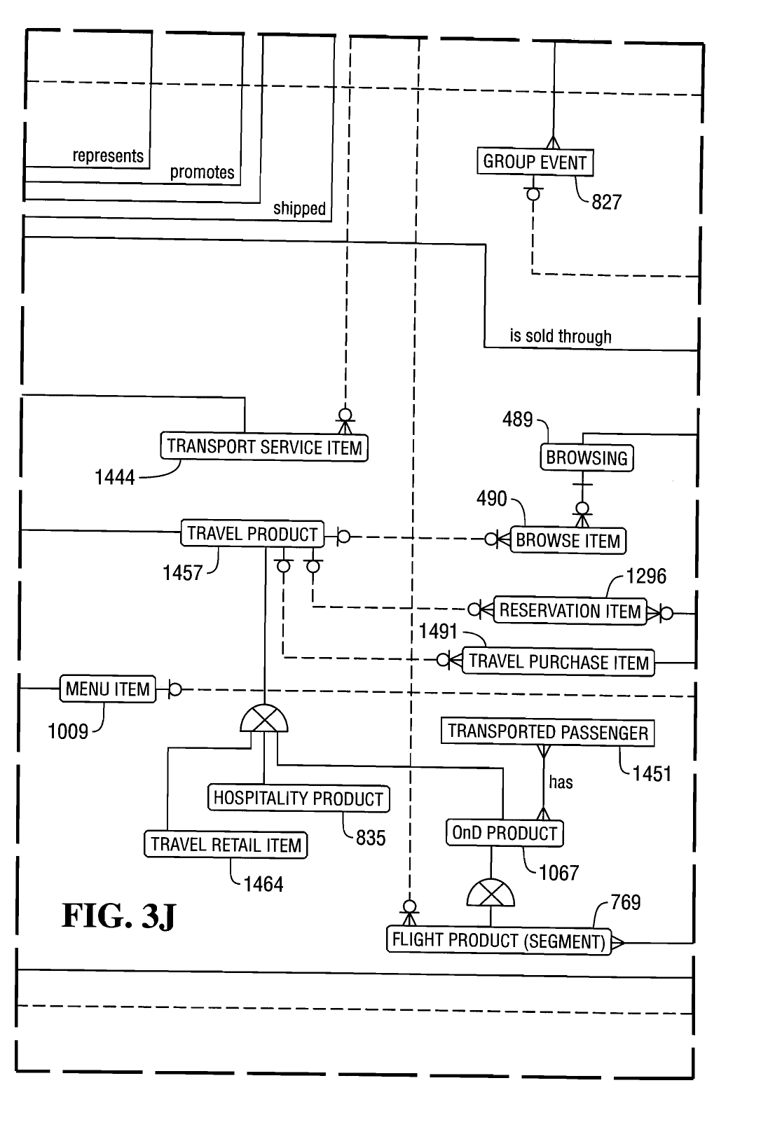

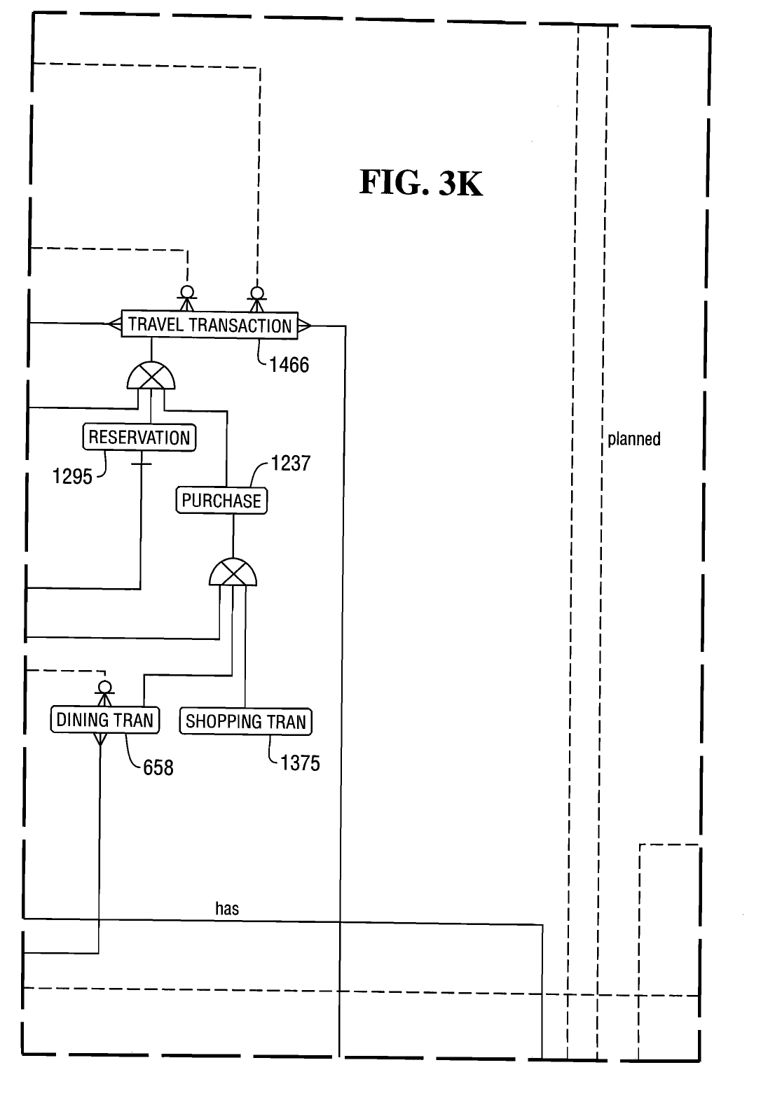

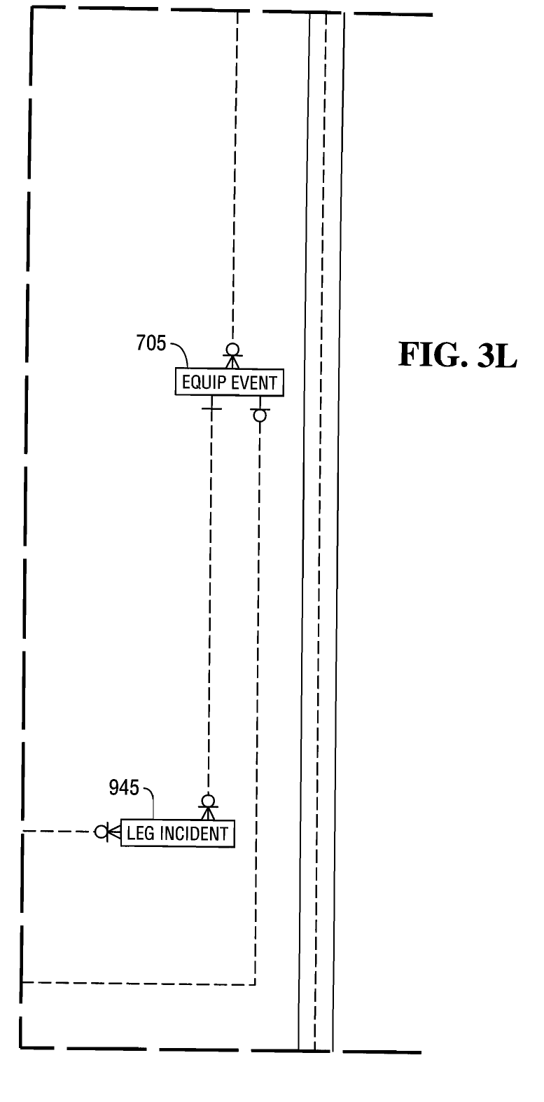

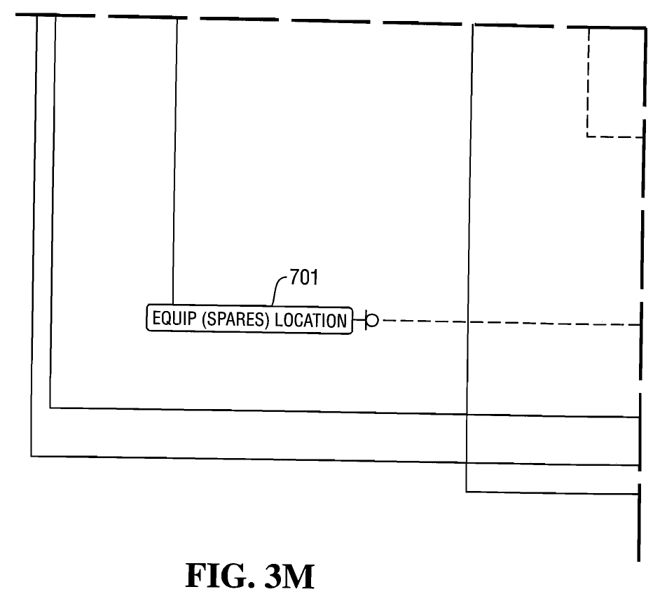

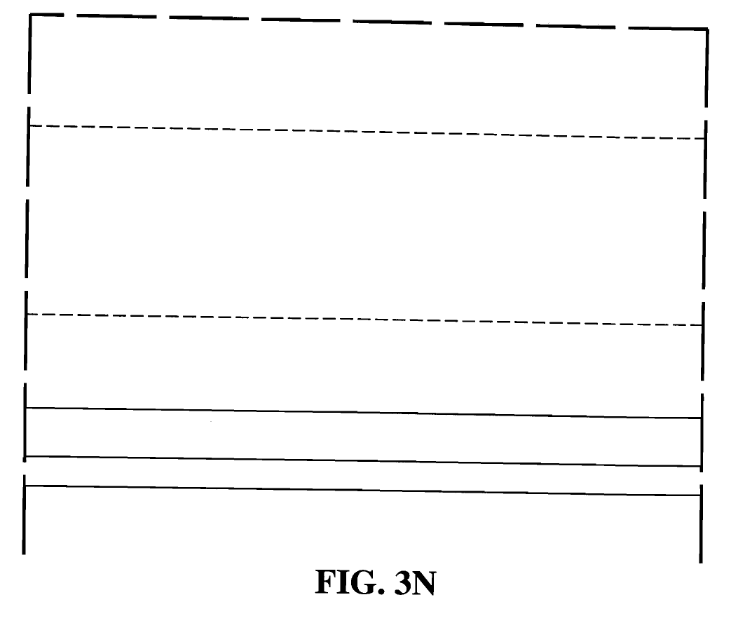

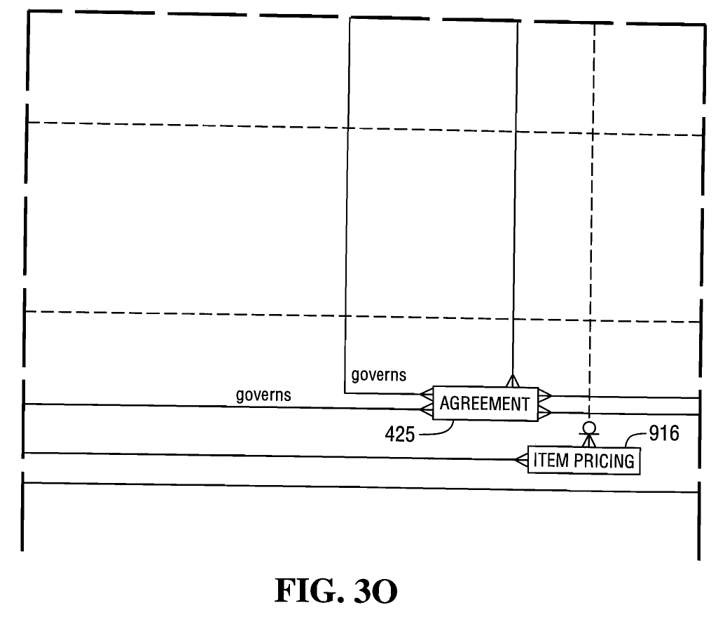

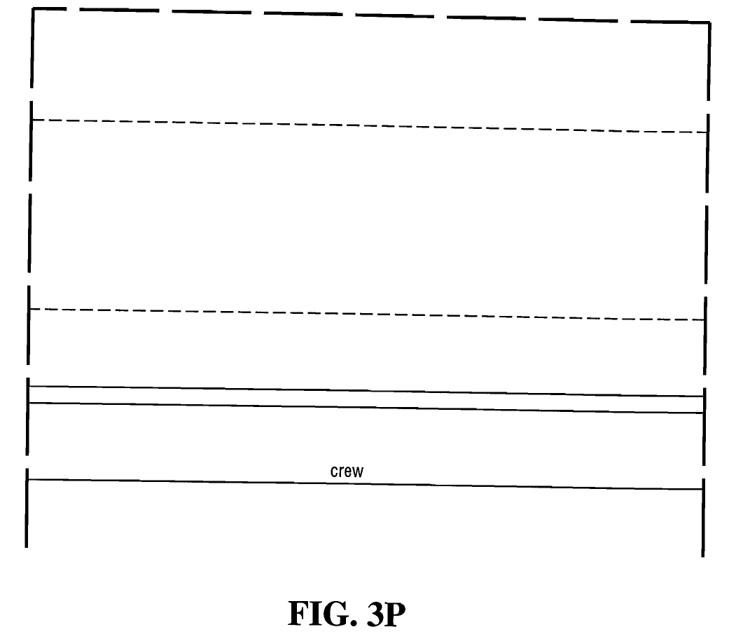

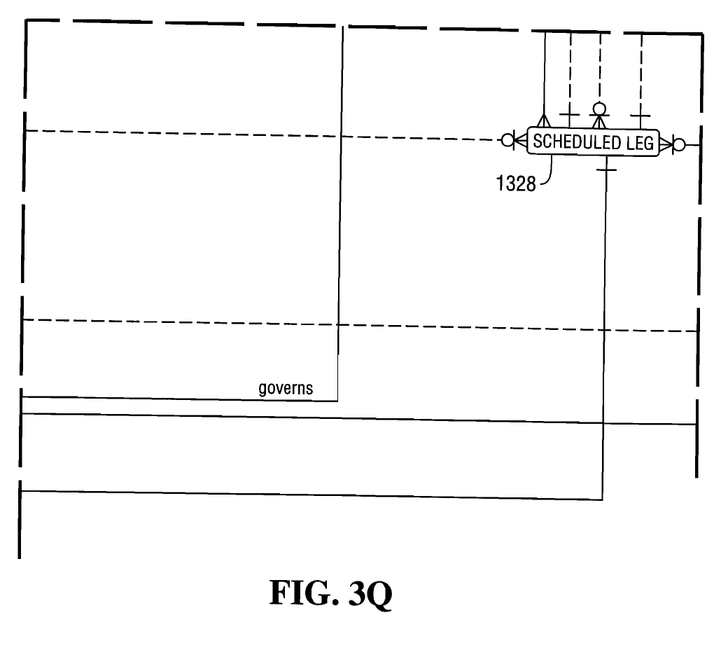

The Travel and Hospitality Data Model Logical Data Model is presented in a conceptual view in FIGS. 3A through 3R. This view provides an overall high-level understanding of the major entities and how they relate to each other. This conceptual level forms the foundation for the remaining views. Its purpose is to show the most important entities in the logical data model and how they generally relate to each other.

The Conceptual View is derived directly from the Travel and Hospitality Data Model Logical Data Model by selecting the most important entities from every subject area, being sure that at least one entity from each subject area was selected and distilling the relationships among the selected entities, while still maintaining the general nature of the way the entities relate to each other. During this process, intervening entities were abstracted into relationships. Many-to-many relationships were used where appropriate. Several entities shown in the Conceptual View represent a subject area or combination of entities within a subject area. The result is a simple, easy to understand diagram that conveys the general content of the underlying logical data model.

For ease of use and understanding, the Travel and Hospitality Logical Data Model has been divided into numerous subject areas identified in Appendix A.

### Hospitality Subject Areas

Lodging providers must be able to easily identify and be able to analyze all guest purchases and behavior during each visit. The model provides the enterprise a rich amount of customer detail including such important behavior as room service purchases, capturing the guest's suite number, products and menu items delivered to the guest's suite (with date and time) and any additional special service charges that may have been incurred such as dry cleaning, concierge services, mini-bar usage, etc. All guest purchases are linked through high-level transaction records and to account folios.

Group events provide the Enterprise an opportunity to enrich the customer experience by providing group Dining, Shows and Extravaganzas, Spa visits and services and Golf and other venues. The Enterprise needs to know the specific event planned, when it will be held and where, the anticipated revenue and costs, management and catering contacts, equipment and personnel needed, and the number of expected/enrolled guests, the services used and, for Golf, the number of holes played and other services such as Gold Pro lessons, etc. These events are all cross-linked with Marketing Campaigns down to the individual Promotional Offer. Events may be handled by external, special events agencies. The Events are tracked over time so changes in status are always known and accounted for. Provided are a full revenue, cost and commission accounting linked to specific hospitality products and services and linked to folios to provide maximum flexibility for handling guest accounts.

Hospitality providers often have a high margin in the sale of Retail Products and Gift Certificates and services. The model provides detail of each purchase transaction; the items/services sold; item characteristics and traits; costs, list pricing, actual selling price, discounts and coupons, etc.

All lodging events such as check-in, room moves and checkout must be carefully tracked to maximize room availability and customer satisfaction. All charges incurred by guests, whether via restaurants, rental, incidental item, activity, retail stores, group events, etc., are captured in a single Guest Folio account with individual transaction lines both for the convenience of the Guest and the detailed analysis by the Enterprise.

Banquets can be a high-profit activity for the hospitality sector and are linked to Group Events in the model. Needed by the Enterprise are all entertainment planning activities and charges, decorations planning and charges, separate service fees, extended menu planning and offers, labor charges, actual and management charges, the enablement of headcount pricing, room and venue rental charges, equipment charges, etc.

Fine dining covers a myriad of possibilities for hospitality providers. The model provides complete support for dining reservations including location and table choice for the venue. All menu and special purchase items are included in a Guest Check with the guest count, tips, discounts and total amounts and Line Items provide the number of menu items ordered and their pricing. Each menu item is also broken down into the quantity and actual ingredients needed to make the item. The nature of the order is included which defines whether the dining is “take away”, on-site or delivery. All dining is cross-linked with the Guest's Folio for a comprehensive overview of all customer activity.

Hospitality providers want to increase the profitability of each guest visit. That means understanding the behavior of different guest segments so guests can be compared to profitable segments and a determination made as to how to raise their profitability to the enterprise. Another objective is to increase promotional effectiveness of each promotion targeted at a group of potential patrons.

The solution would allow a hospitality provider to optimize its marketing efforts. It could promote products and services that drive the highest margin visits by patrons. The other benefit is that this analysis will allow the enterprise to eliminate products and services that drive low-margin visits by patrons.

This will enable visit detail analysis of the types of products purchased, services utilized by patrons and tender utilized for each patron visit. It will show products and services purchased per visit compared to target products and services analyzed and promoted. A visit profile will be developed for each patron visit based on frequency, probability and profitability of each mix of products and services. Finally, this will provide input to promotion effectiveness by providing promotional impact on frequency of visit, affinity of promoted products and services to non-promoted products and services for each patron responding to a given promotion. Listed below are some examples of the promotional analysis with this approach:
Promotional Effectiveness Analysis by Purchase, Venue, Pre Weeks vs. Promotion Weeks
Post-Promotional Impact Analysis by Purchase, Pre Weeks vs. Post-Promo
Promoted Single Purchase Only Visit Analysis by Purchase for Venue
Single Purchase Only by Venue for All Promoted Purchases
Affinity and Visit Performance Analysis of Promoted Purchase, by Affinity Purchase by Venue
Affinity Analysis of Promoted Purchase, by Affinity Purchase for Venue Cluster
Promotional Purchase Trait Affinity Analysis by Affinity Categories, for Purchase Trait by Venue
Profitability Analysis for the Top 10 Purchases in Spending by Promoted Purchase and Purchase Trait, for the Top 20% Profitable Guests by Venue
Promotional Purchase to Total Purchase vs. Promotional Profitability to Total Profitability by Day for All Promoted Purchases by Venue
Promotional Purchase Propensity and Performance Analysis by Purchase by Purchase Trait, for the Top 20% Profitable Guests by Venue
Promotional Purchase Propensity Analysis by Purchase by Purchase Trait, for the Top 20% Profitable Guests by Venue
Guest Segment Propensity (Lift) and Performance Analysis by Guest Profit Decile Segment for Promoted Purchase by Purchase Trait by Venue
Guest Segment Propensity (Lift) Analysis by Guest Profit Decile Segment by Purchase by Venue
Promotional Spending and Profitability Analysis by Guest Postal Code, by Purchase Trait by Venue
Promotional Purchase and Profit Analysis by Guest Postal Code by Purchase Trait by Venue
Promotional Avg. Spending and Profitability by Visit by Guest Postal Code for Purchase Trait by Venue
Promotional Purchase and Profitability Analysis by Day for a All Promoted Purchases by Venue
Avg. Spending per Visit vs. Avg. Profitability

The hospitality provider needs to identify, entice and retain high-value guests. This means understanding guest behavior and understanding what makes a guest profitable. Once the enterprise understands what makes a patron profitable, they can optimize targeting of products, services and promotions to attract and retain their most profitable patrons and take other patrons and move them to the higher profit status by making offers that drive profitable behavior. The benefits derived from Guest Analysis include higher market share, increased margins and higher guest satisfaction and loyalty.

Guest Analysis must address capturing patron behavior, i.e. purchase behavior and margin, hotel, group and dining activities and margin, and costs associated with keeping this patron loyal. The various guest activities must then be analyzed by profitability, demographic traits or other differentiators. Guests can then be segmented by RFM (Recency, Frequency, and Monetary), demographics, geography, preferences, etc. Promotions must then be developed to leverage this analysis to ensure that top revenue patrons receive offers sure to attract their continued business. Detailed analysis like the examples below can be performed to understand every aspect of patron behavior:
Product/Service Loyalty Analysis by Guest Segment and Product/Service Trait
Guest-to-Product/Service Worth Analysis
Guest Exclusivity to Product/Service Analysis
Product/Service Substitutability Analysis
Propensity (Lift) by Product/Service Characteristic Analysis for Preferred Guest Segments
Propensity (Lift) by Product/Service for Selected Guest Segments Analysis
Extended Spending Performance Analysis by Day Part for Preferred Guest Segments
Guest Segment Propensity (Lift) Analysis
Guest to Product/Service Loyalty Analysis
Spending Performance by Guest Decile
Top Spending Performance Analysis for Preferred Guest Segments
New Product/Service Performance and Propensity Analysis
New Product/Service Introduction Comparison Impact Analysis
Product/Service to Visit Performance Impact Analysis for Preferred Guests
Product/Service Propensity (Lift) Analysis for Preferred Guests
Product/Service Affinity Analysis (Cross-Product/Service Purchase and Profitability)
Selected Product/Service to Cross-Product/Service Affinity Analysis
New Product/Service Affinity Analysis
Potential Lost Affinity Analysis of Product/Service Deletion Candidates
Venue or Product/Service Attribute to Visit Affinity Analysis

Staff expense must be controlled based on an accurate, operational plan. This involves hiring and retaining the right people to ensure sufficient staffing and excellent customer service.

The benefits are reduced labor costs, increased employee productivity and increased margins.

The model supports capture of Labor costs so that they can be compared against the operational plan. This includes labor cost comparisons for full time vs. part time associates over time and operating expenses by category compared to the operational plan. Finally, labor productivity must be calculated by tracking revenue per labor hour, average services/products per hour and payroll costs over time.

Some example Business Questions that can be answered in this area:
What are actual labor expenses vs. plan for the previous month, quarter and year?
Can part time associates be used to meet peak manpower requirements at a lower cost to the company?
What controllable expenses are over plan?
What associate profile produces the most revenue at the least overhead?
What training issues have been identified that would lower overhead expenses?

Operational Efficiency will allow an Enterprise to adjust labor schedules and controllable expenses to meet the designated operational plan. It will allow the Enterprise to hire associates that meet pre-described profiles that have historically produced the best associates. Finally, it will allow training issues to be identified and addressed, that will increase associate productivity and help lower operational expenses.

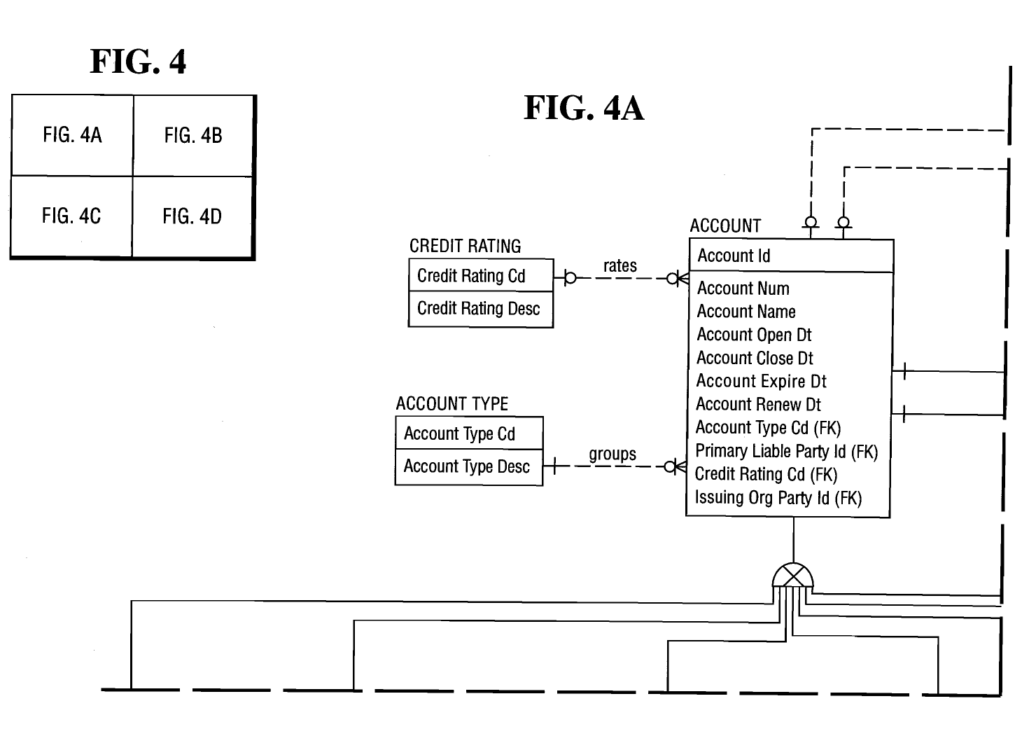

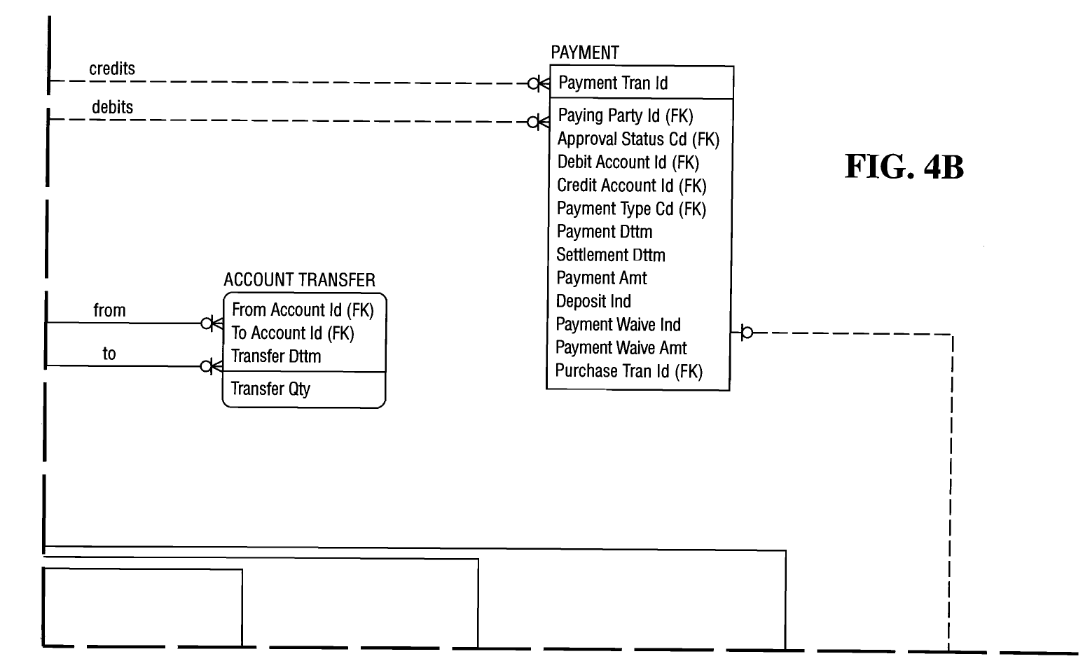

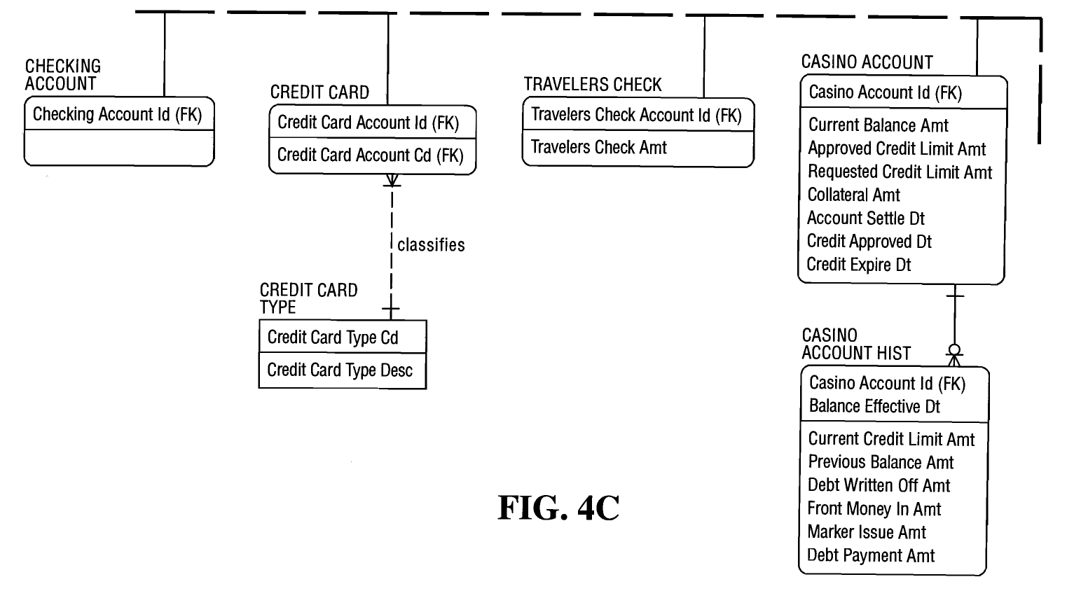

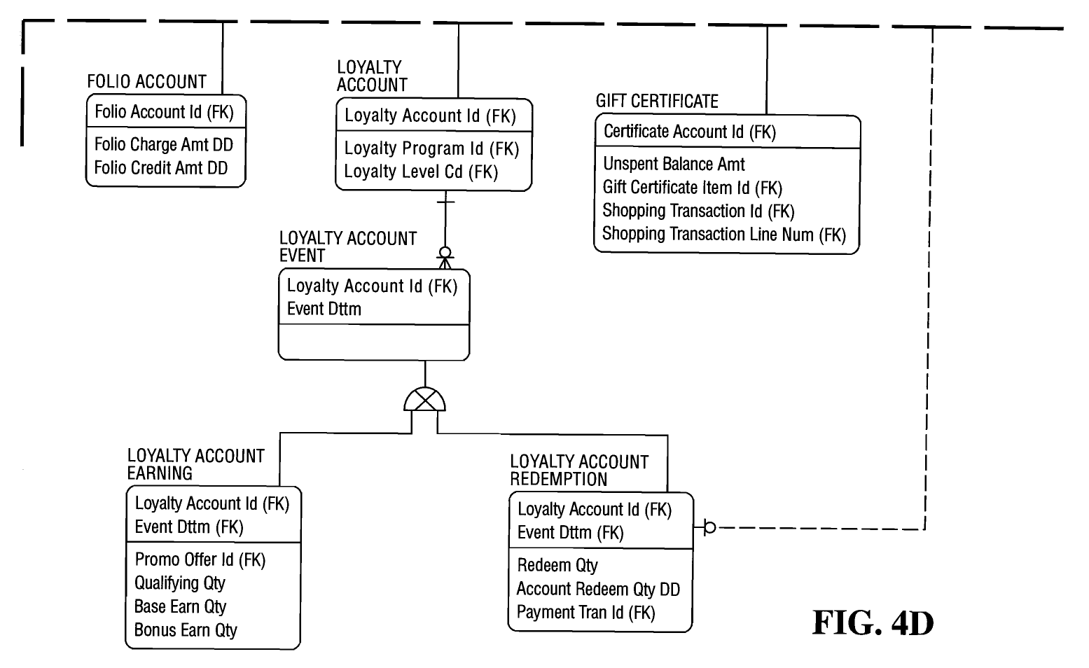

Incorporation of the foregoing, key subject matter provides a strong and varied business information foundation for the hospitality venue. The Travel and Hospitality Logical Data Model includes subject areas developed to logically model these key business information needs. These subject areas, as well as the entities included within the subject area, are illustrated in FIGS. 4 through 21. There is some natural overlap between the subject areas, i.e., an entity may appear in multiple subject areas if it has direct relationships with entities in multiple subject areas.

The subject areas modeling the key business information needs of hospitality venues, and shown in FIGS. 4 through 21 include the:

ACCOUNT (DEFINITION) Subject Area, illustrated in FIG. 4;

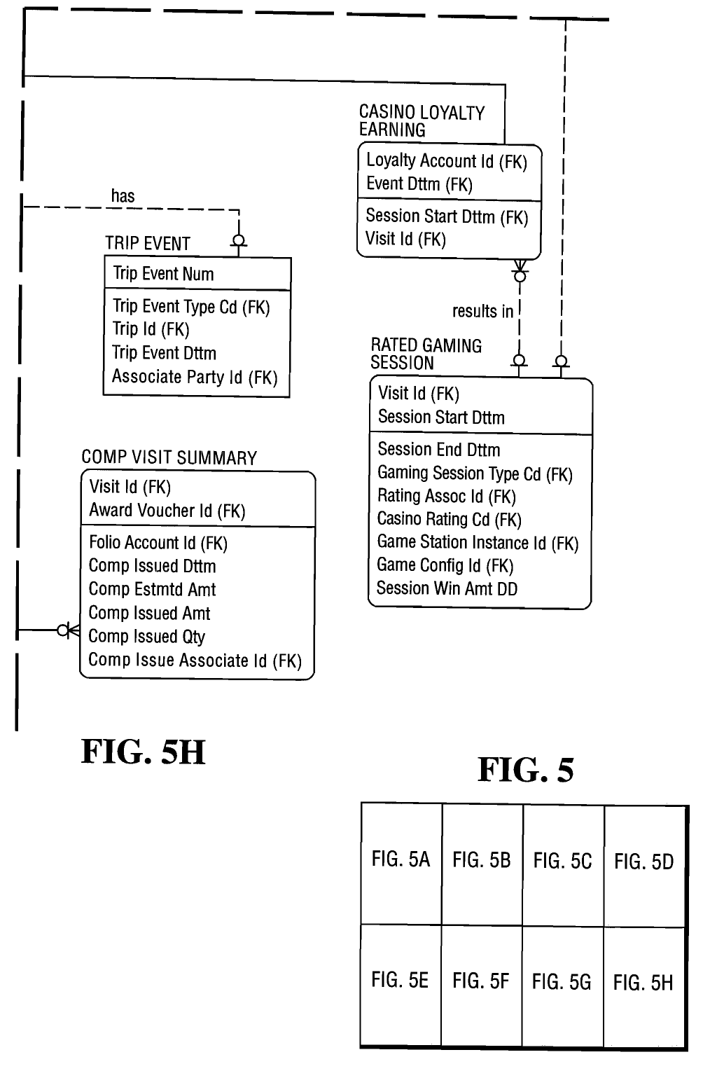

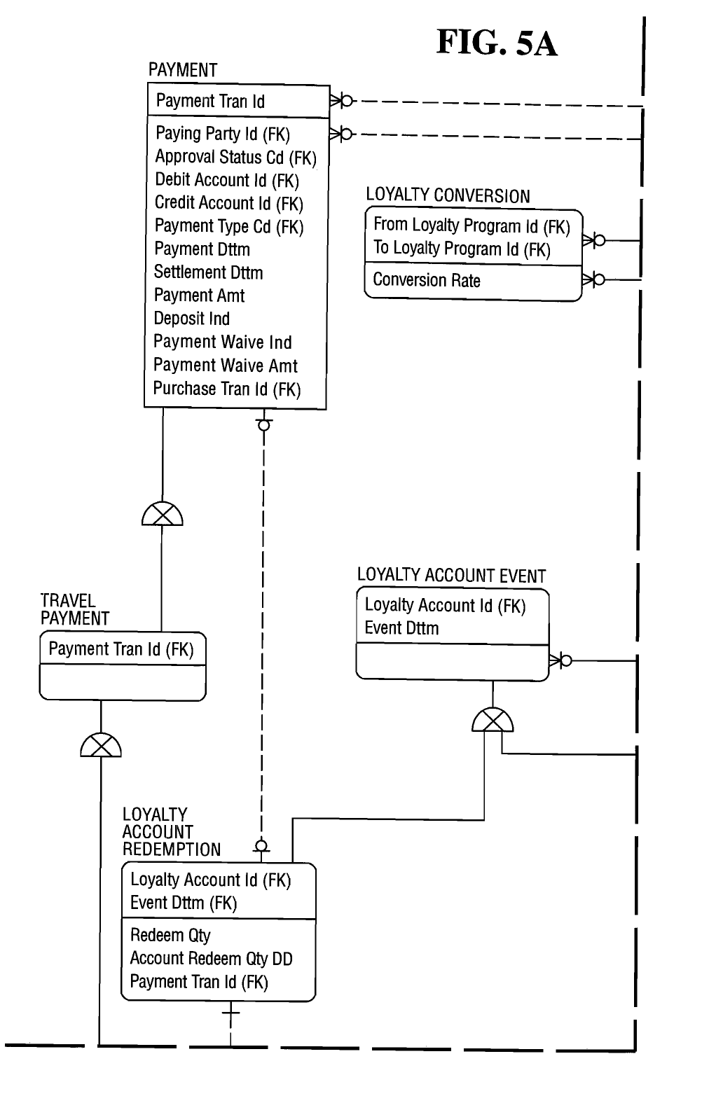

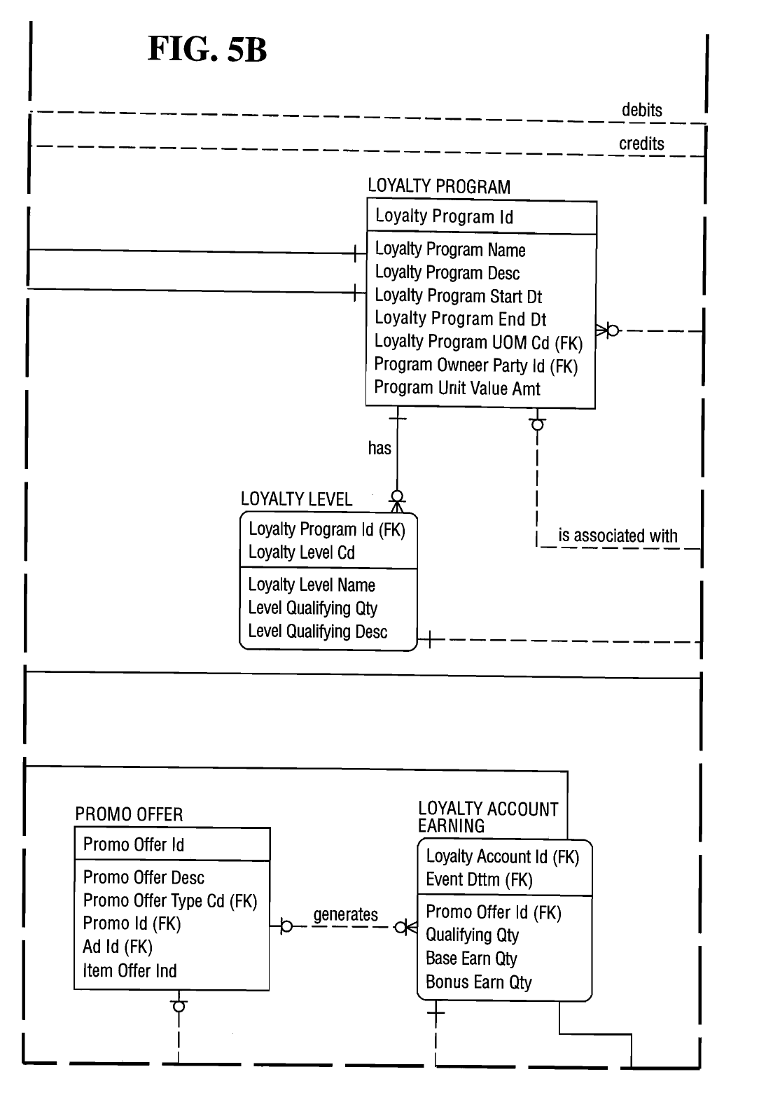

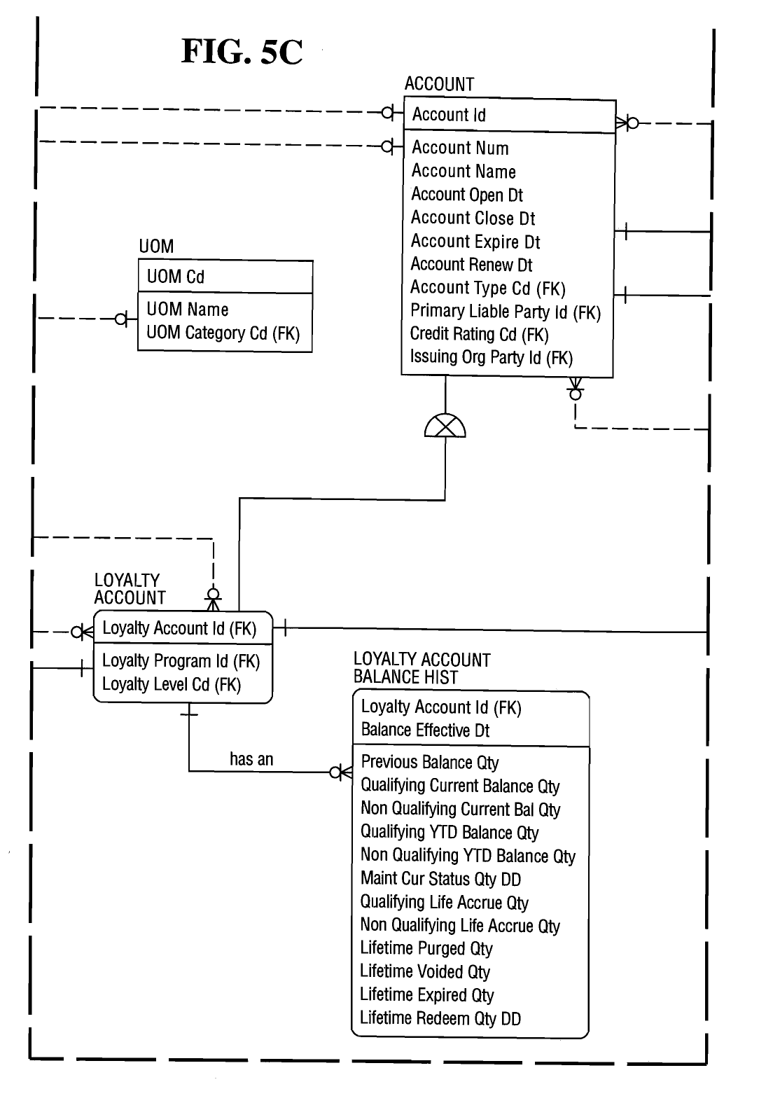

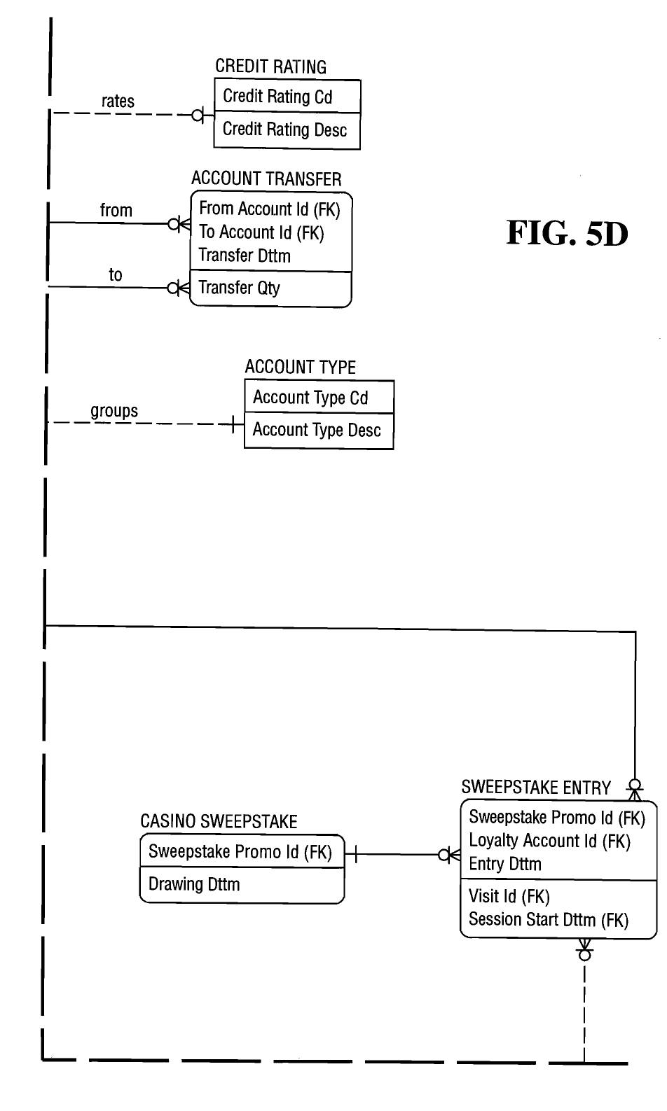

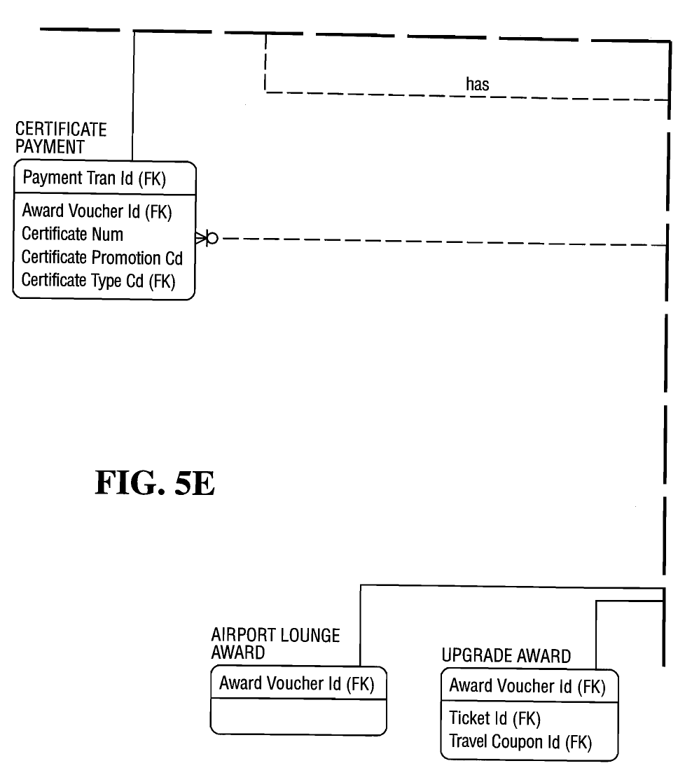

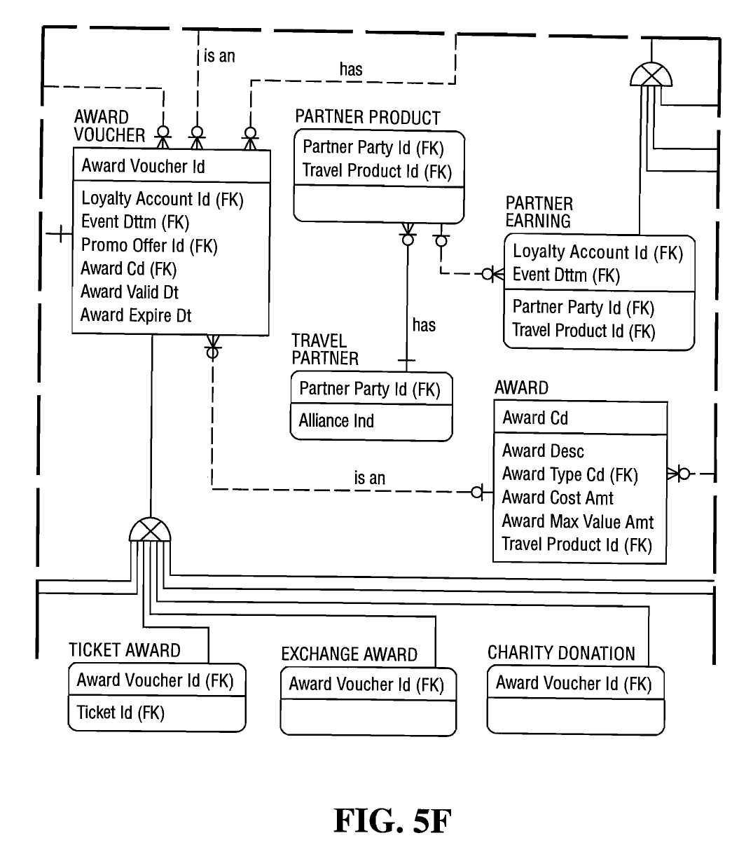

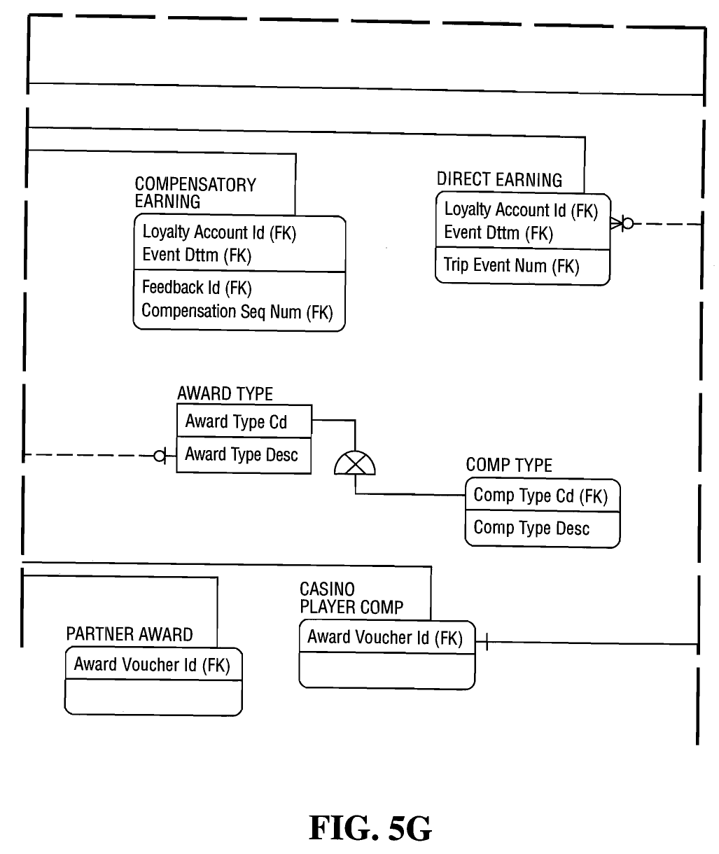

ACCOUNT (LOYALTY) Subject Area, illustrated in FIG. 5;

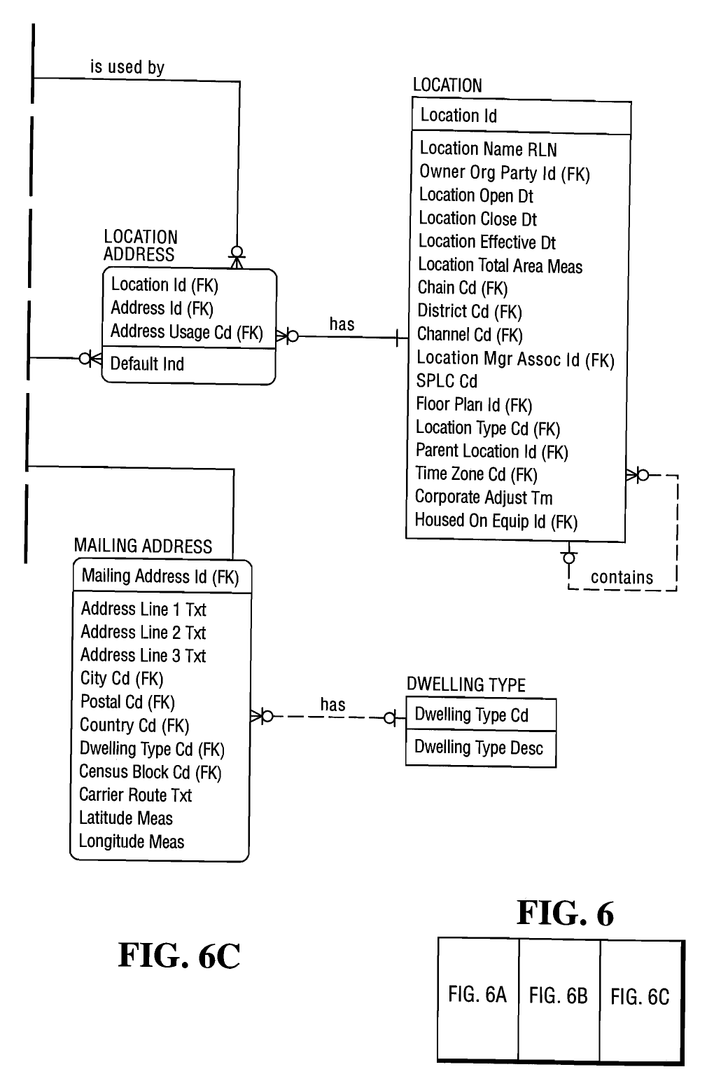

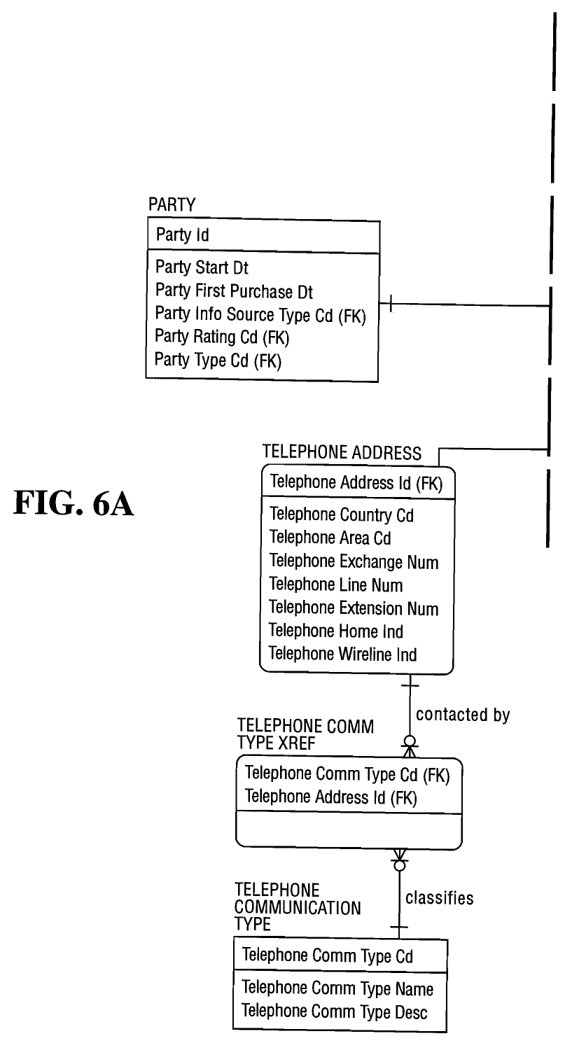

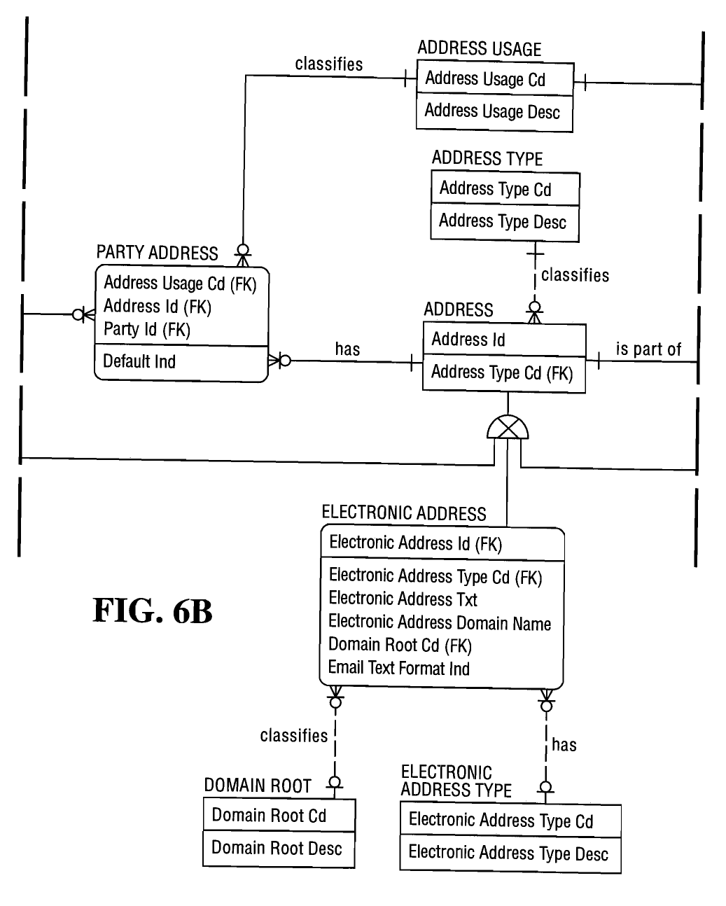

ADDRESS (CONTACT) Subject Area, illustrated in FIG. 6;

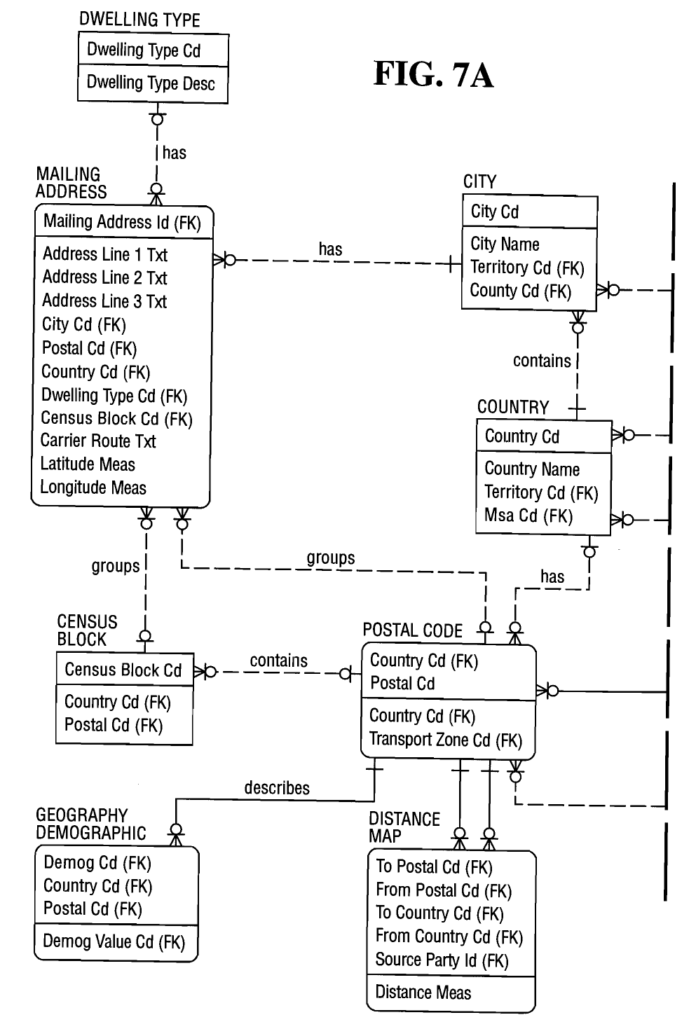

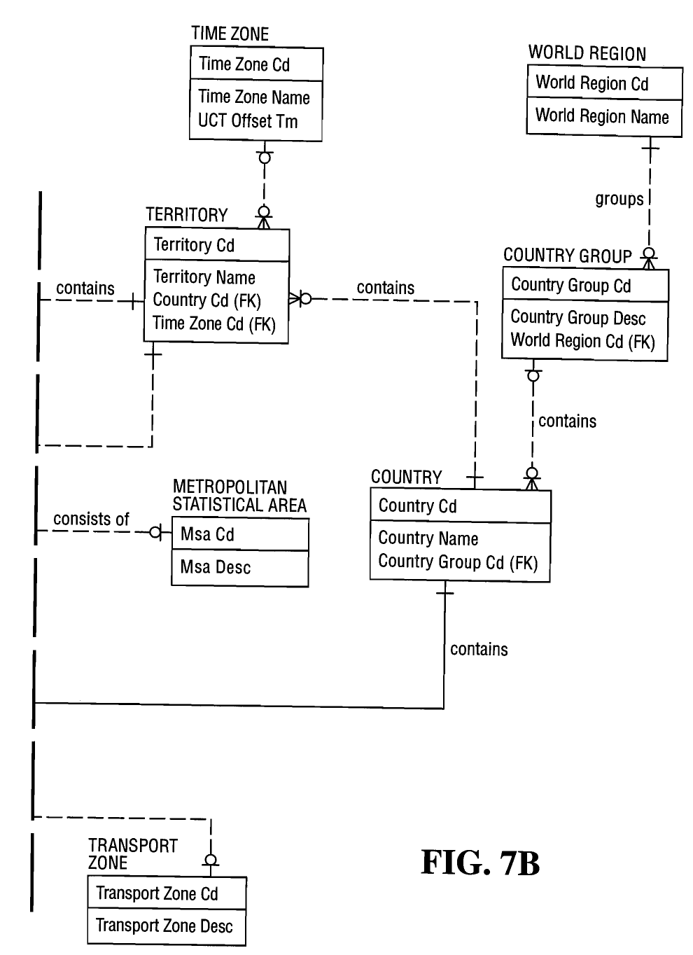

ADDRESS (GEOGRAPHY) Subject Area, illustrated in FIG. 7;

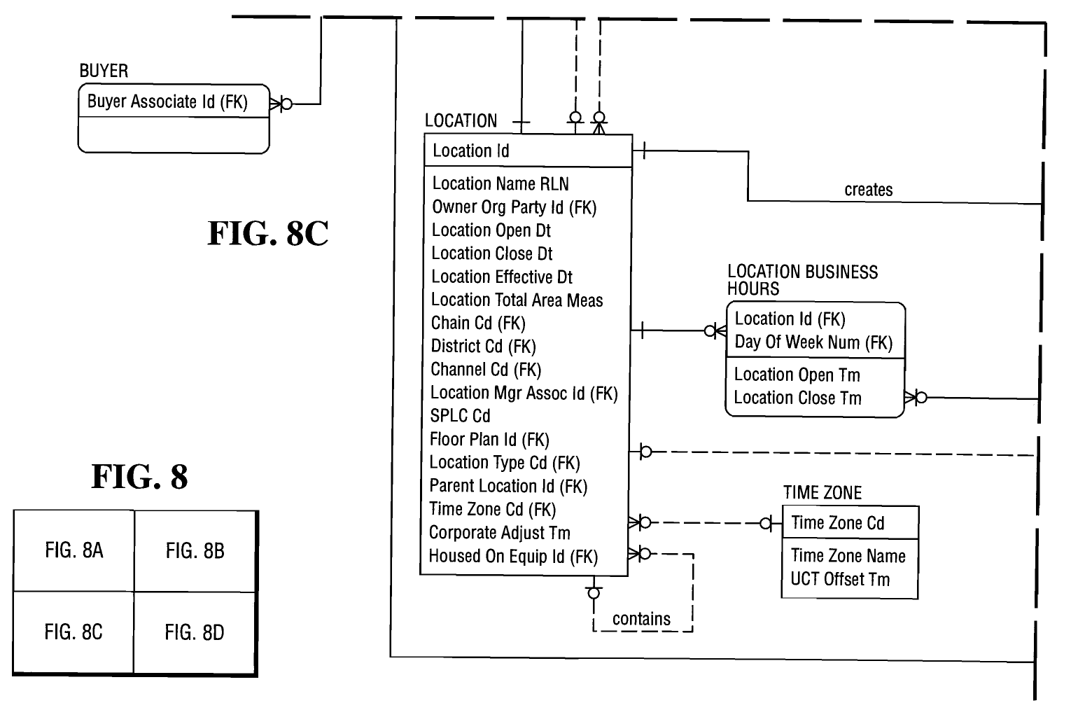

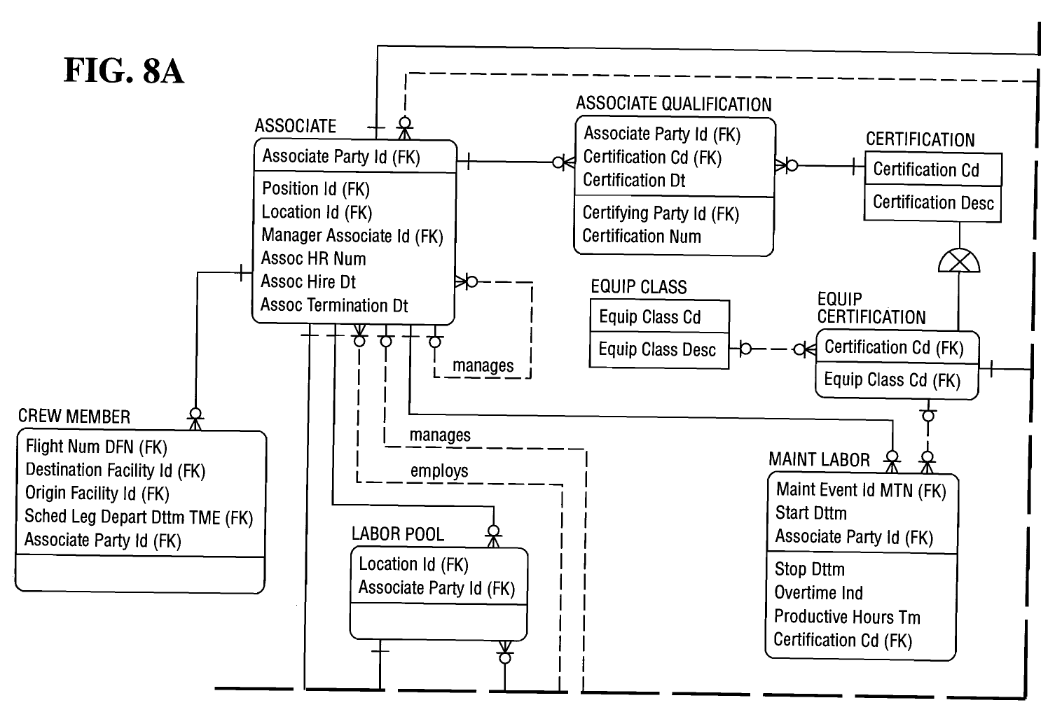

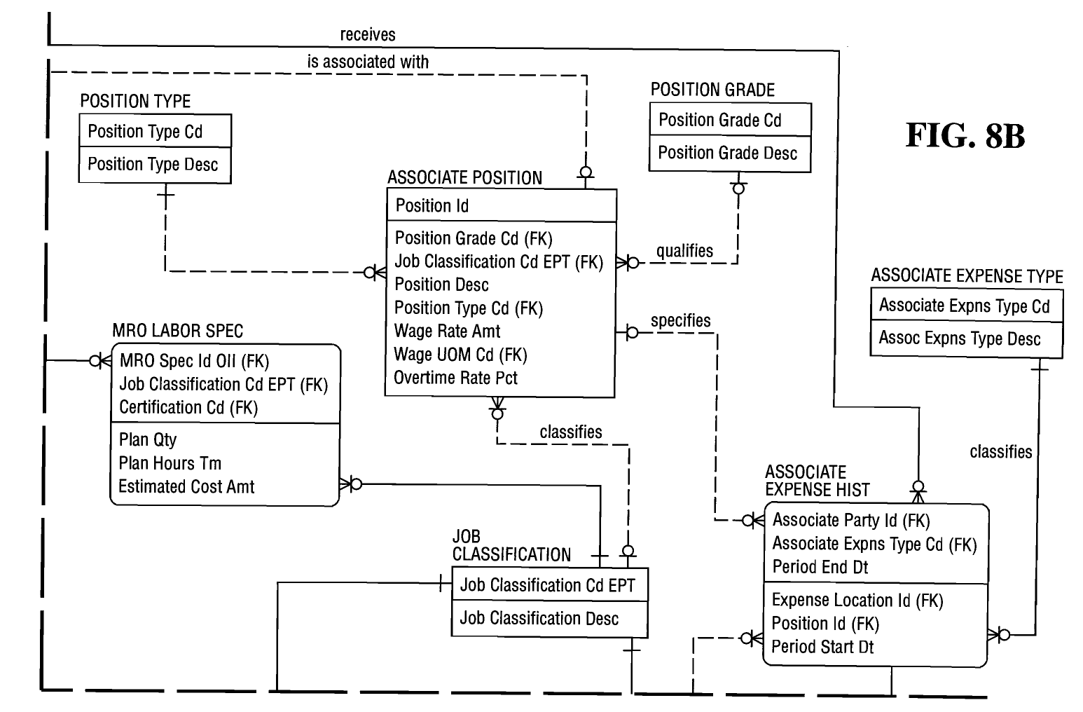

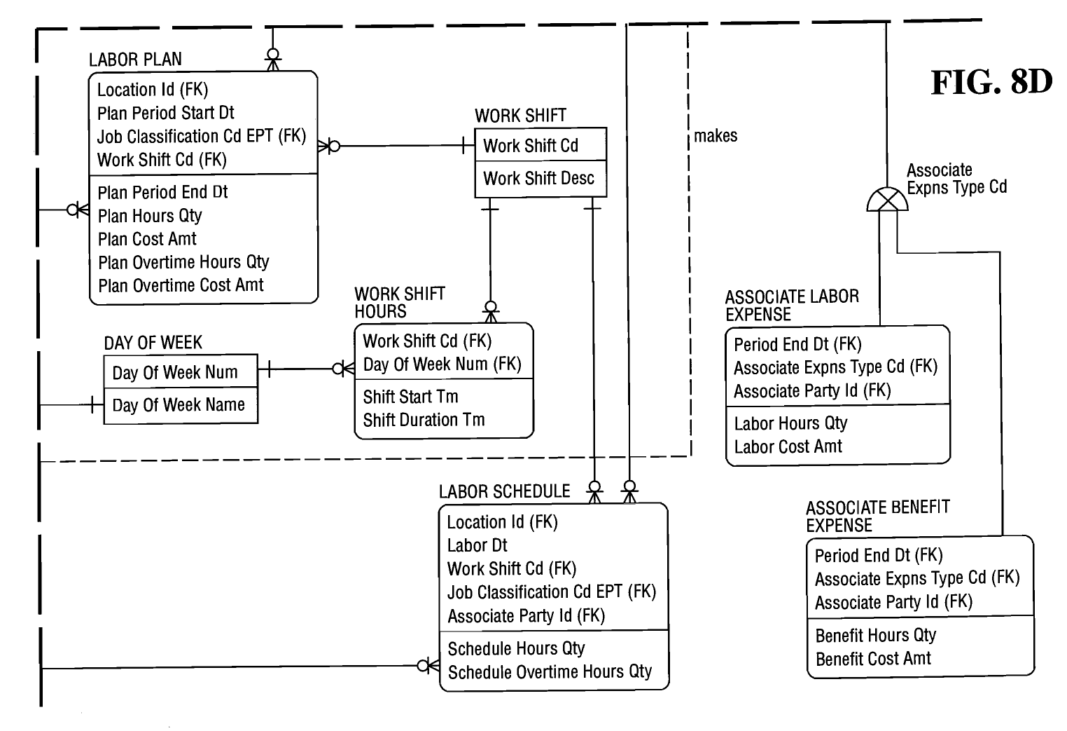

ASSOCIATE LABOR Subject Area, illustrated in FIG. 8;

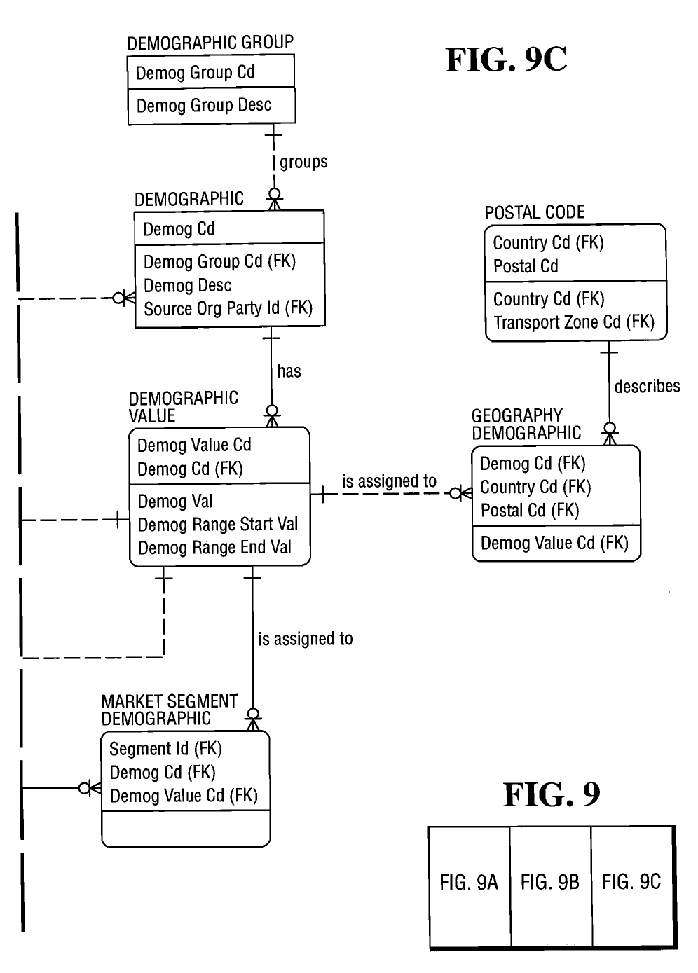

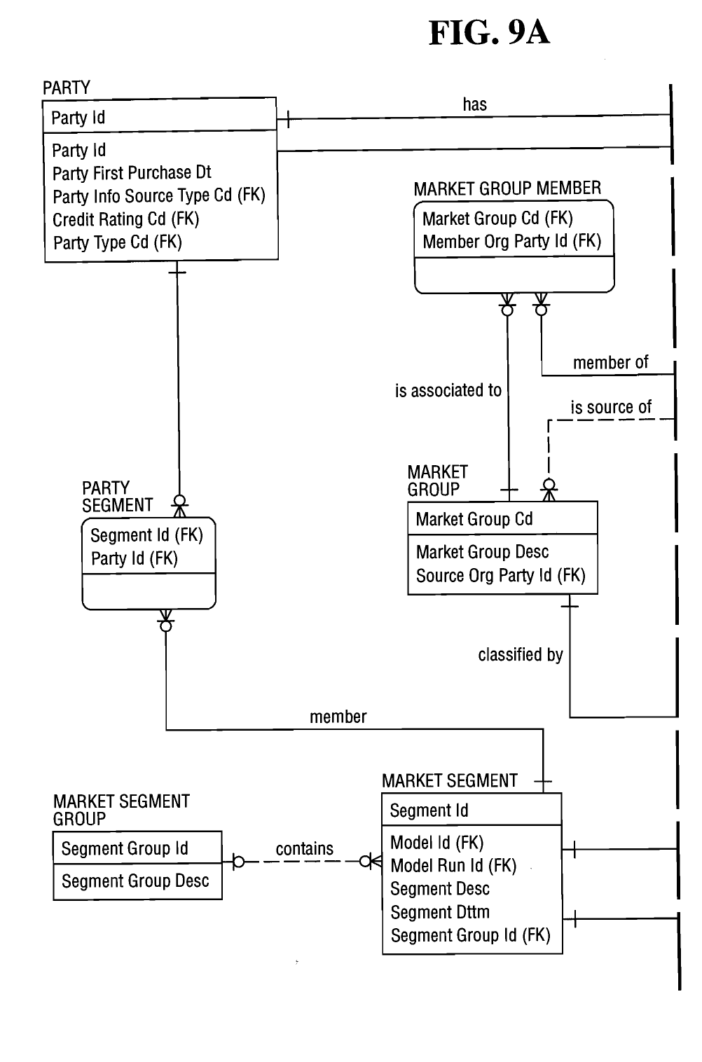

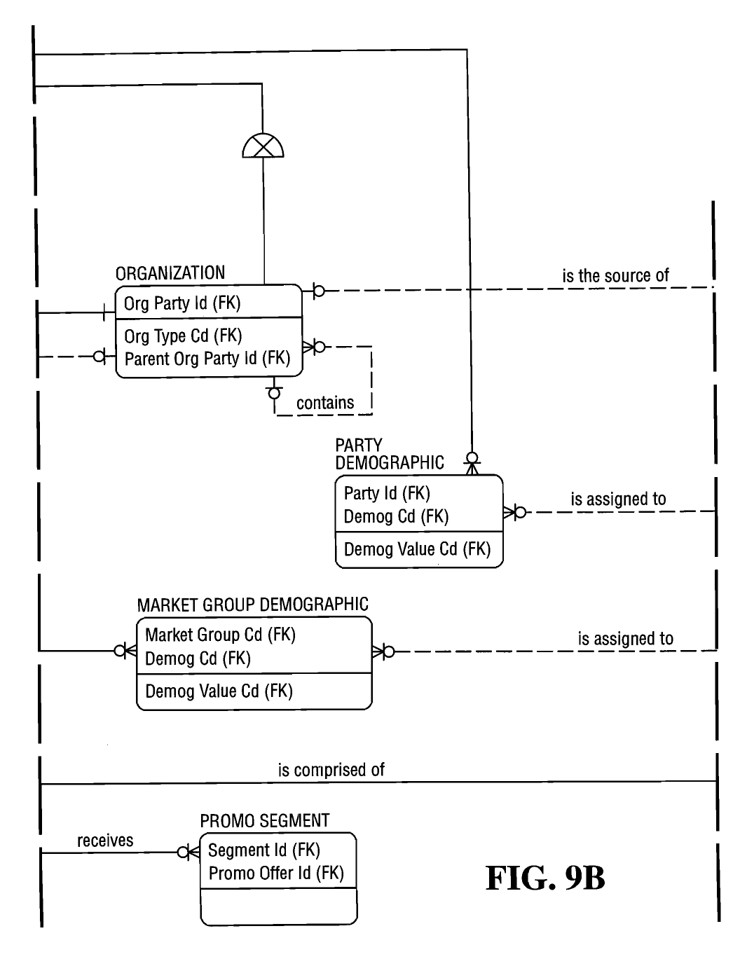

DEMOGRAPHICS Subject Area, illustrated in FIG. 9;

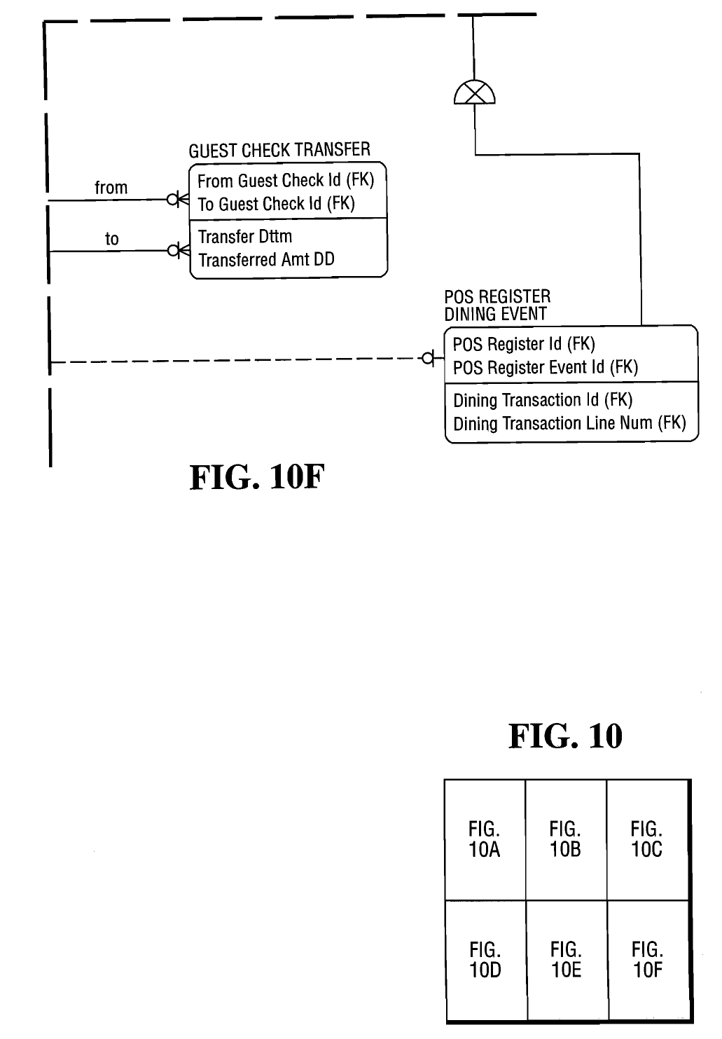

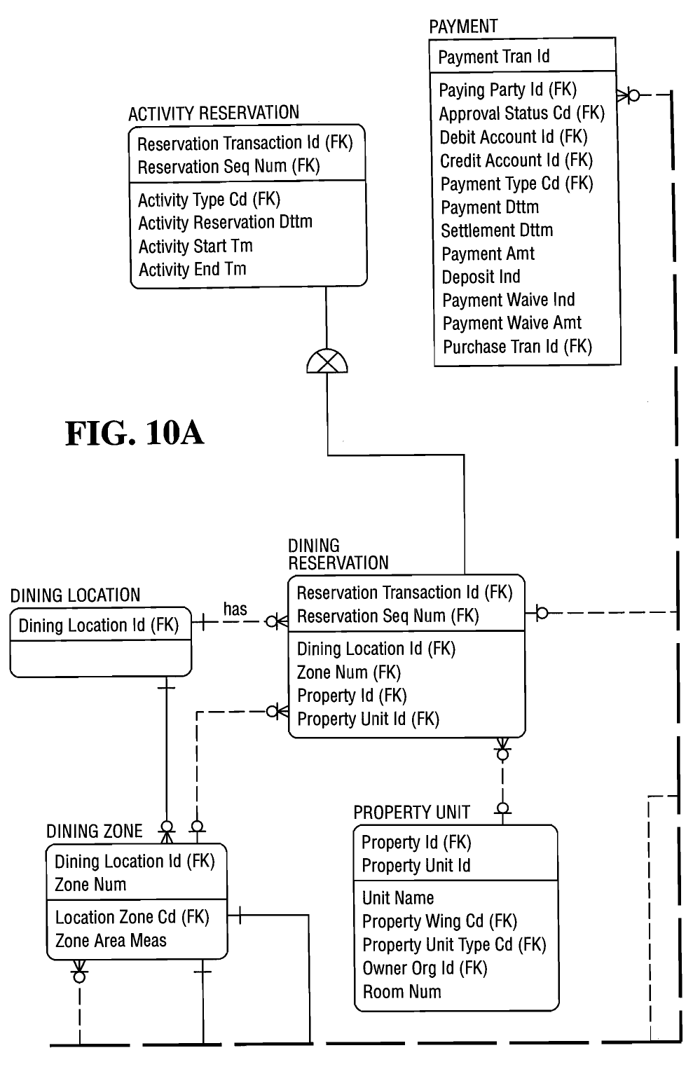

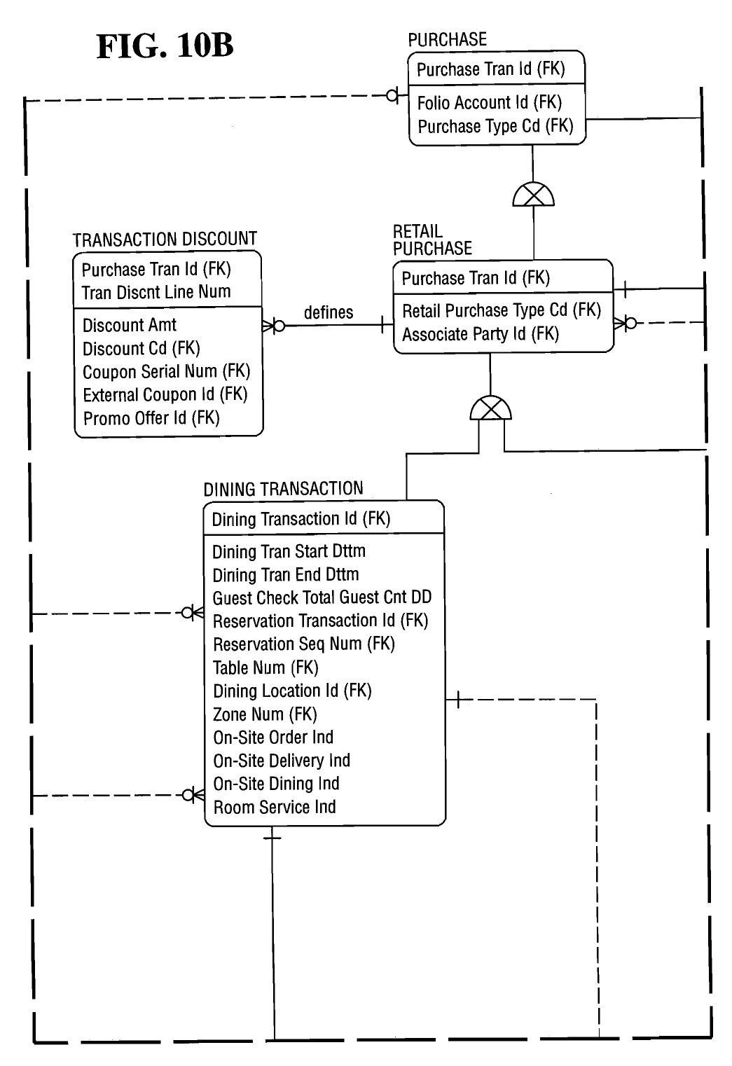

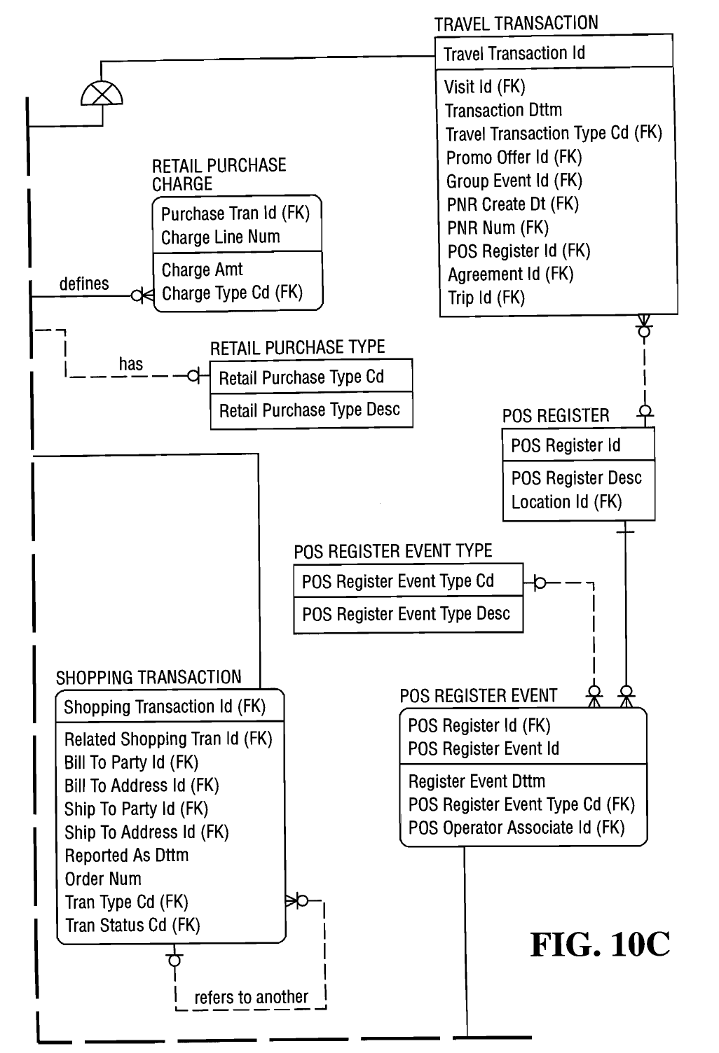

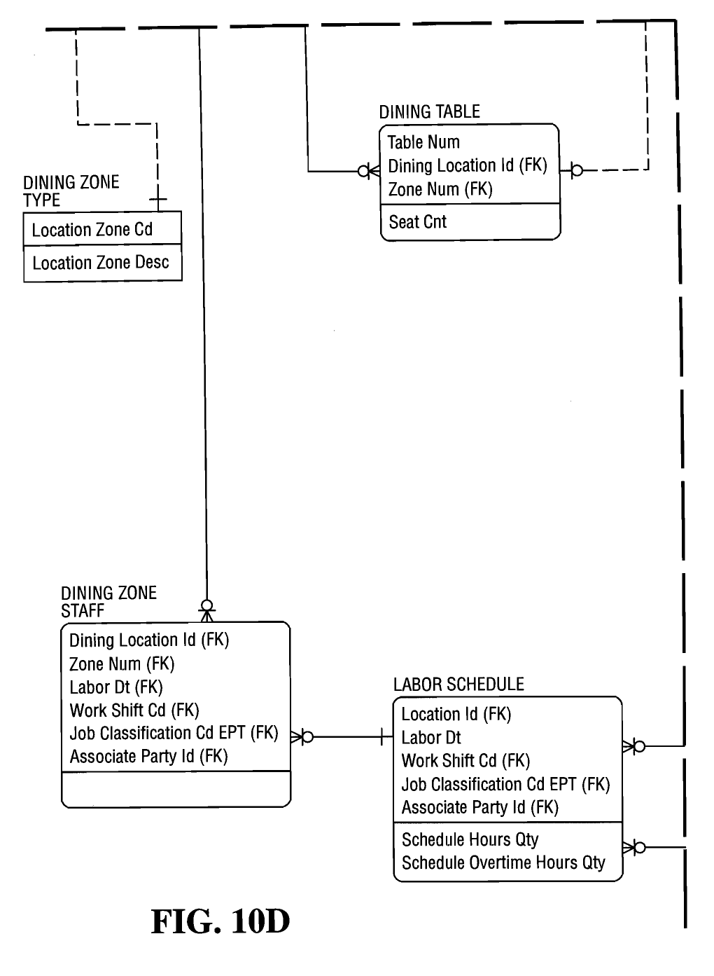

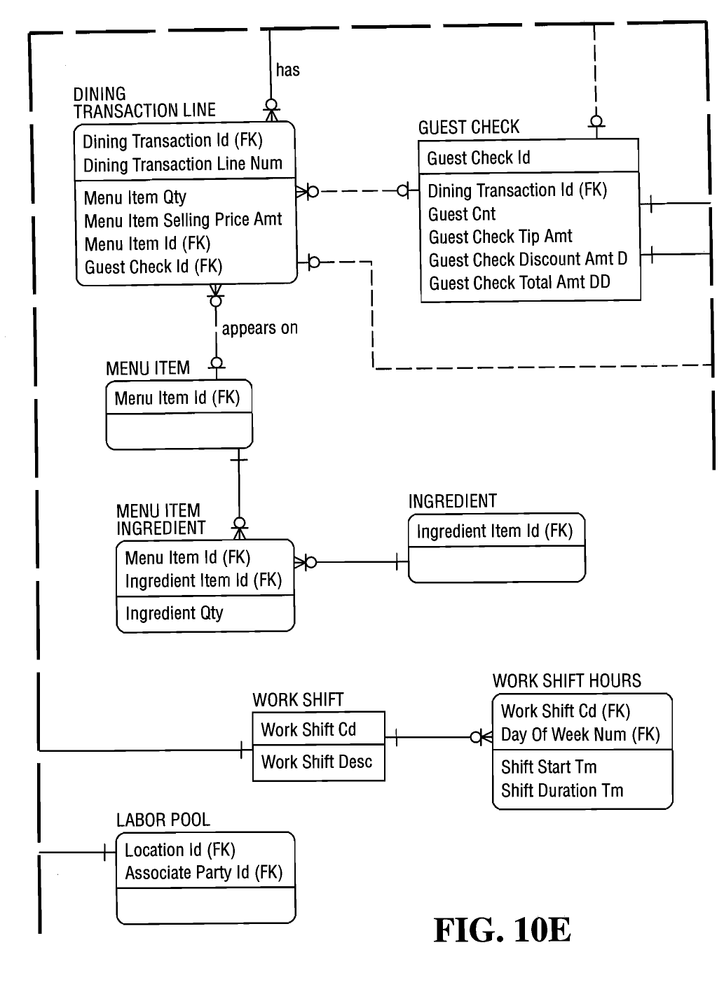

HOSPITALITY DINING TRANSACTION Subject Area, illustrated in FIG. 10;

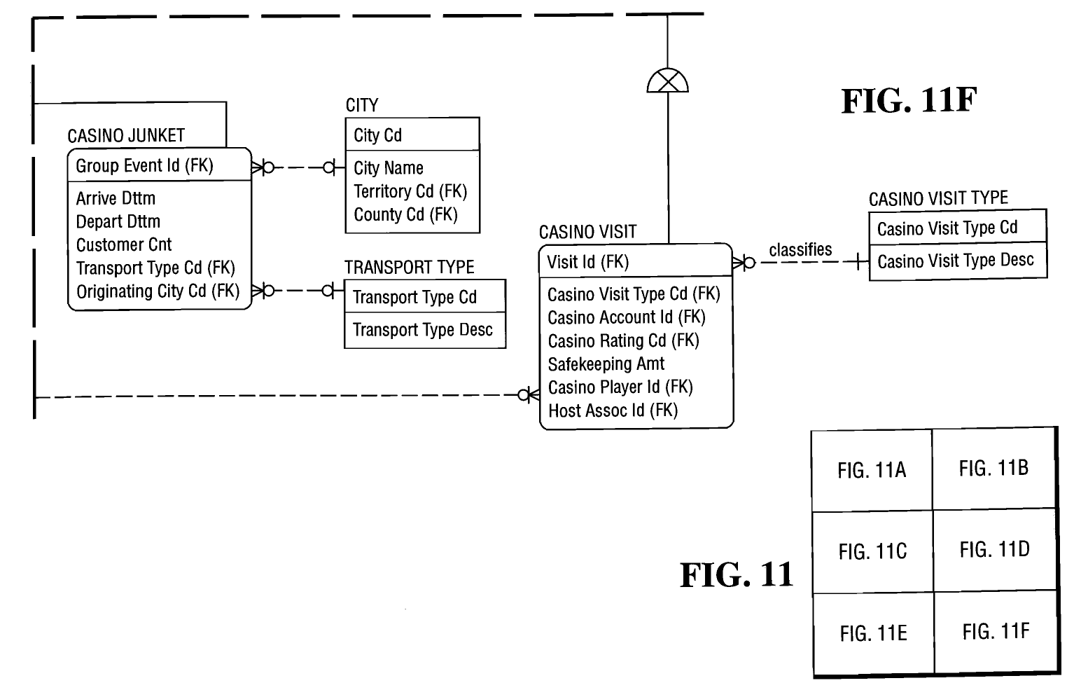

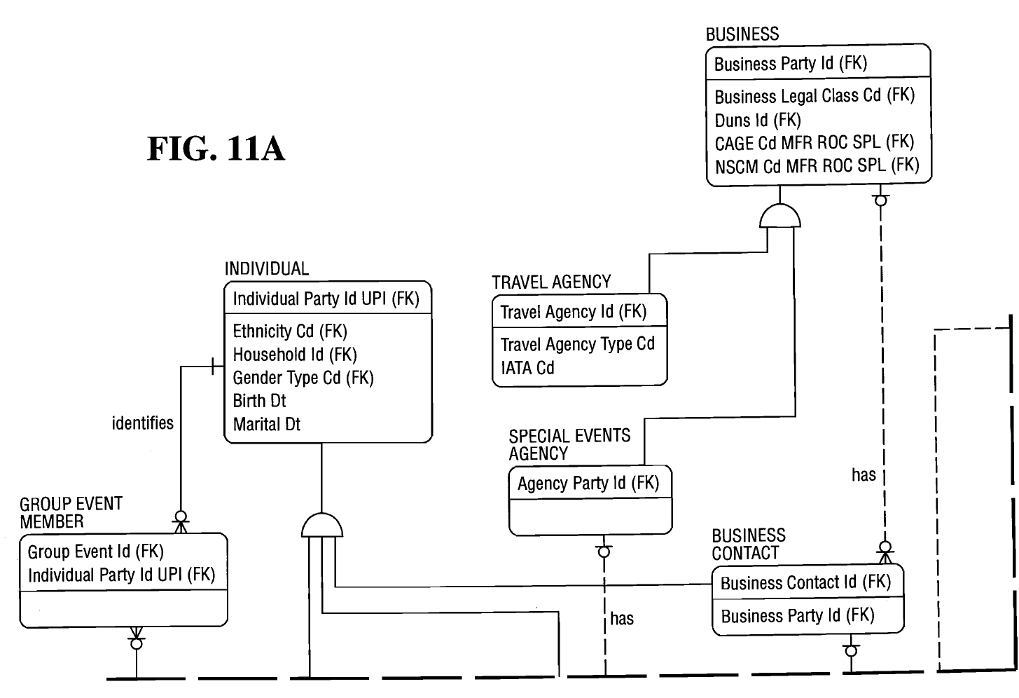

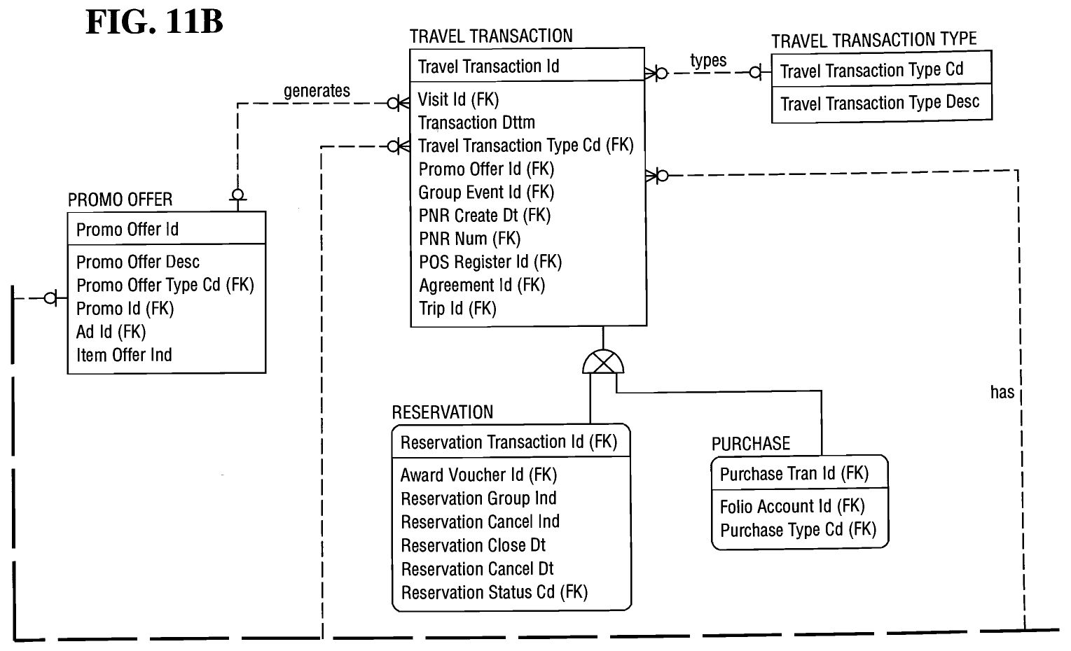

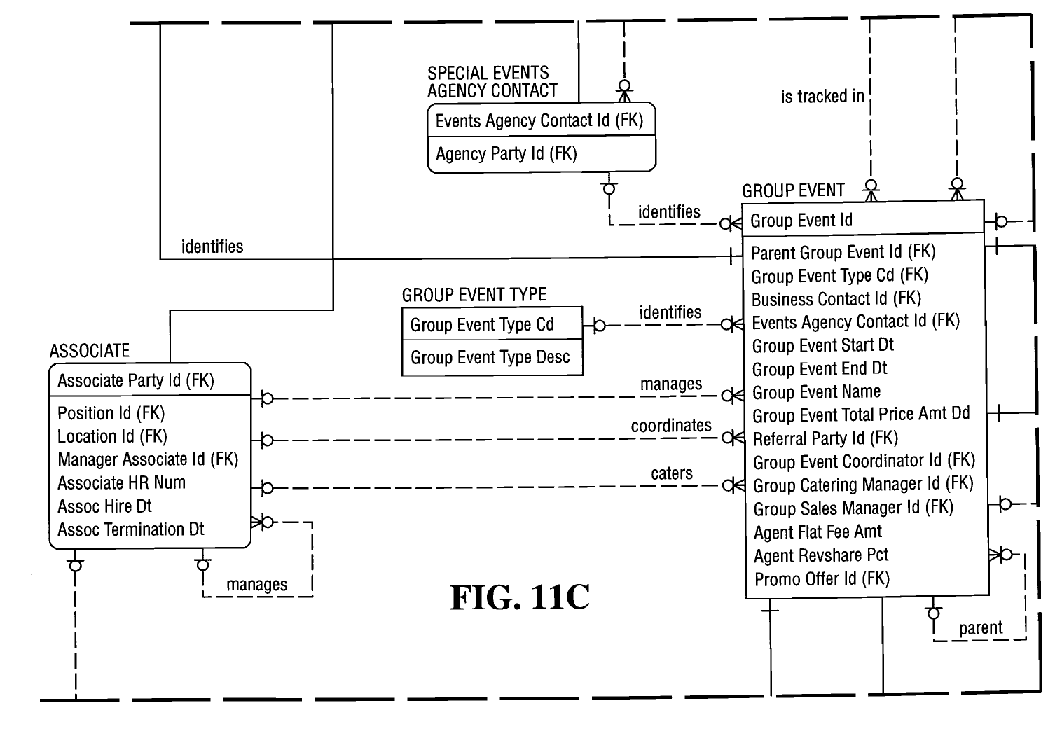

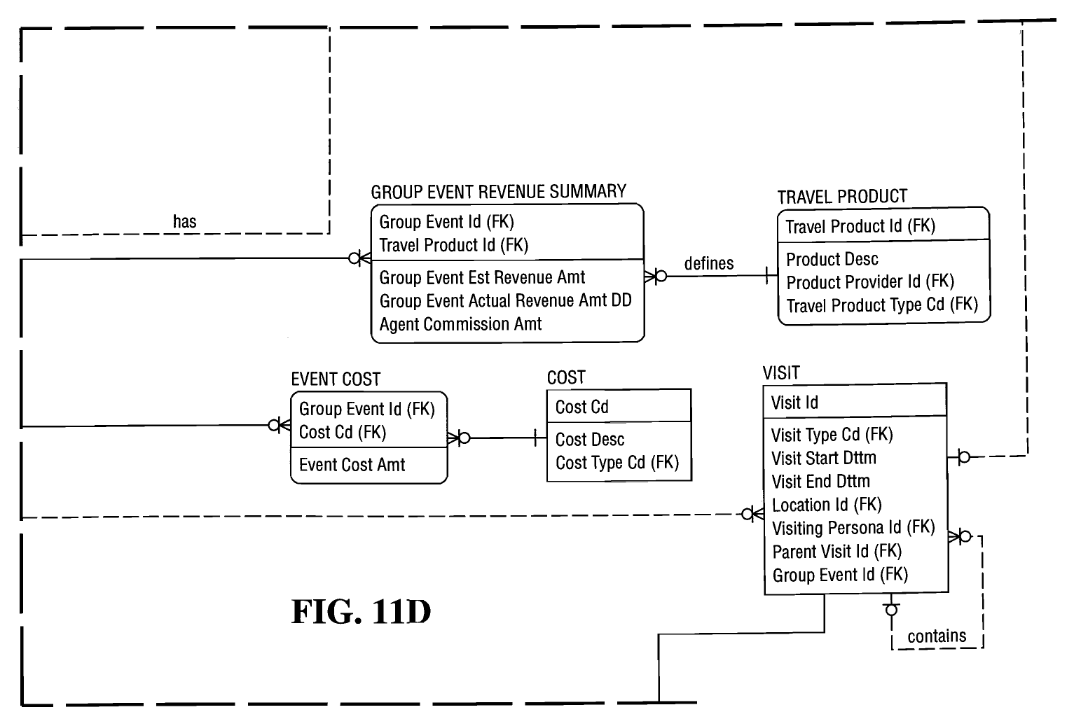

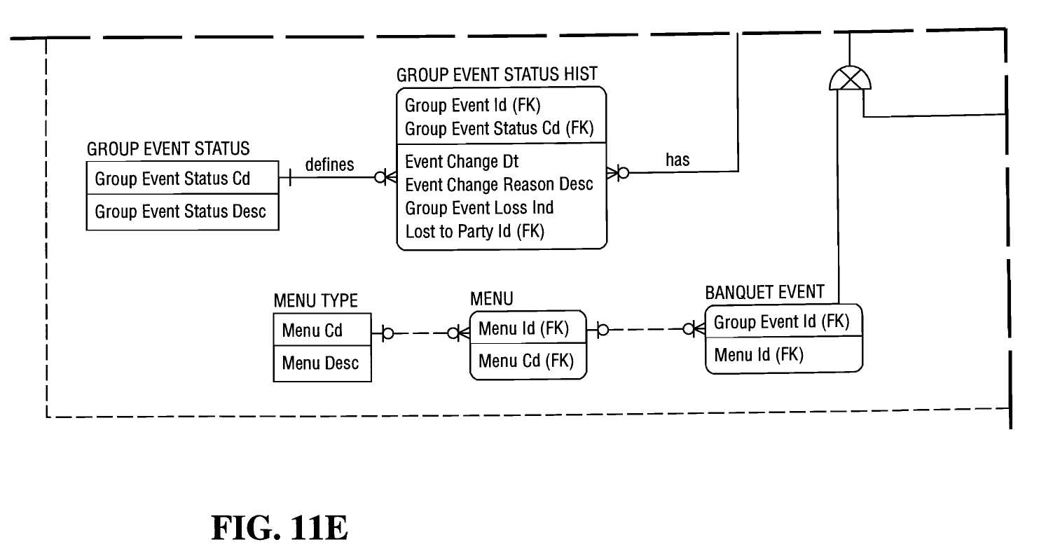

HOSPITALITY GROUP EVENT Subject Area, illustrated in FIG. 11;

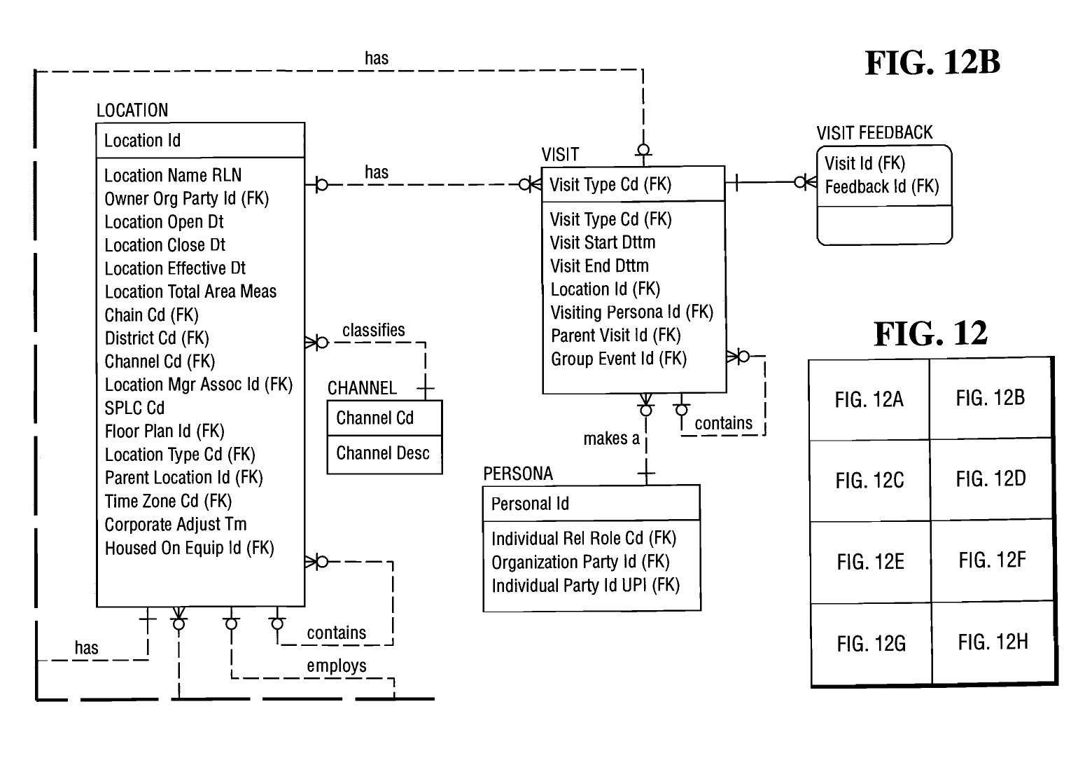

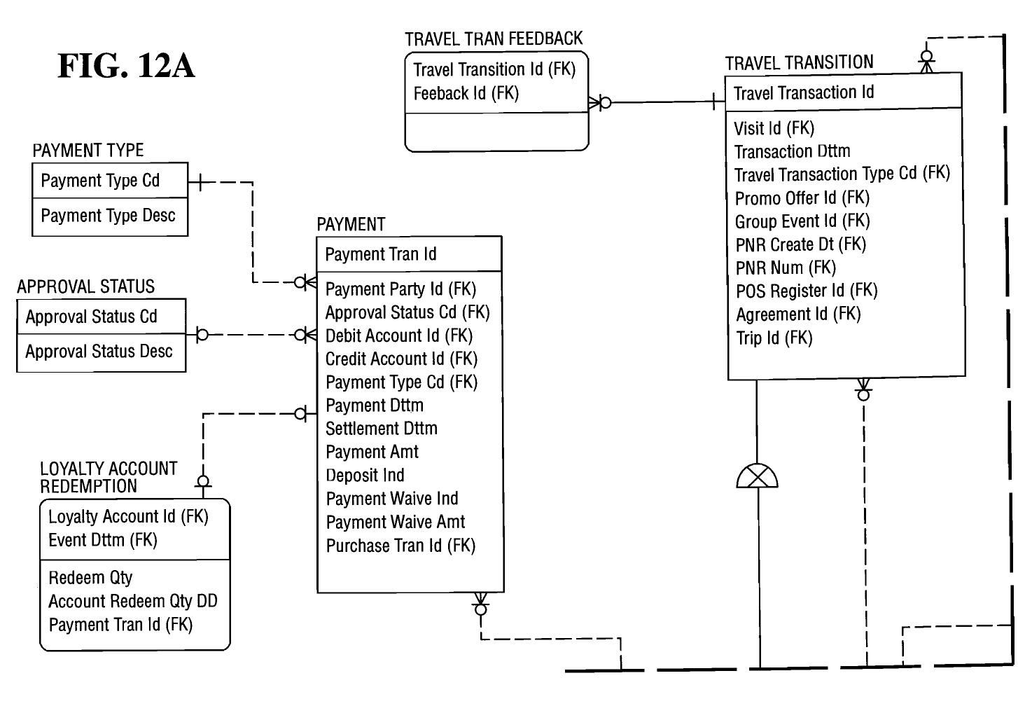

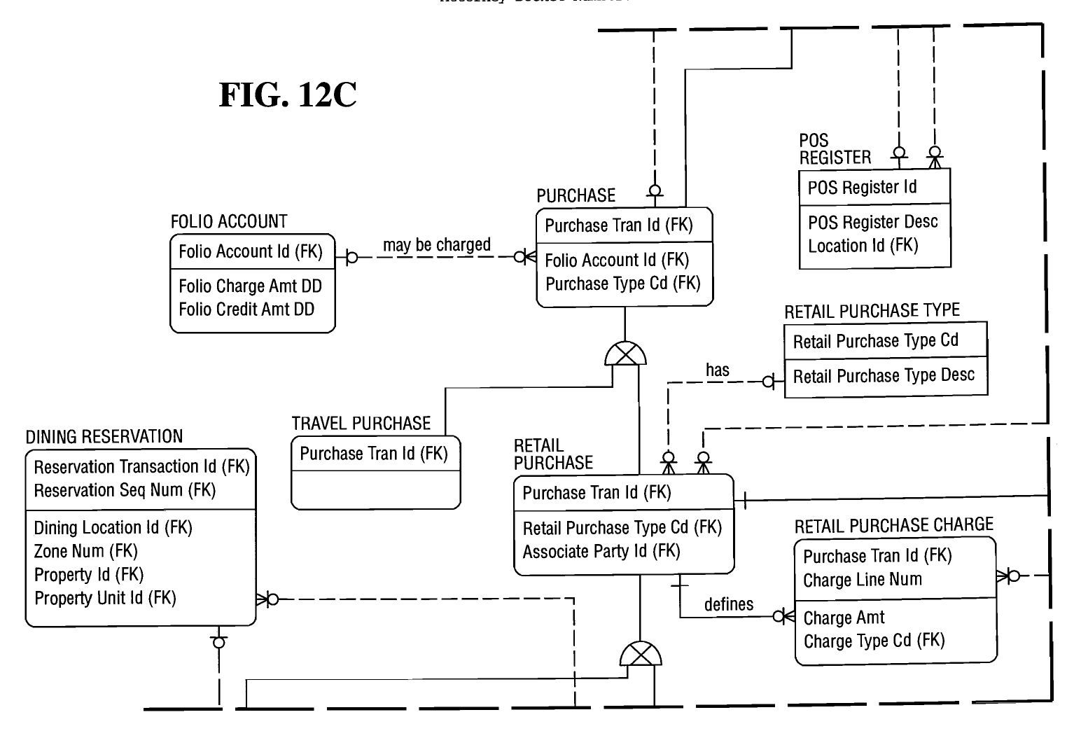

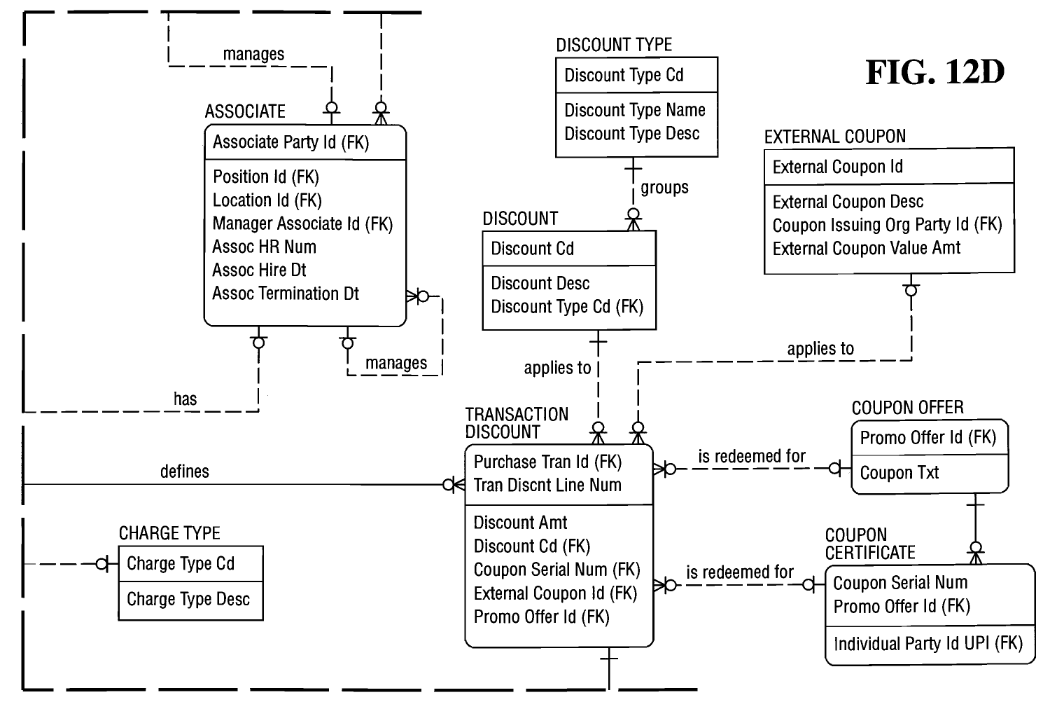

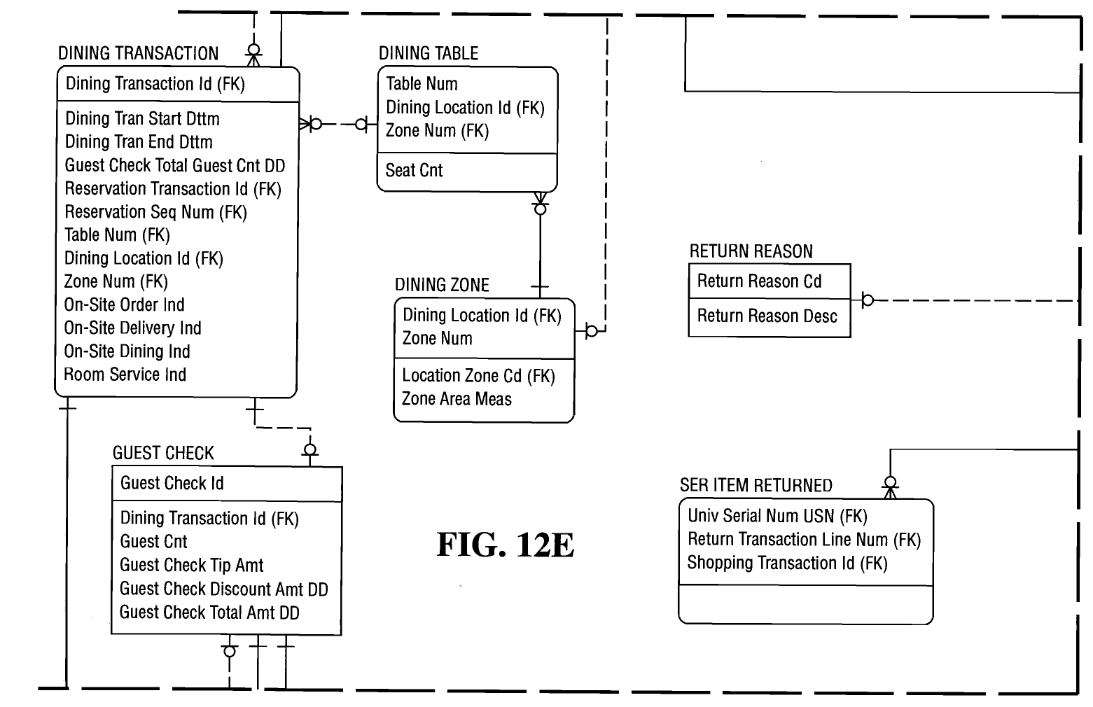

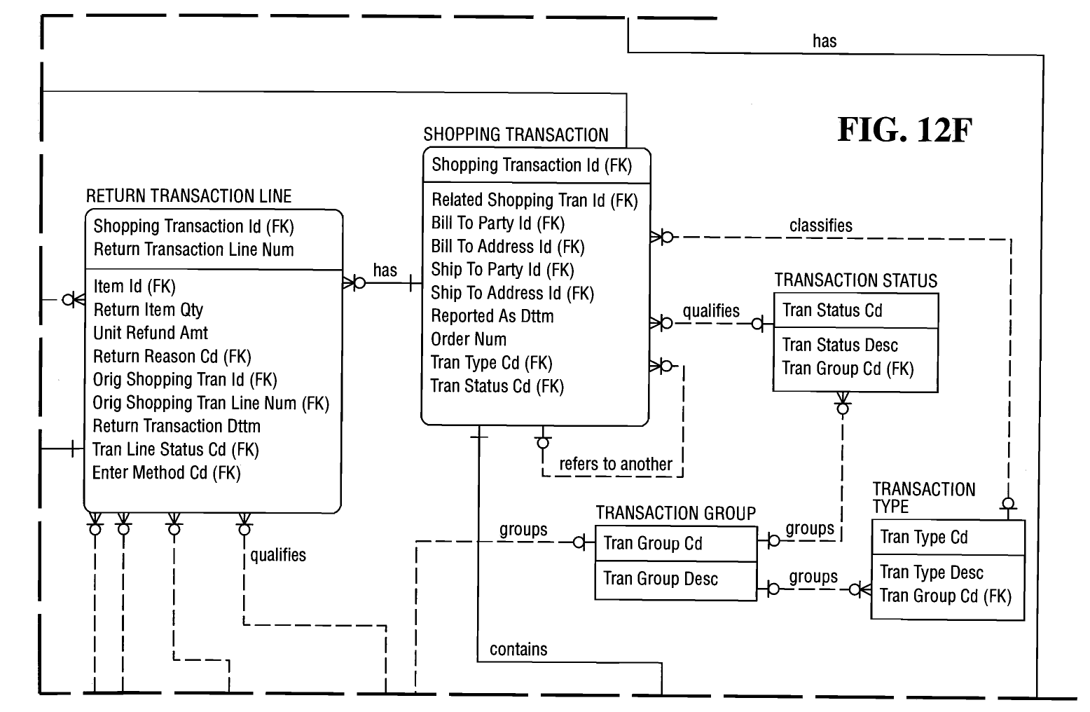

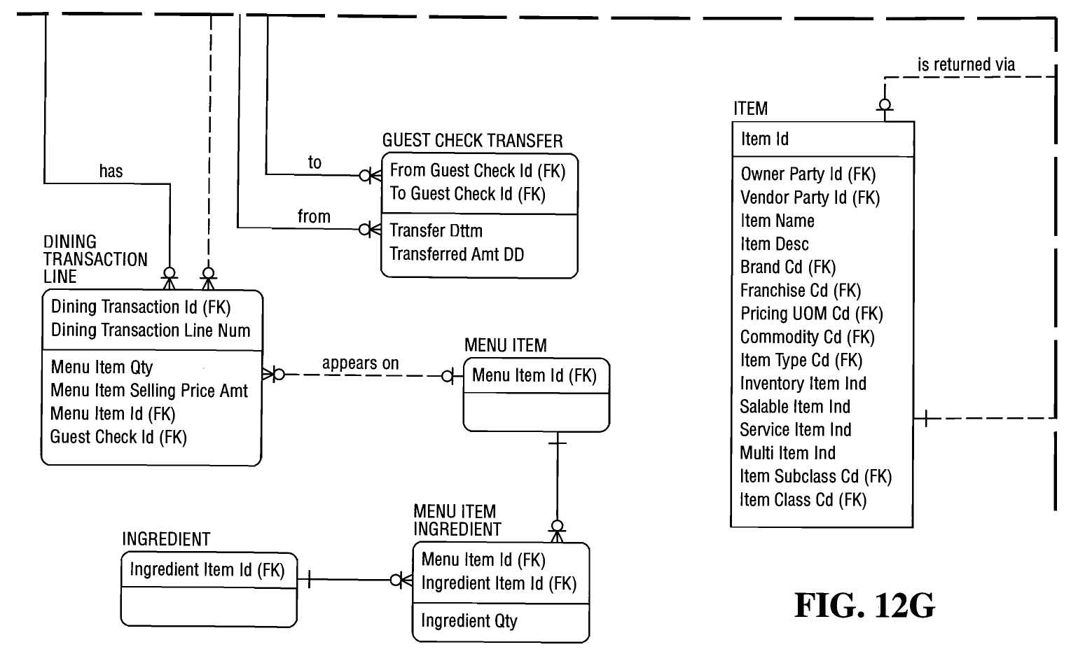

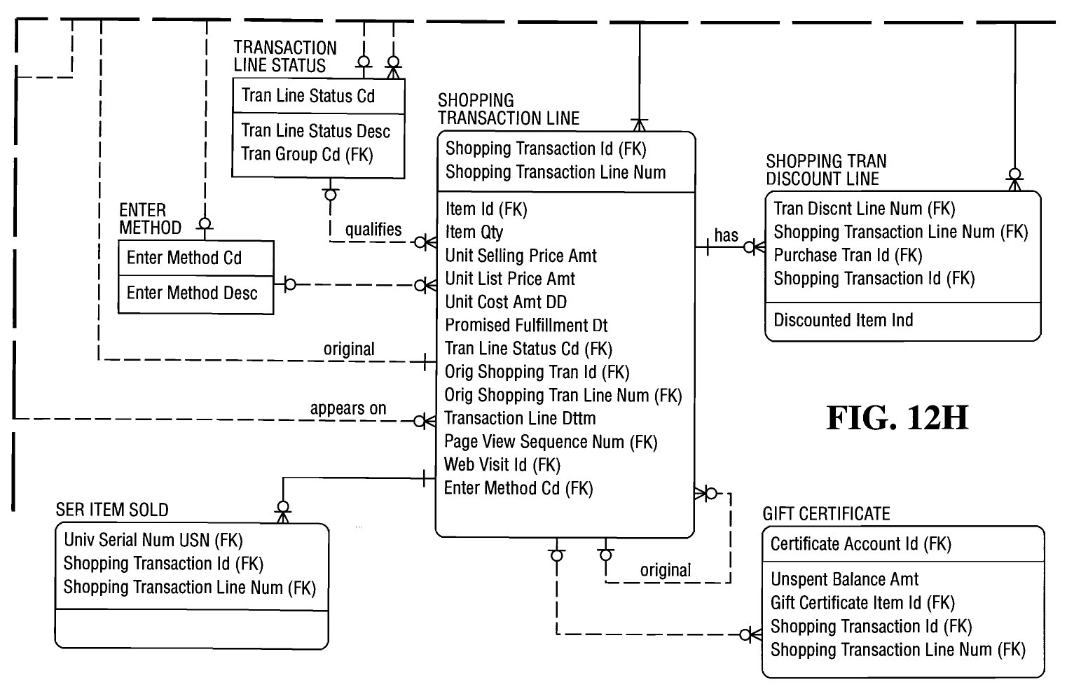

HOSPITALITY RETAIL PURCHASE Subject Area, illustrated in FIG. 12;

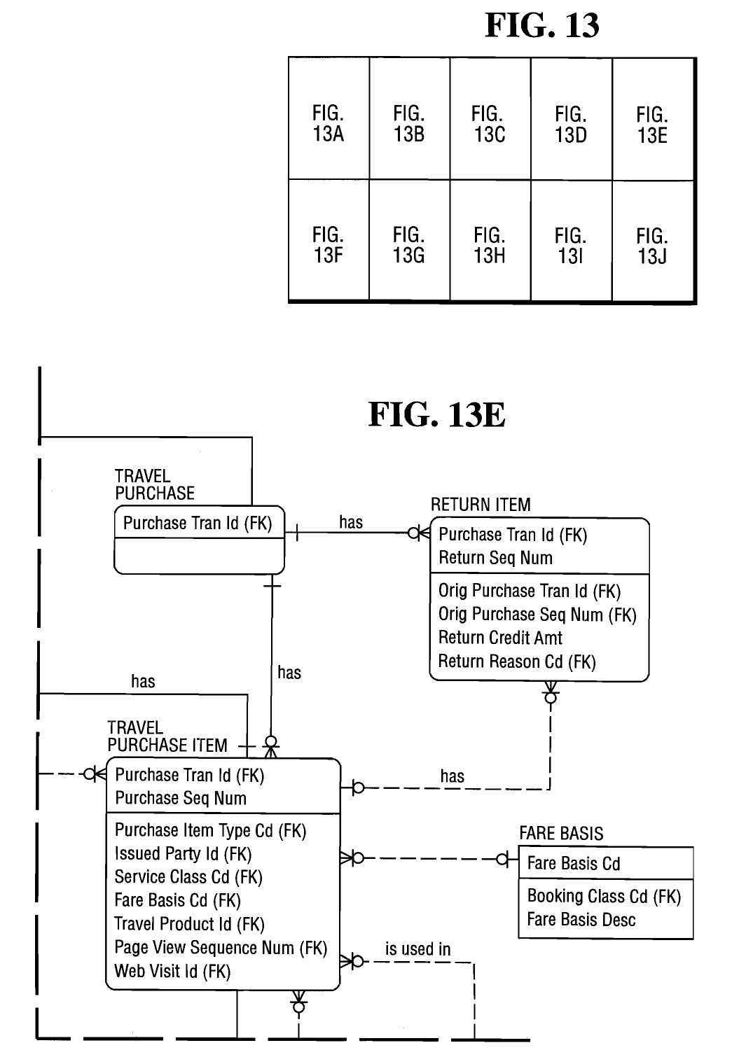

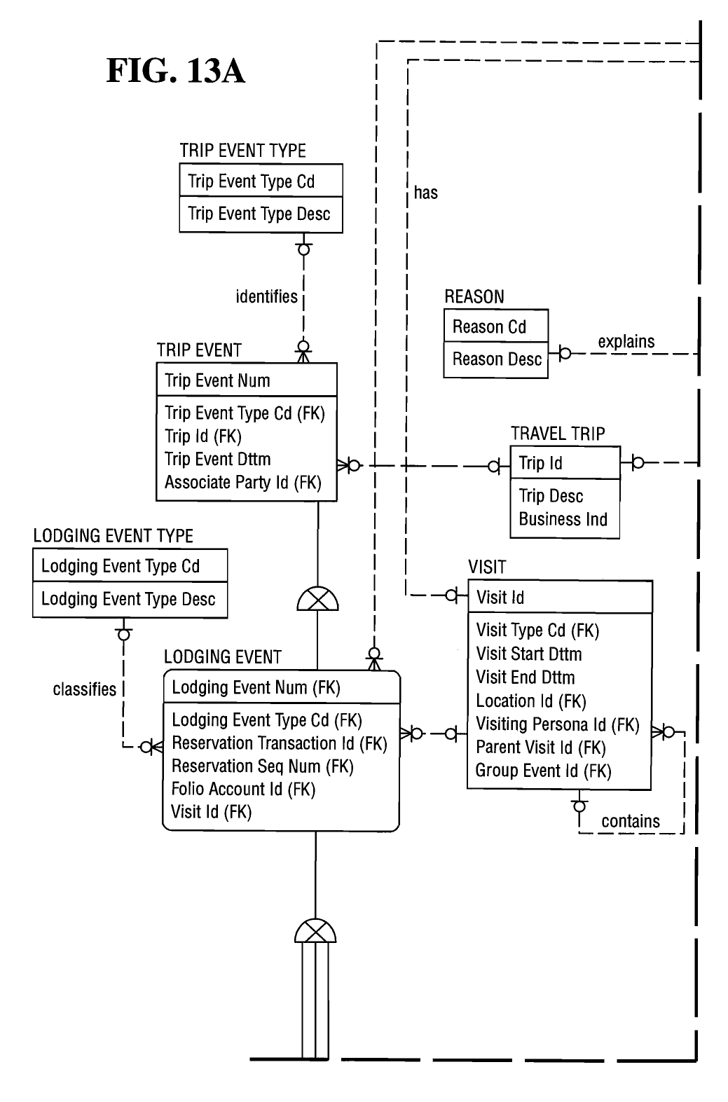

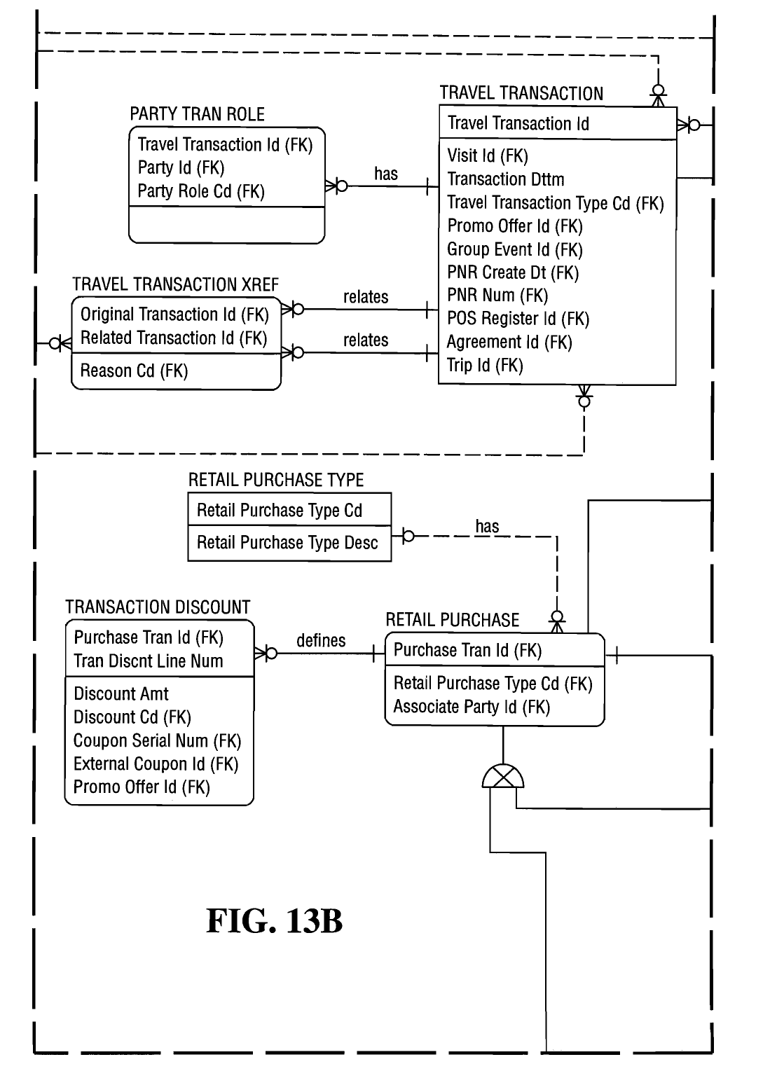

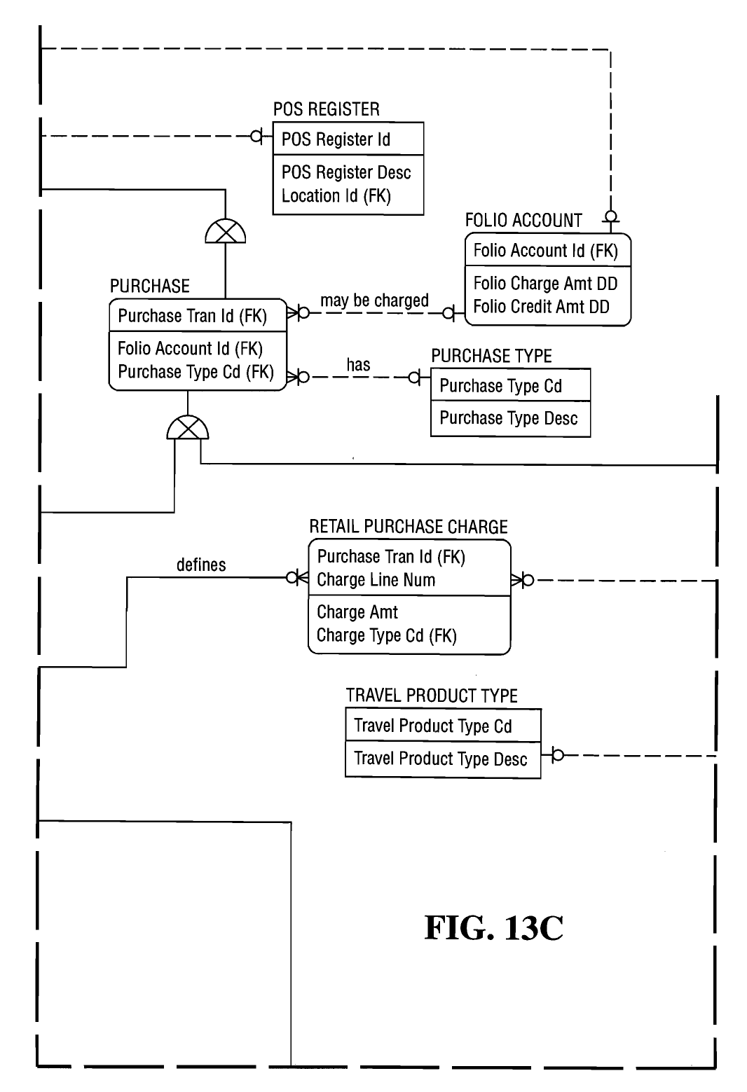

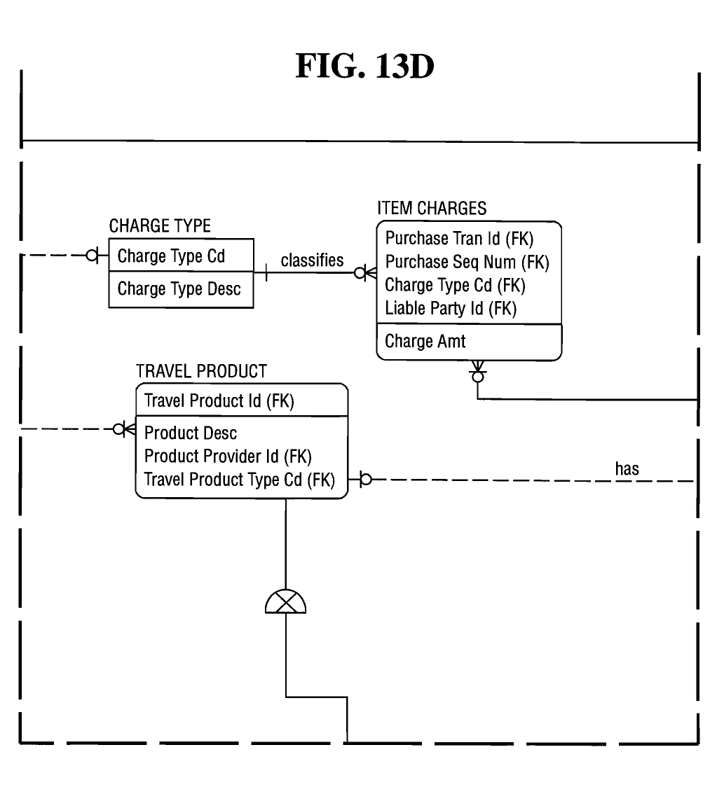

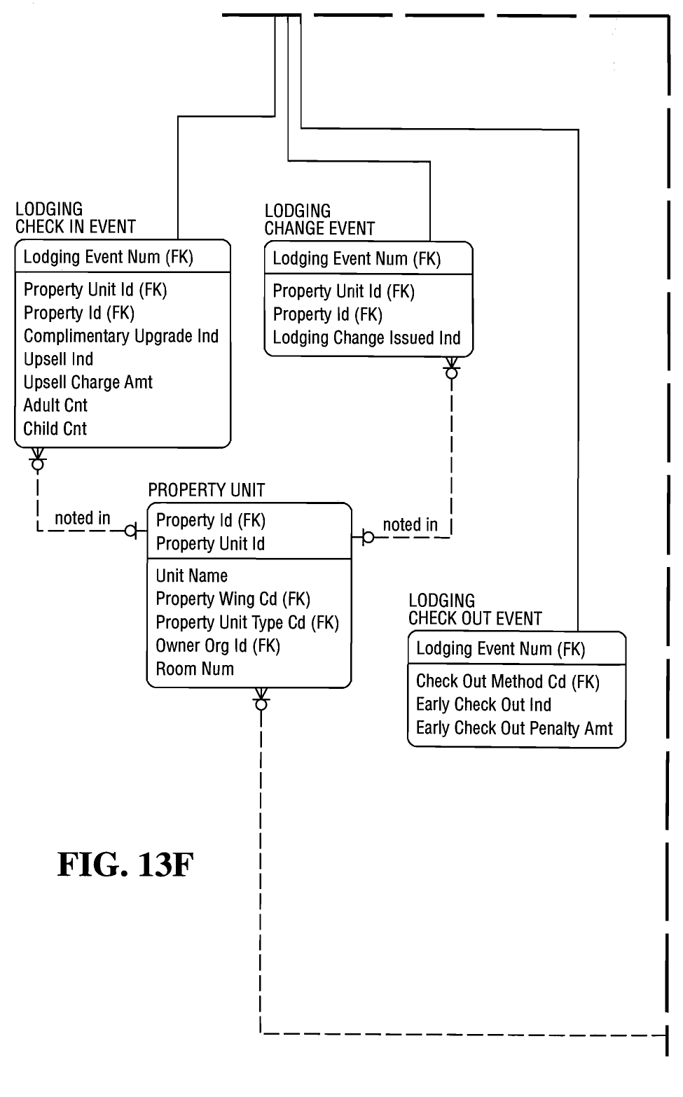

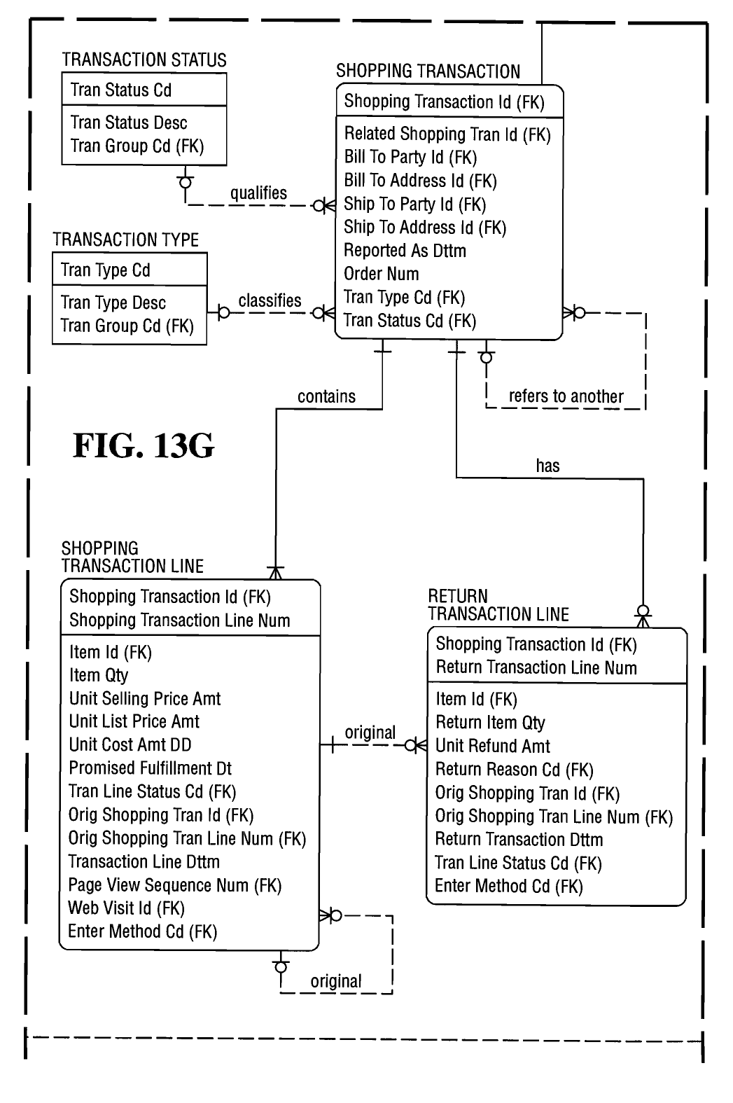

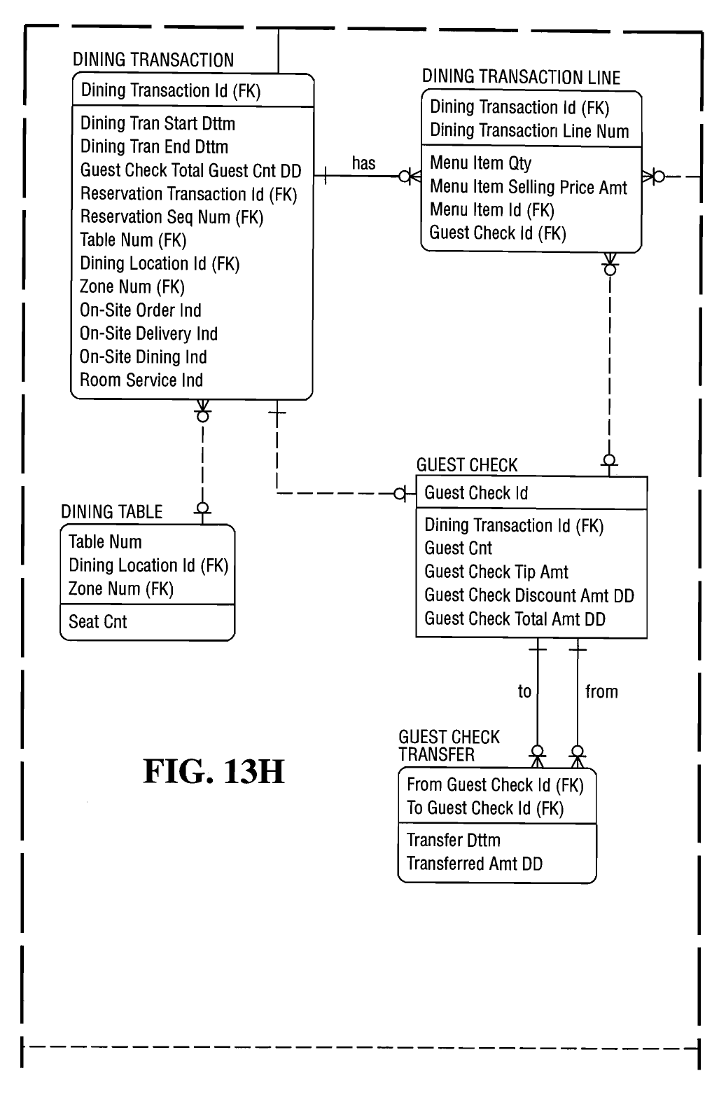

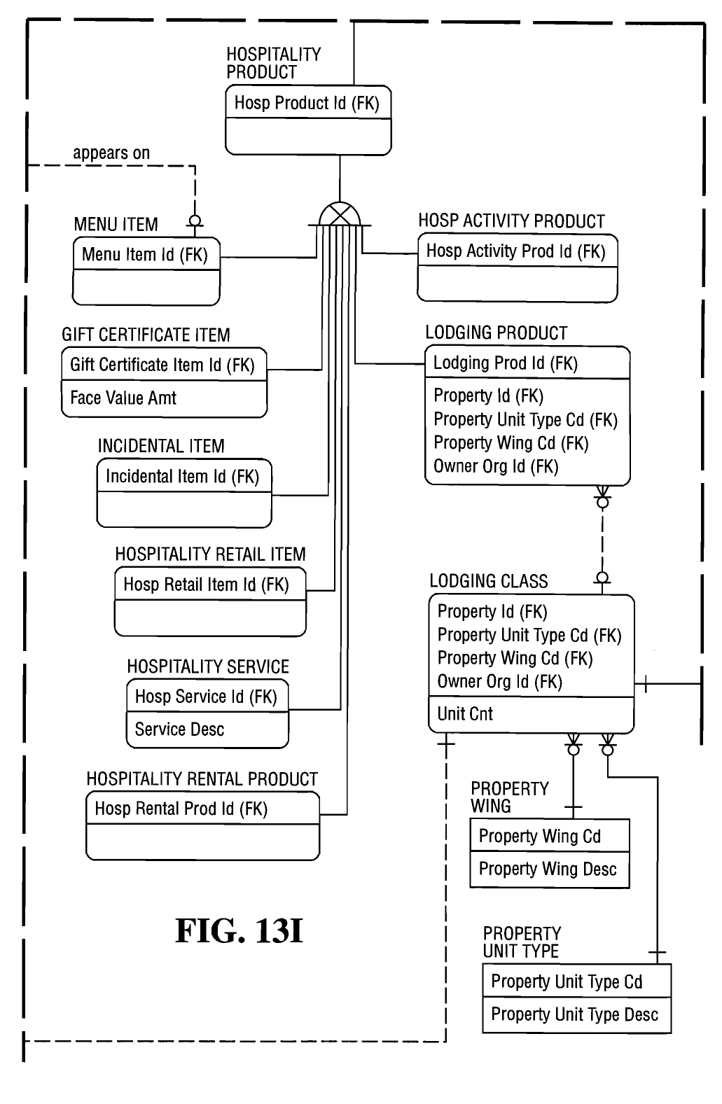

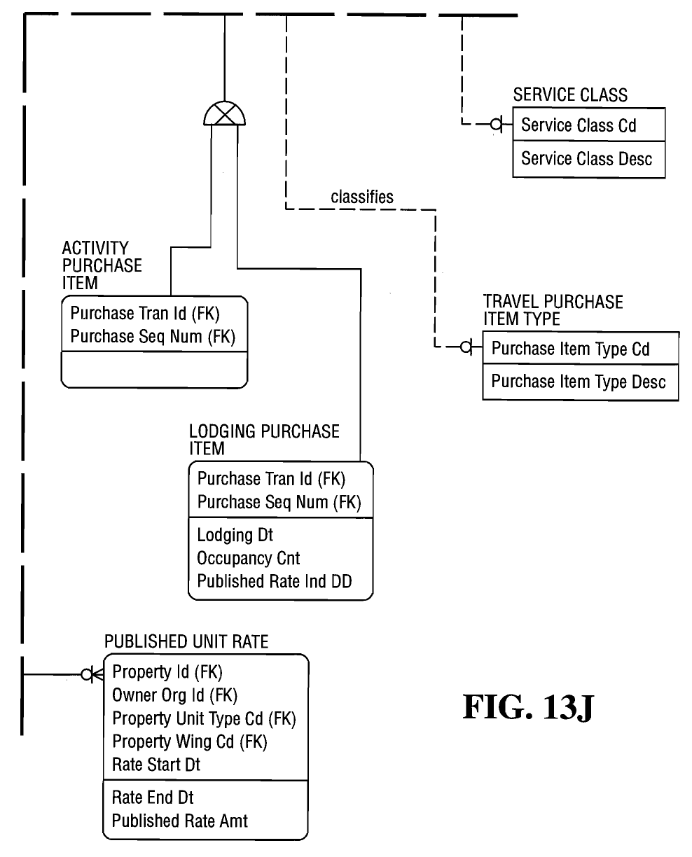

HOSPITALITY ROOM CHARGES Subject Area, illustrated in FIG. 13;

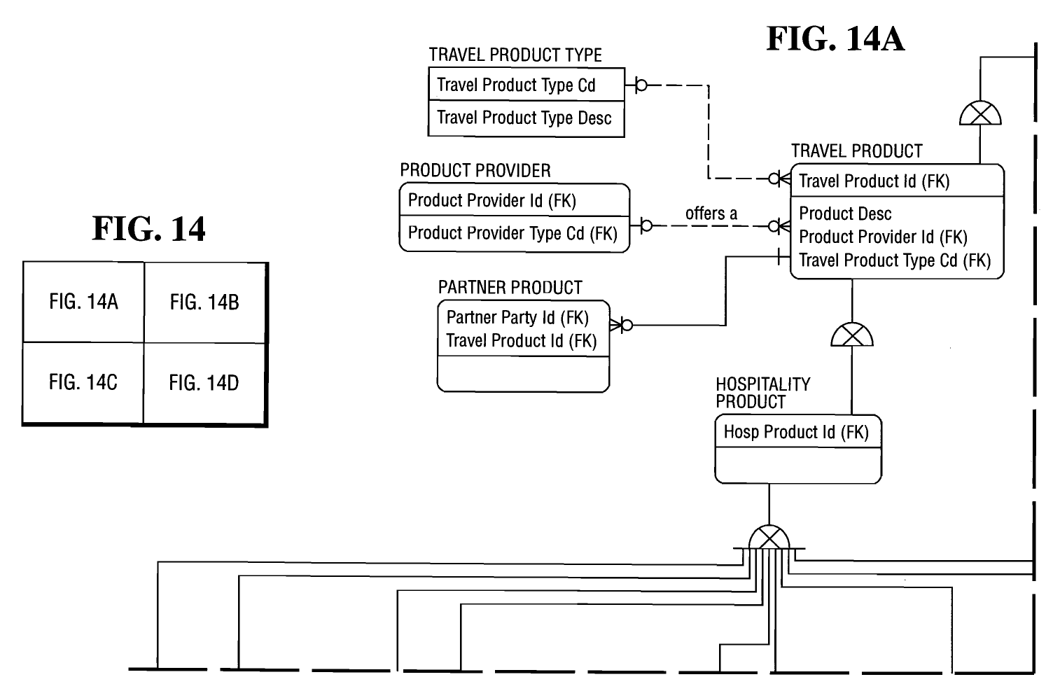

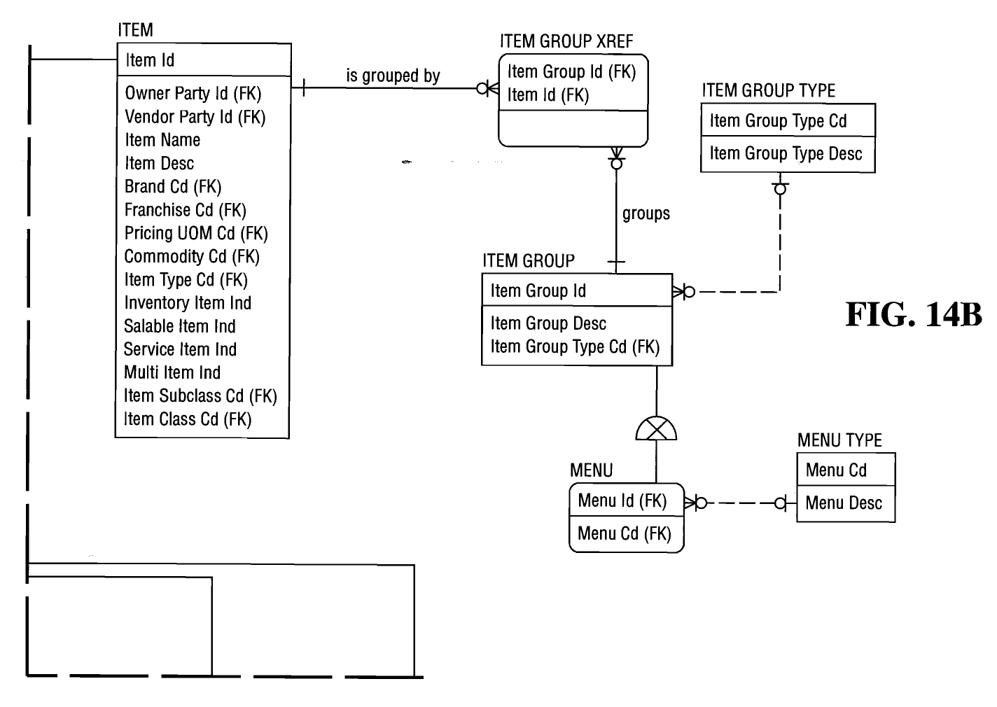

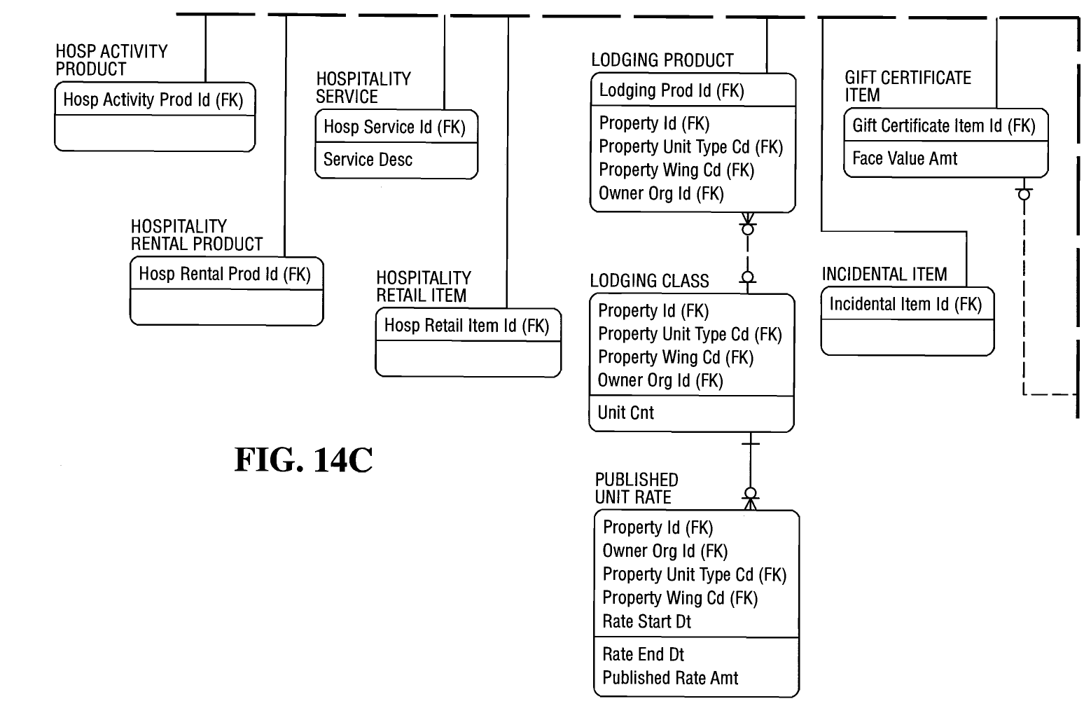

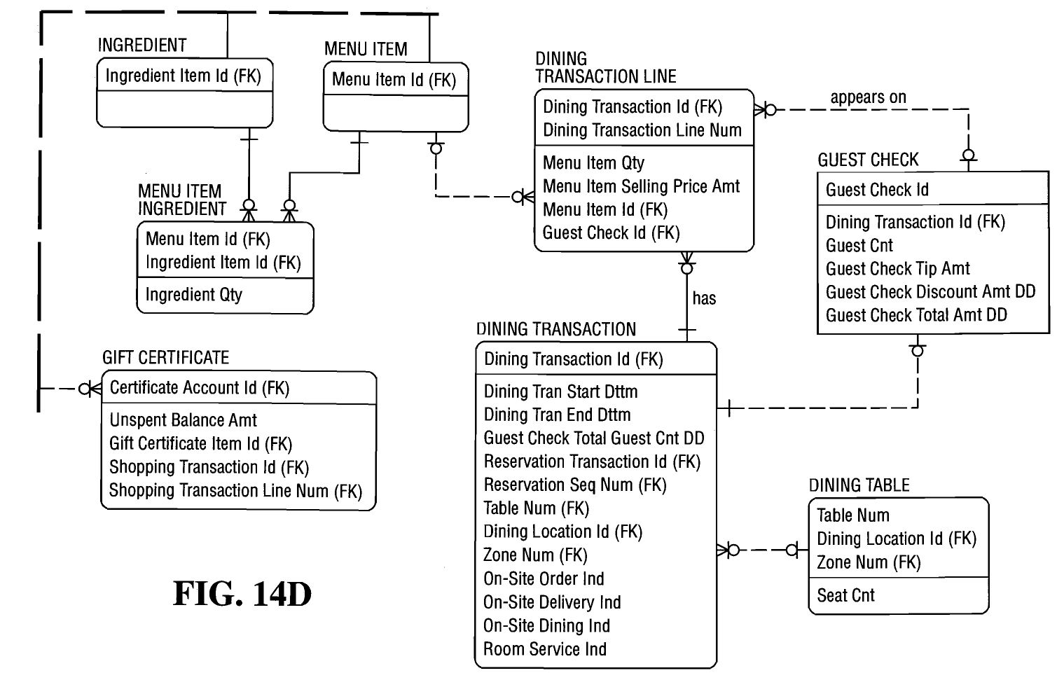

ITEM (HOSPITALITY) Subject Area, illustrated in FIG. 14;

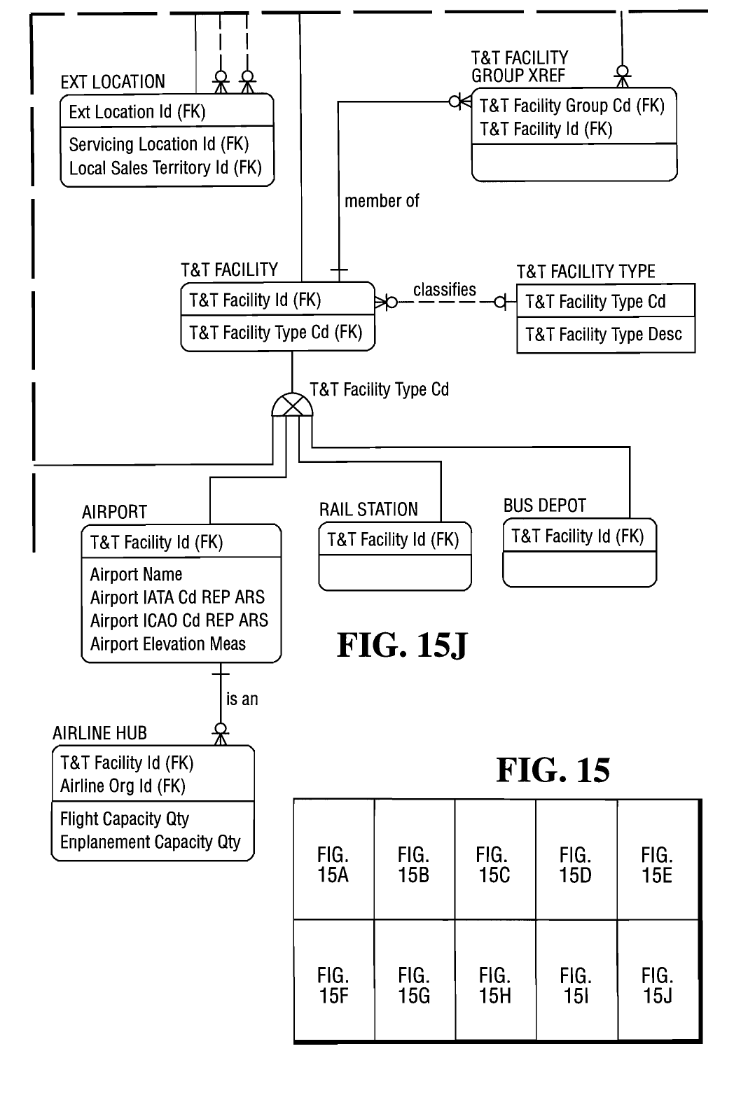

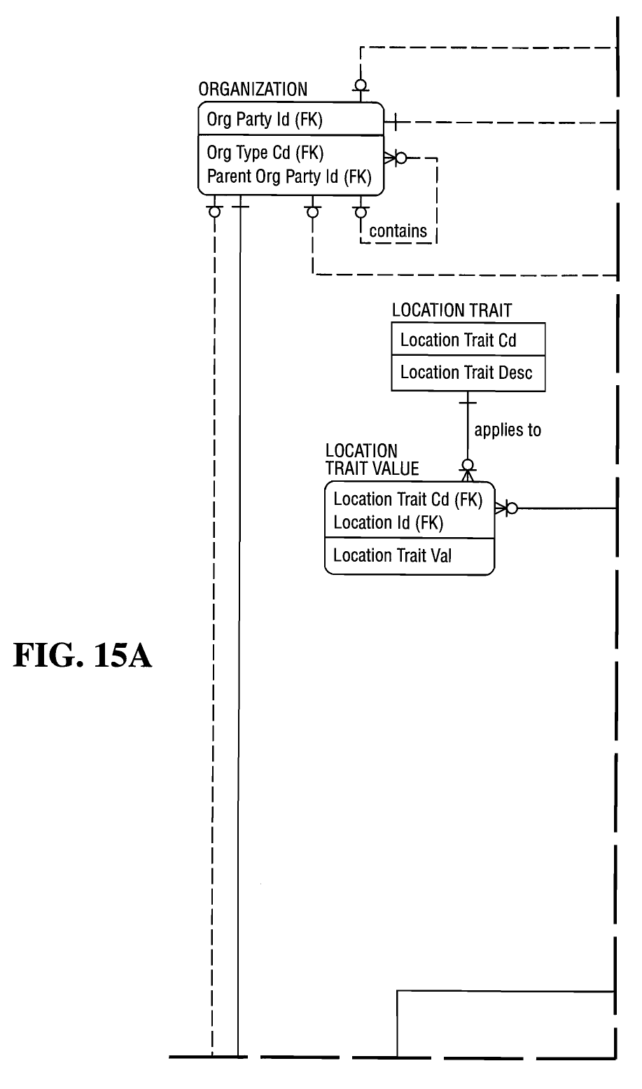

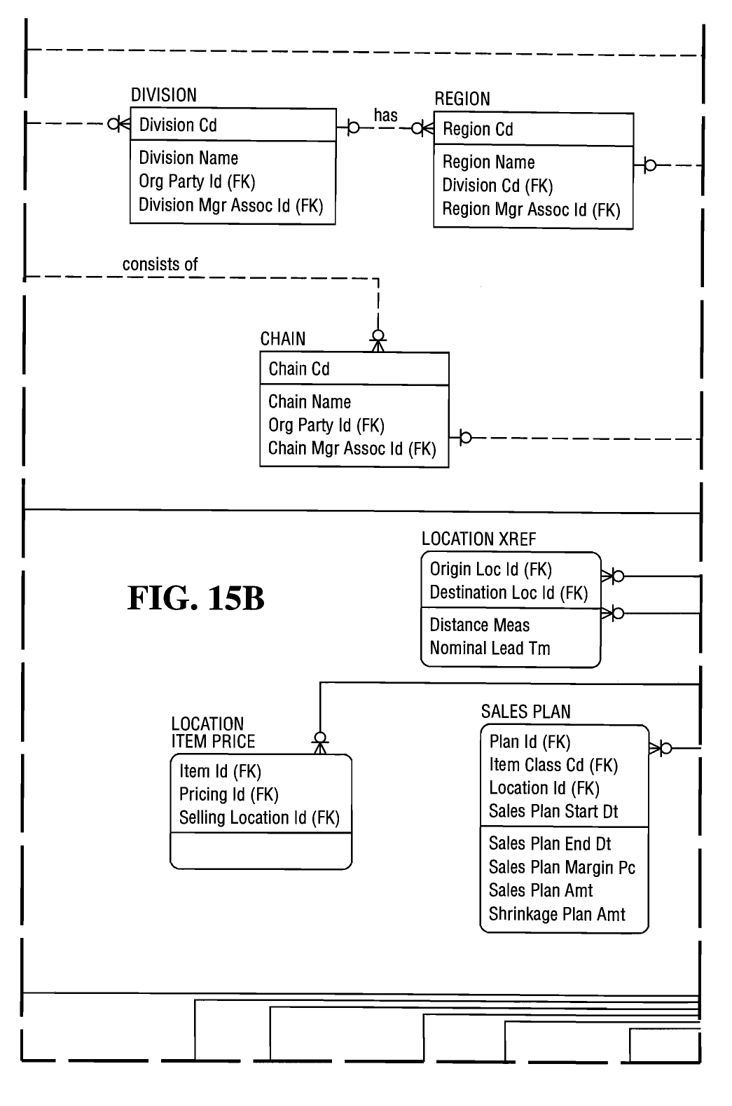

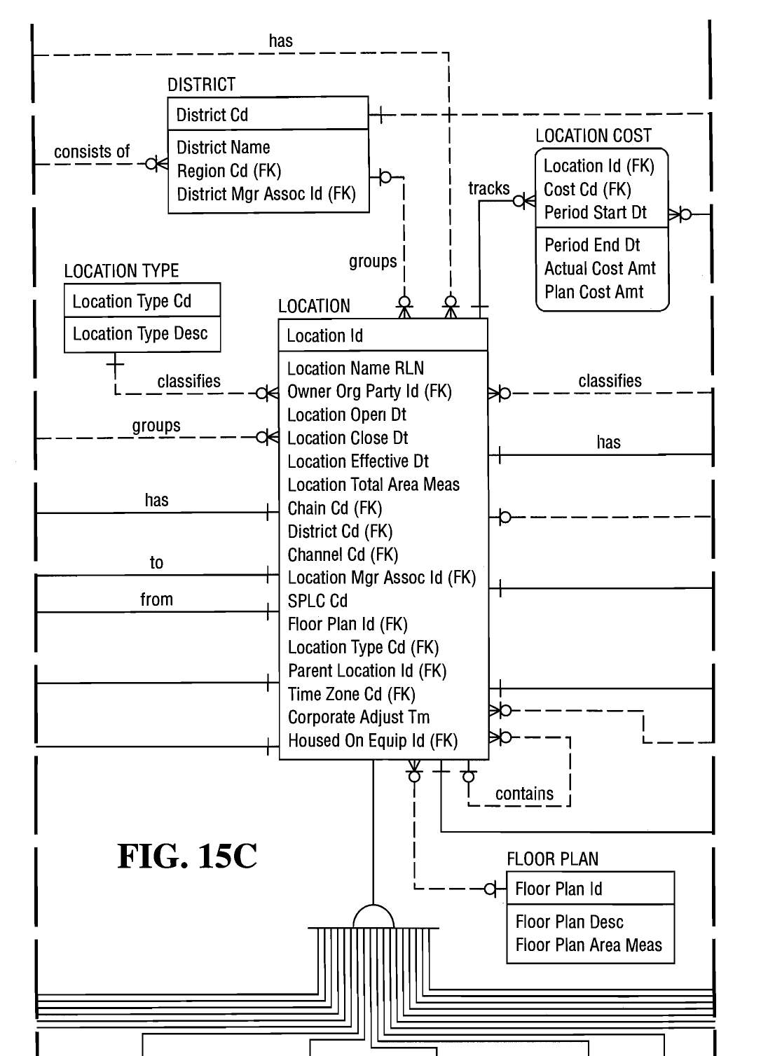

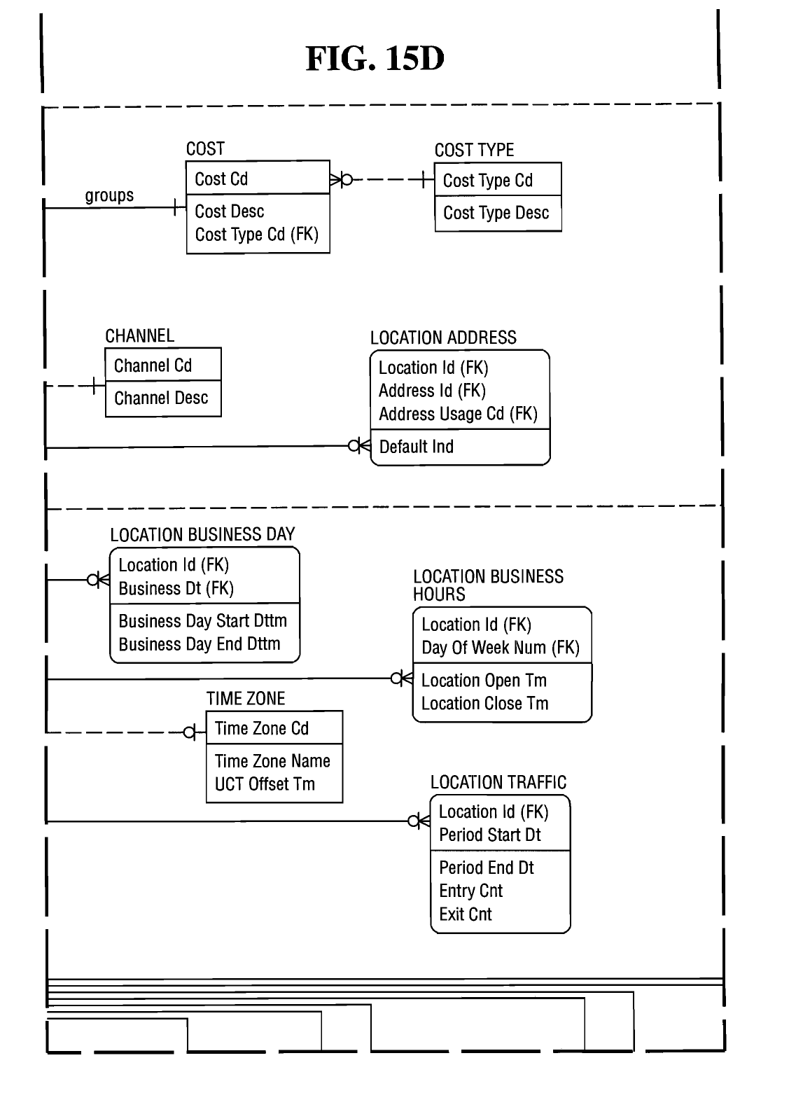

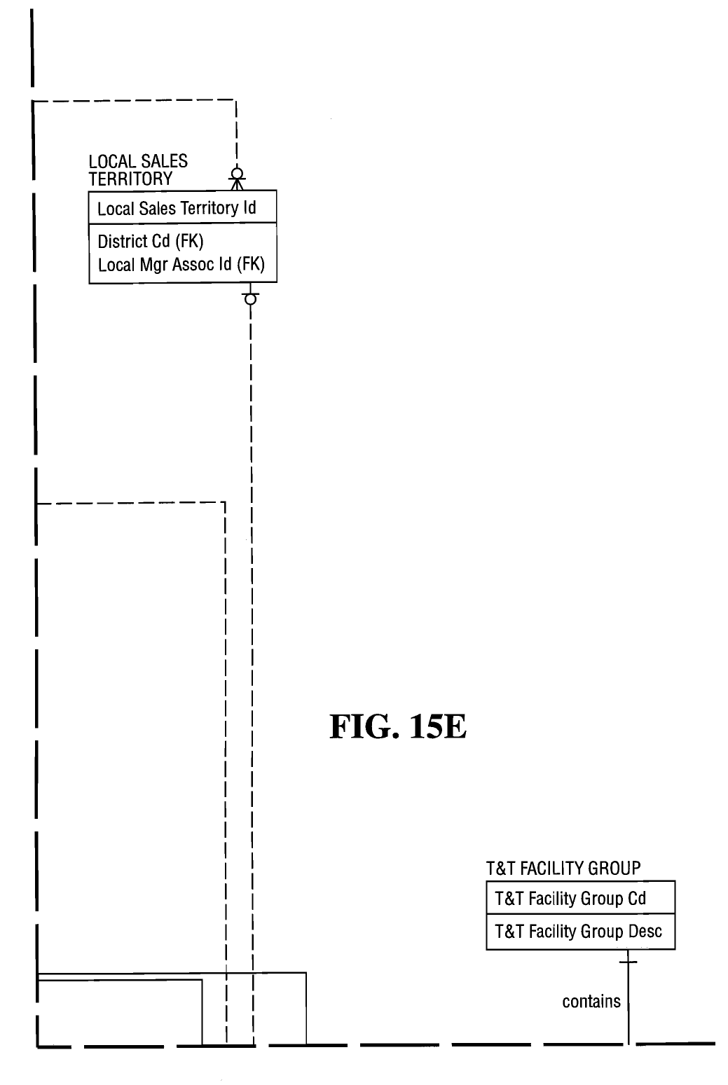

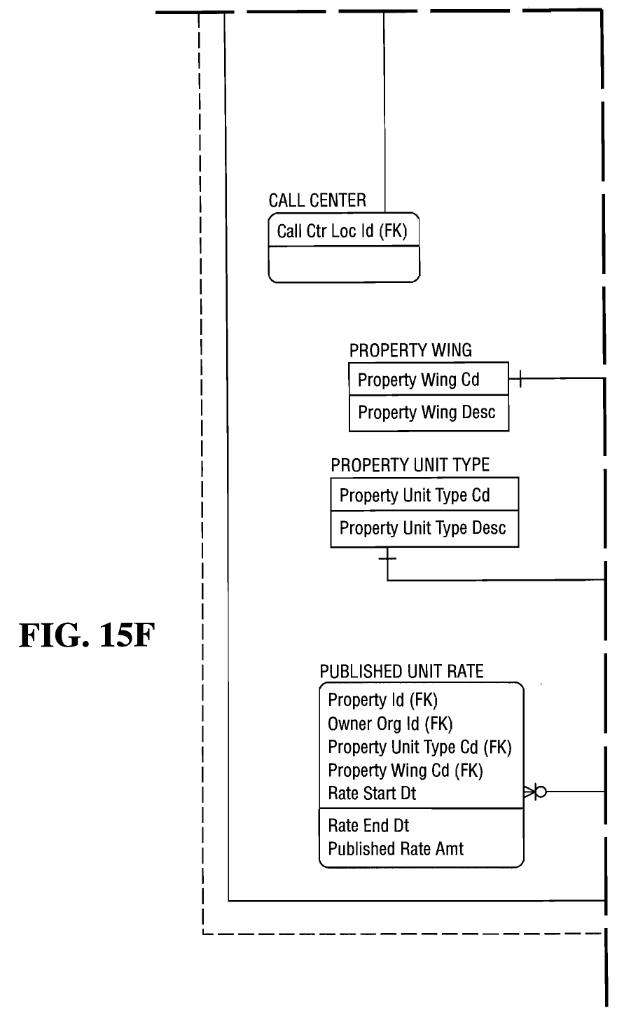

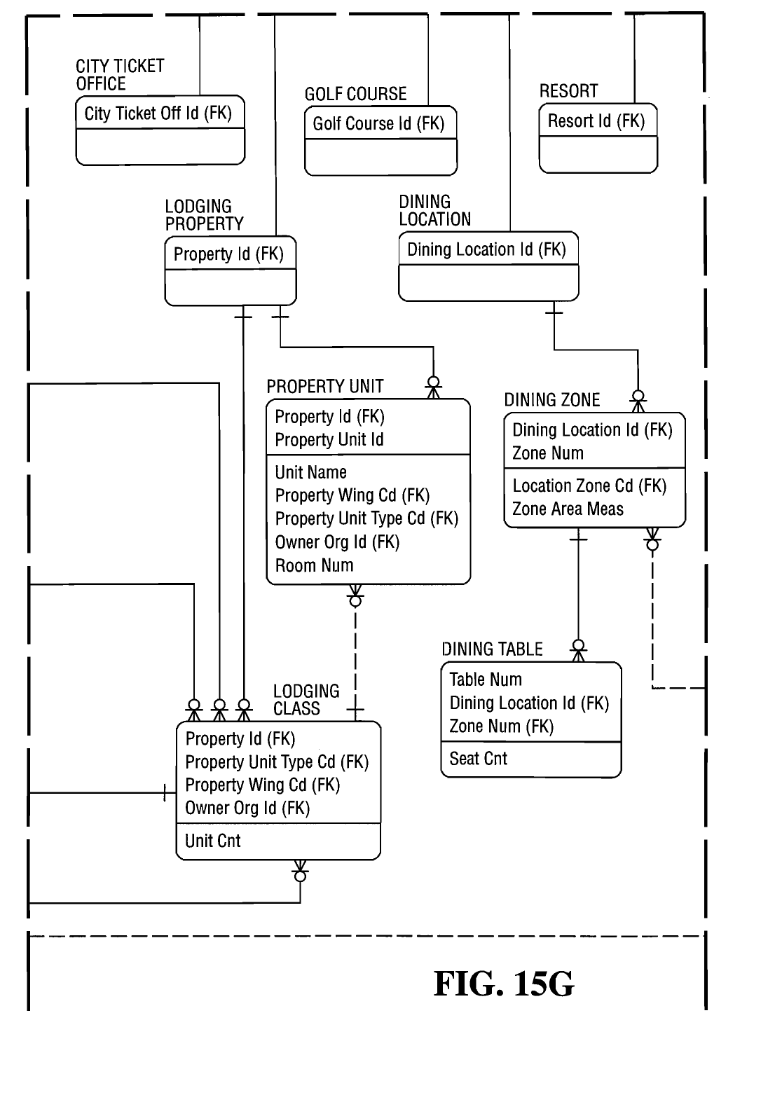

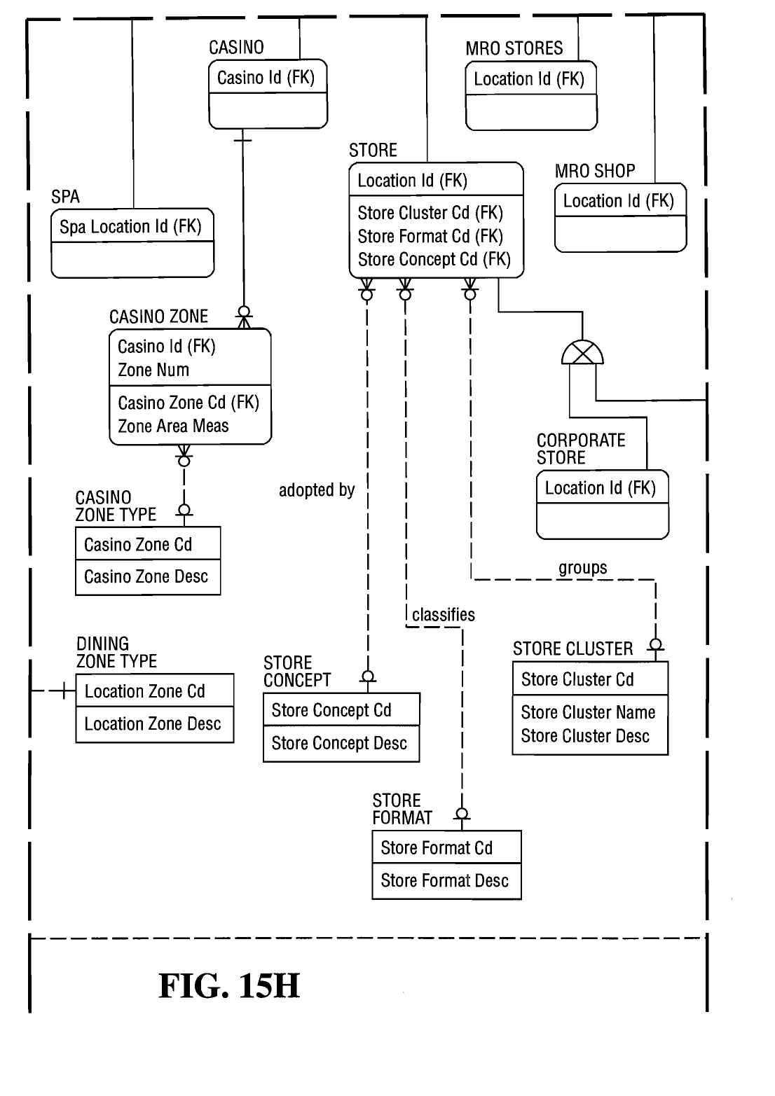

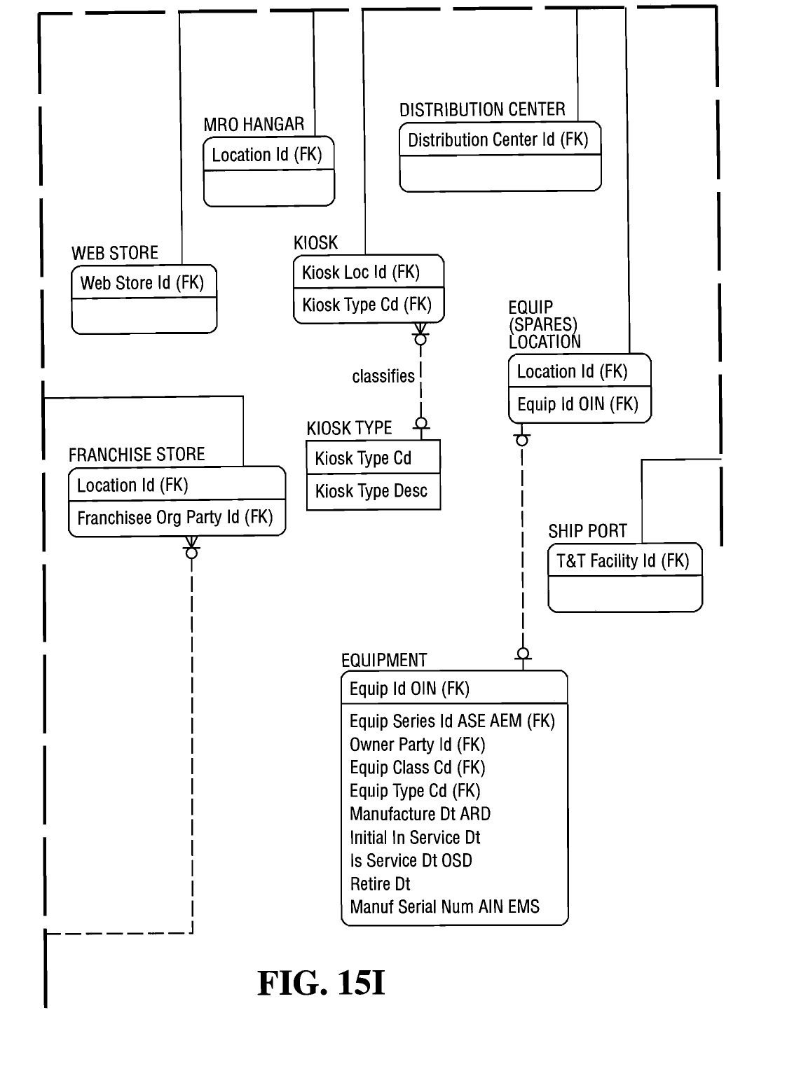

LOCATION (OVERVIEW) Subject Area, illustrated in FIG. 15;

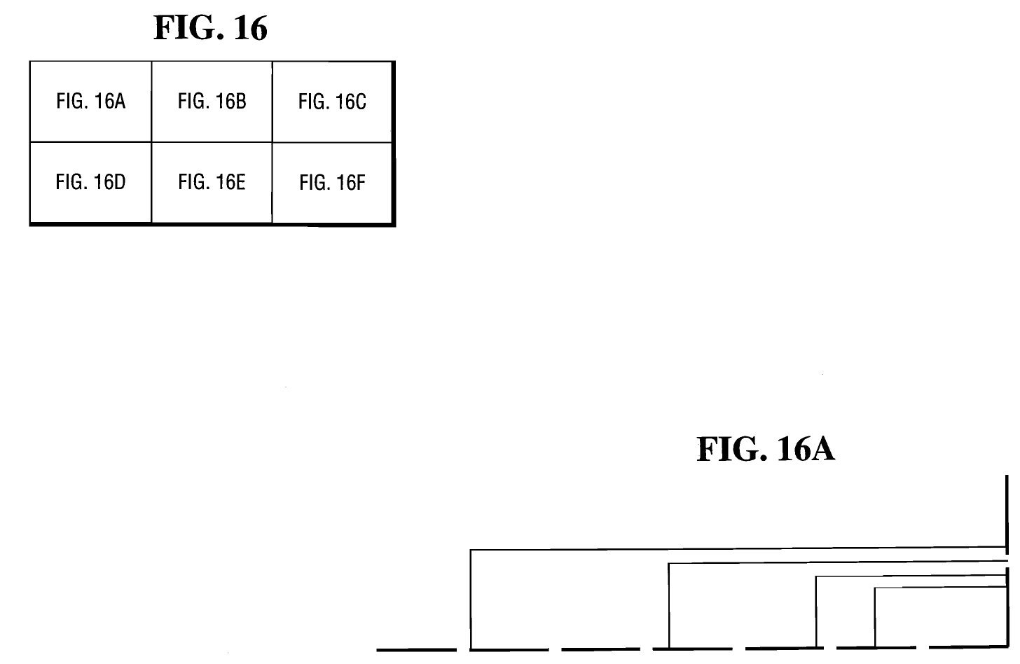

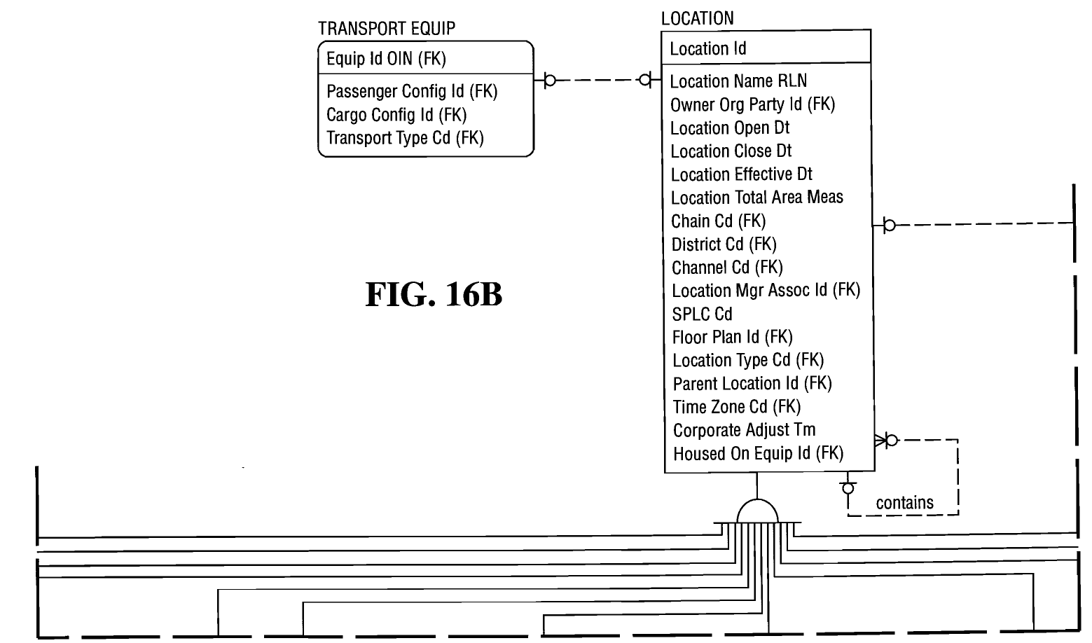

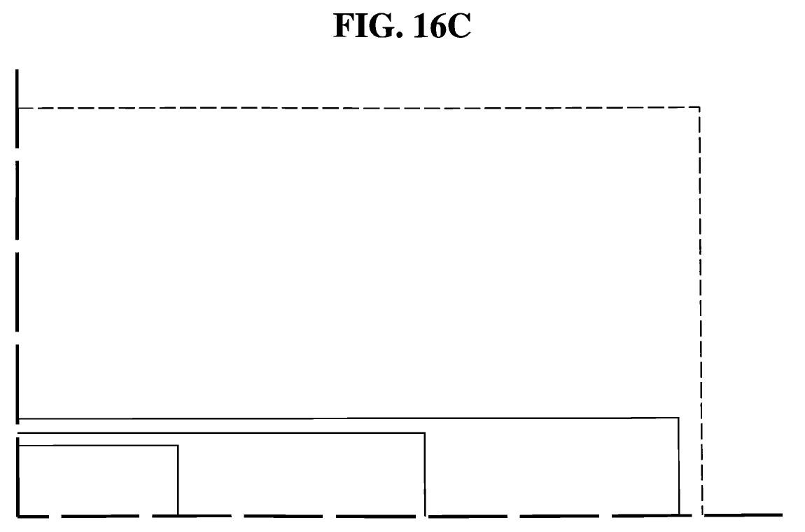

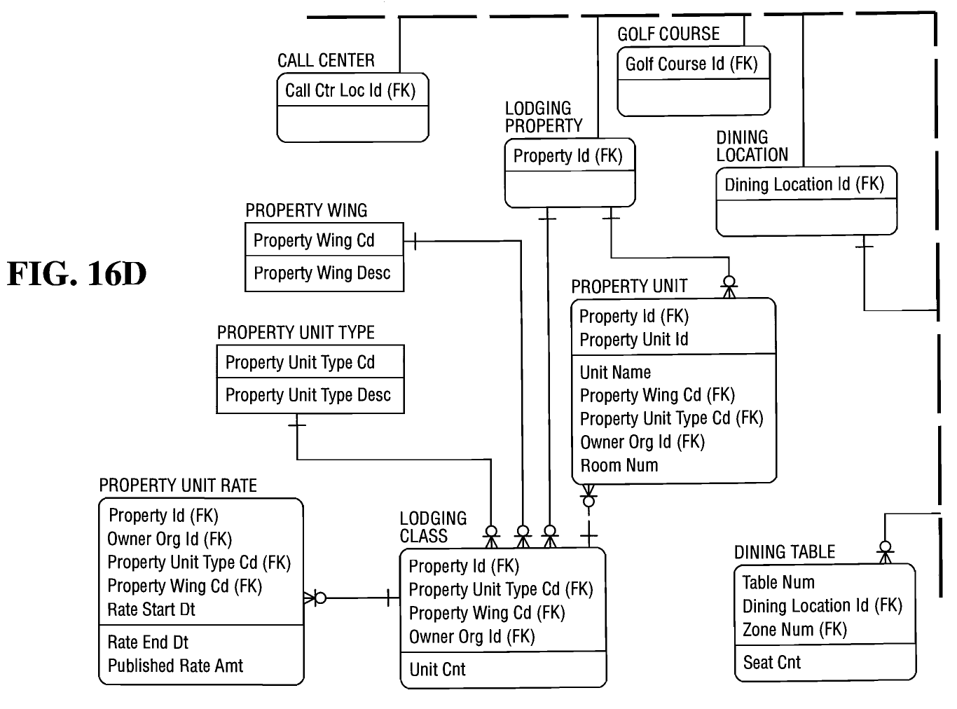

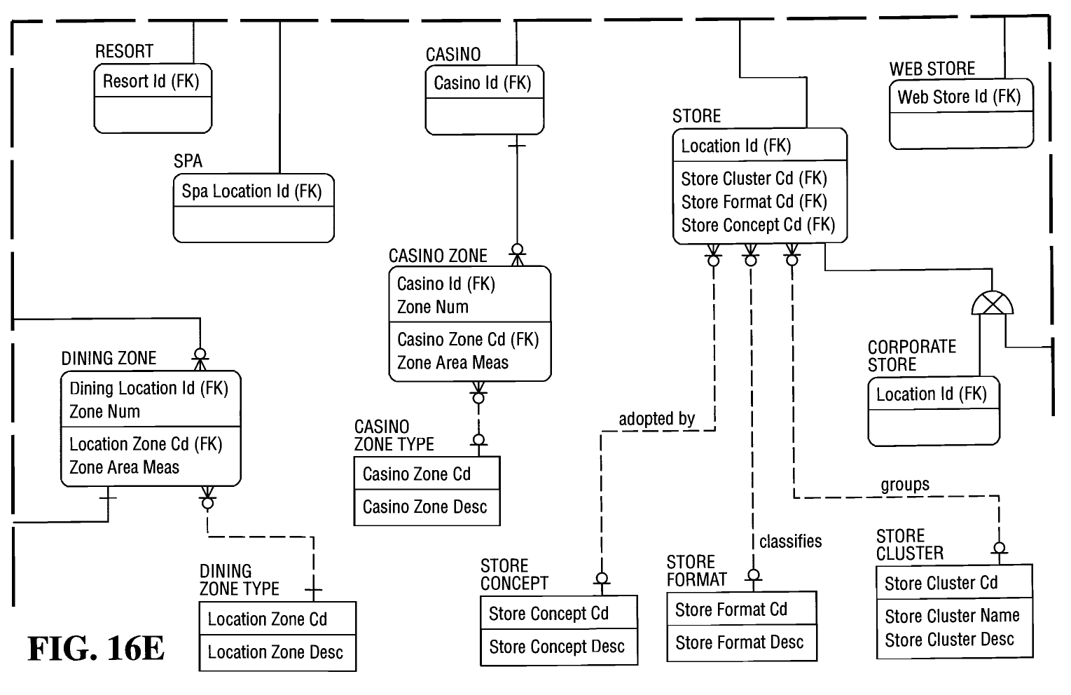

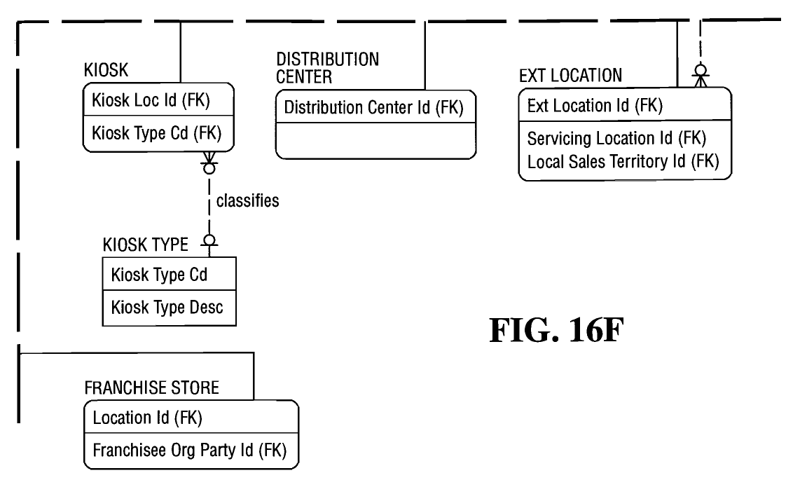

LOCATION (HOSPITALITY/CASINO) Subject Area, illustrated in FIG. 16;

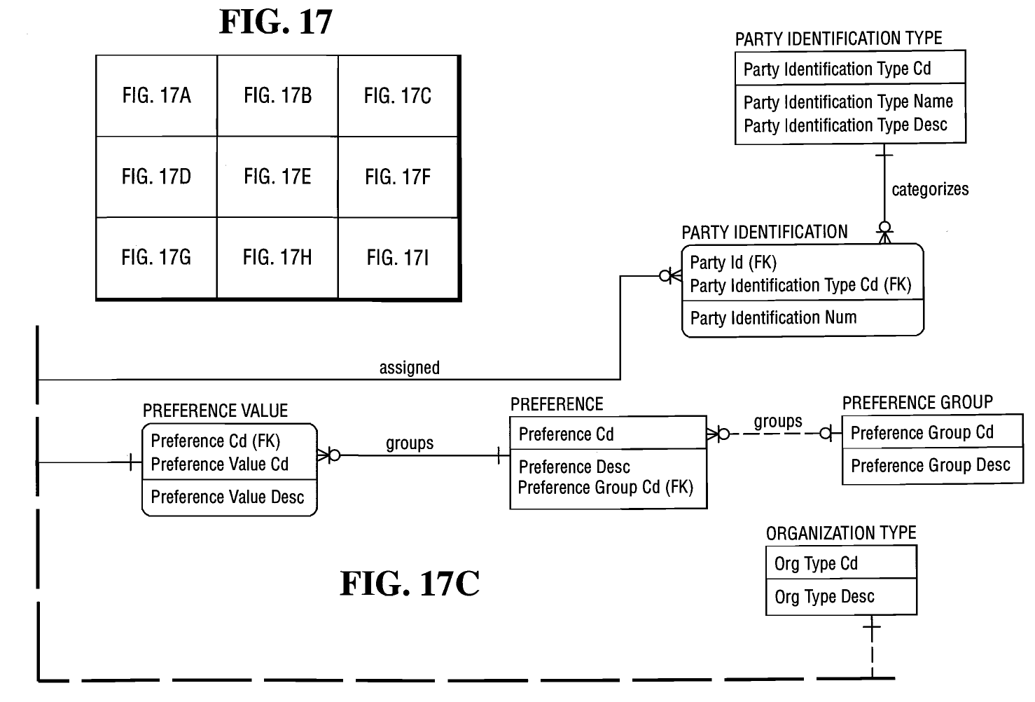

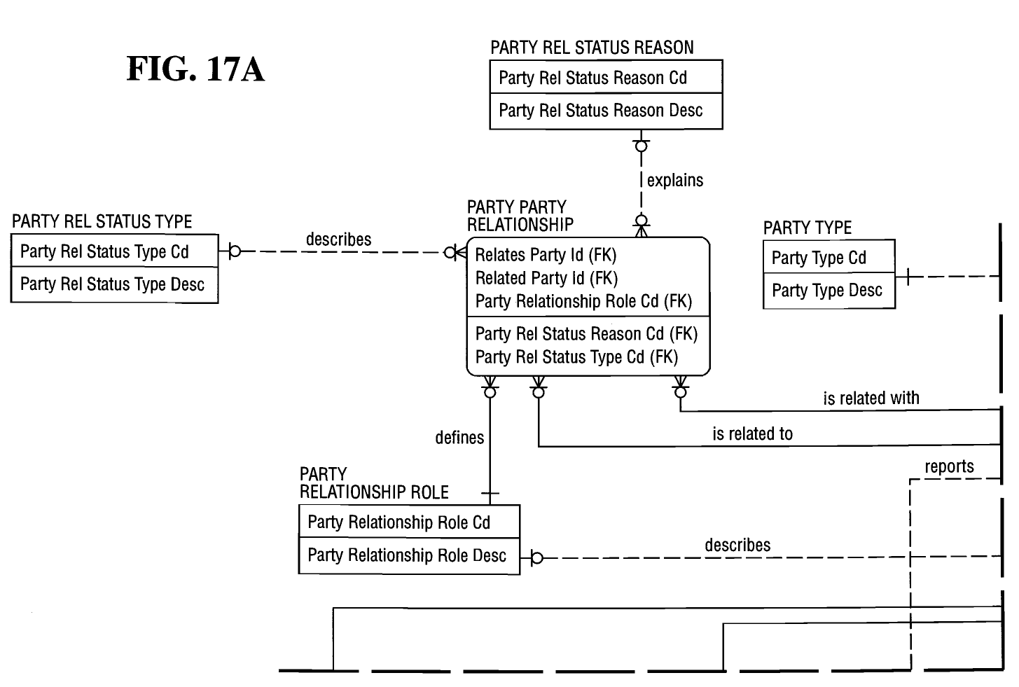

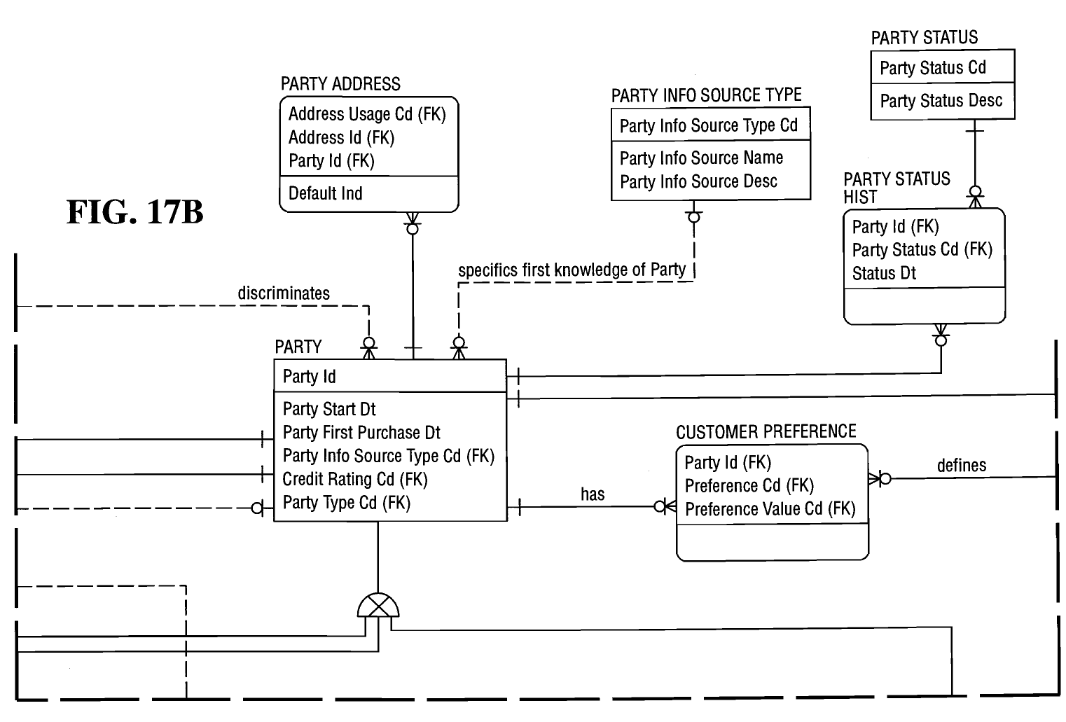

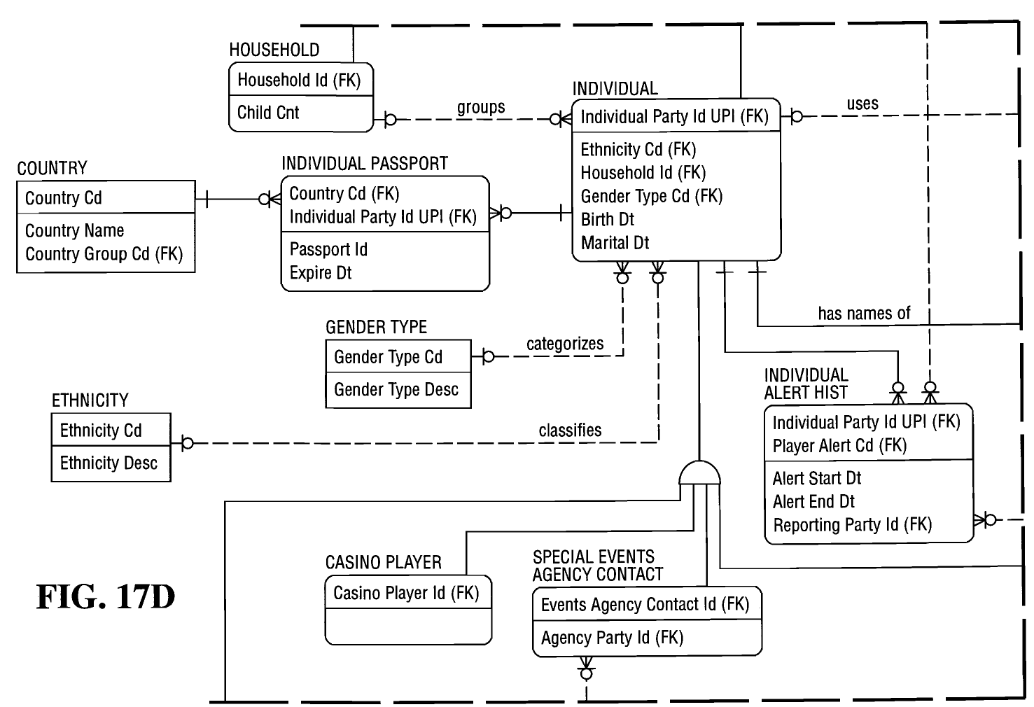

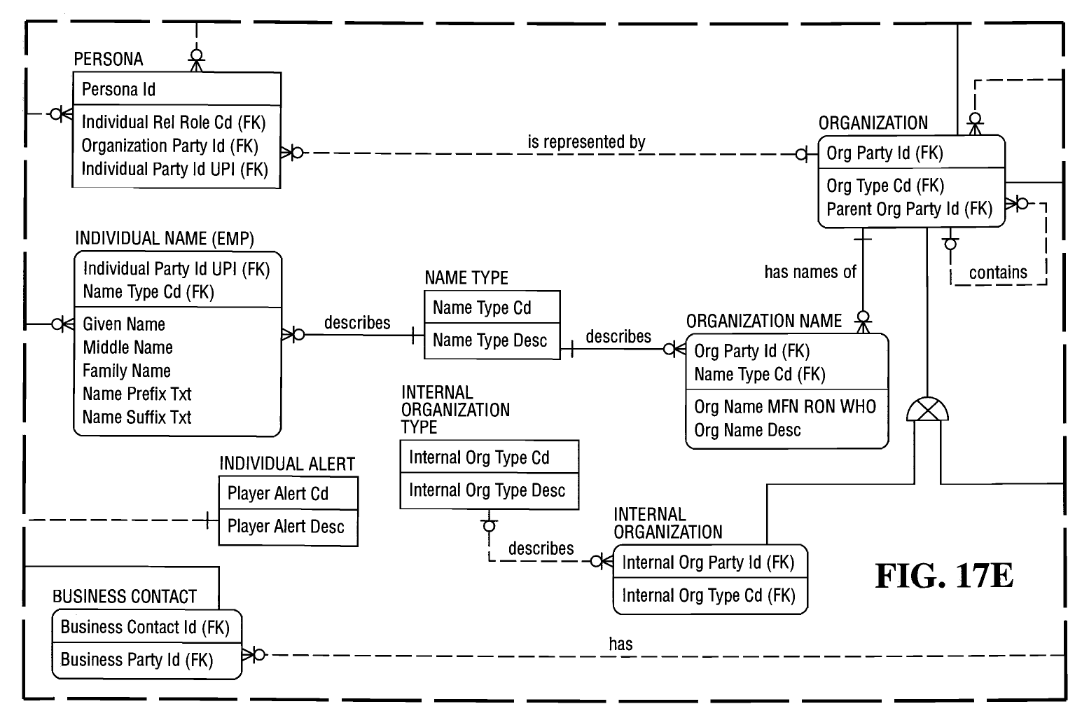

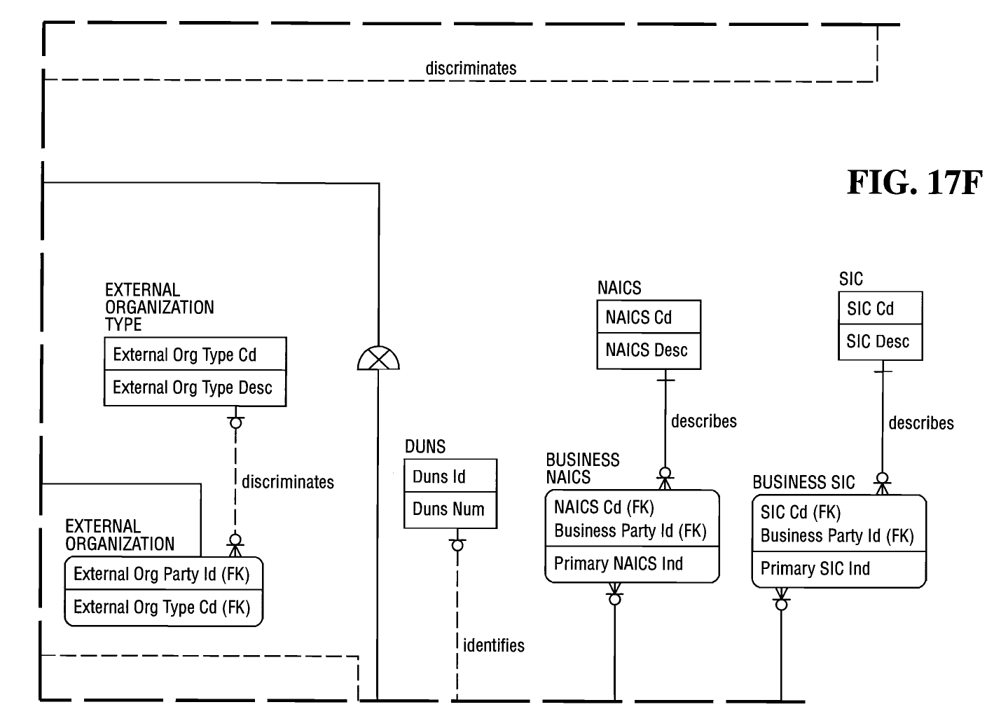

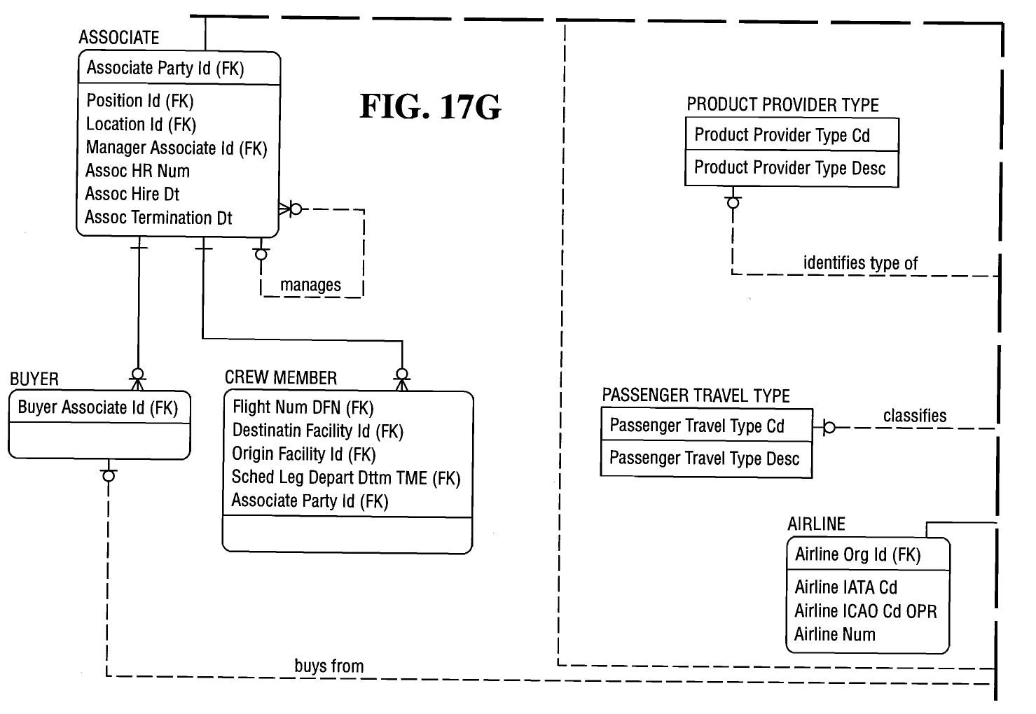

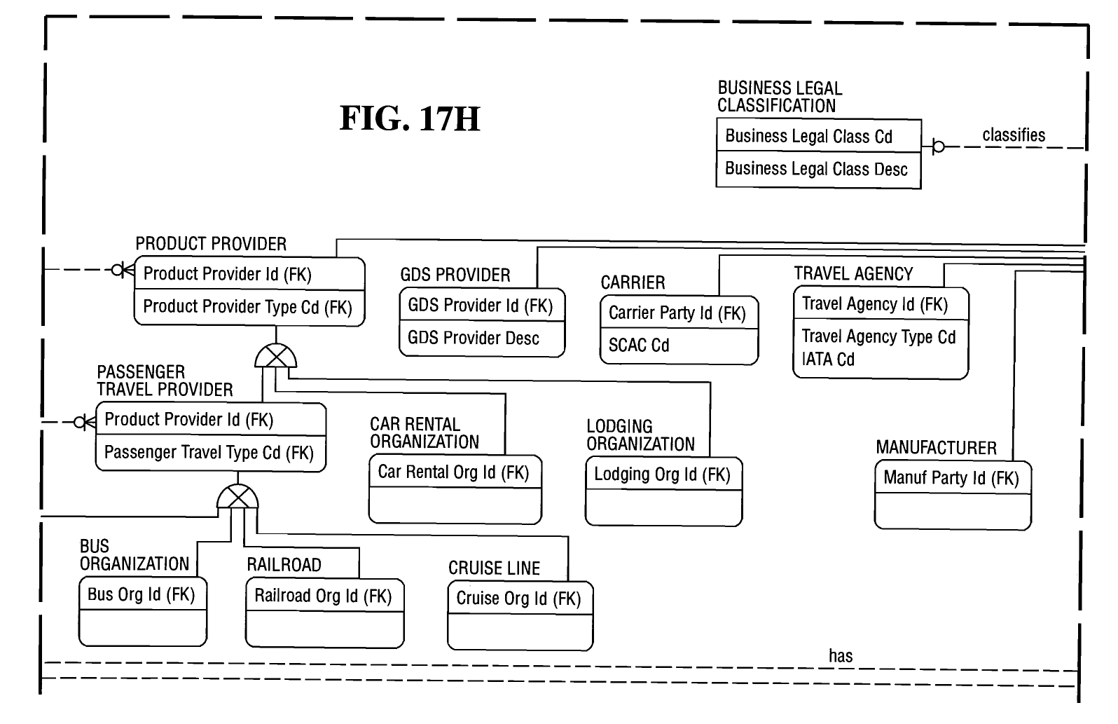

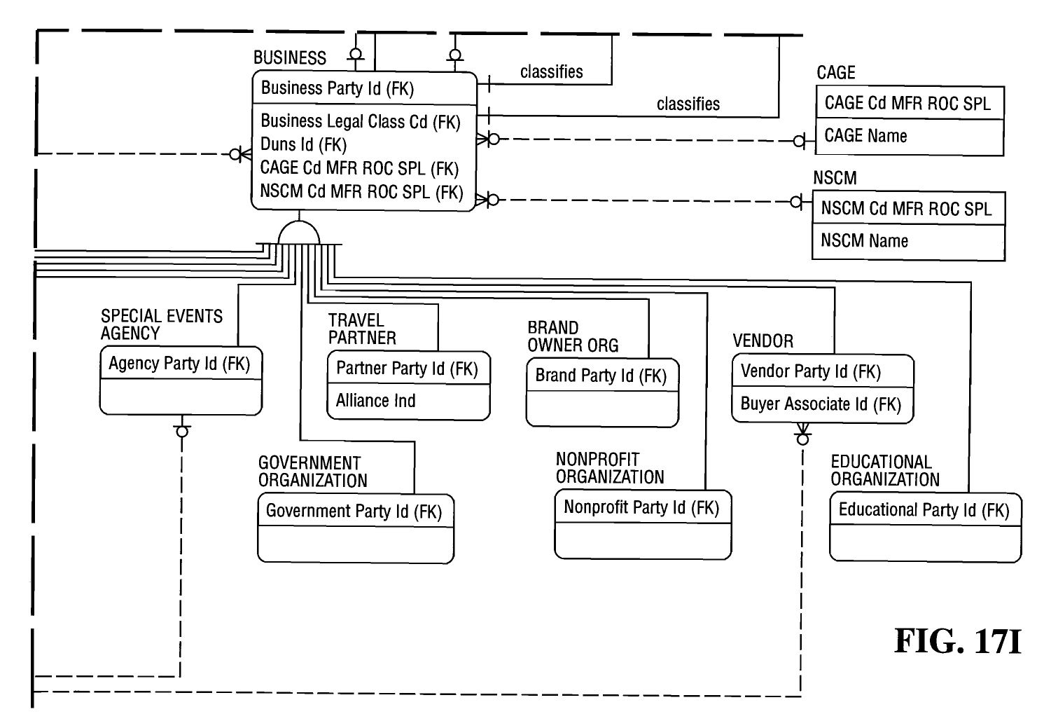

PARTY Subject Area, illustrated in FIG. 17;

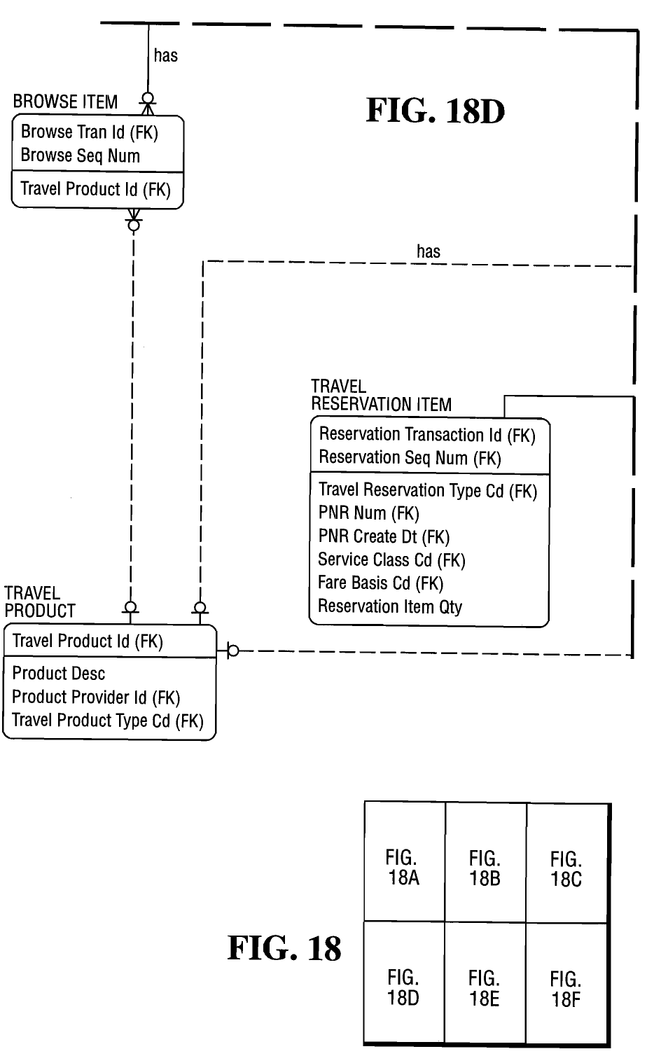

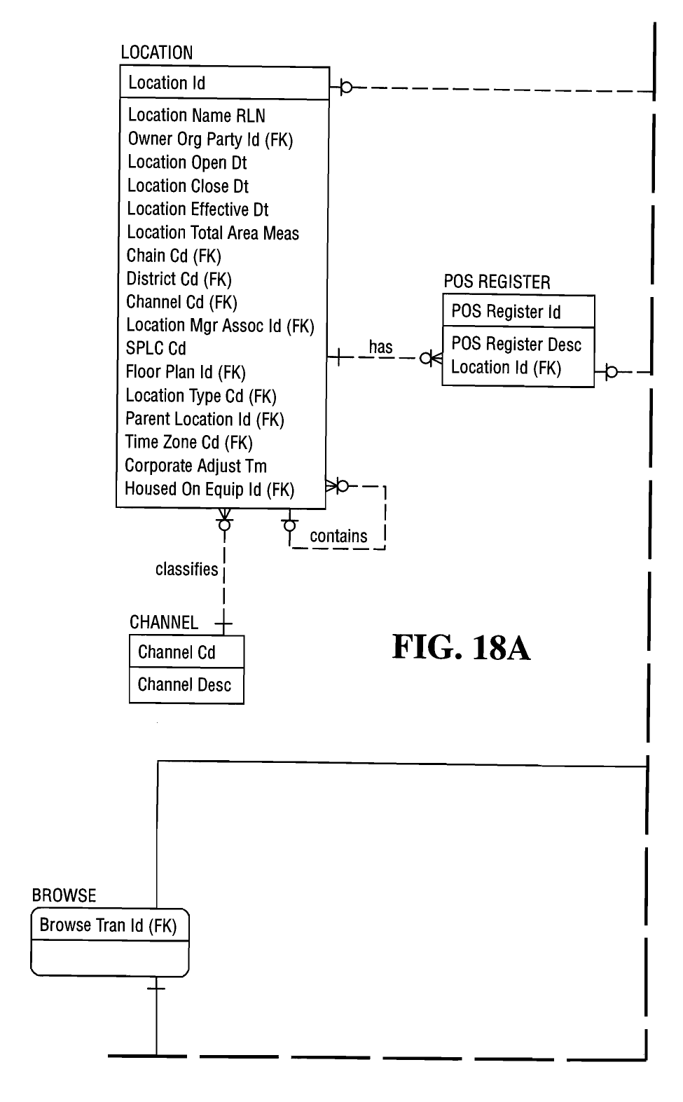

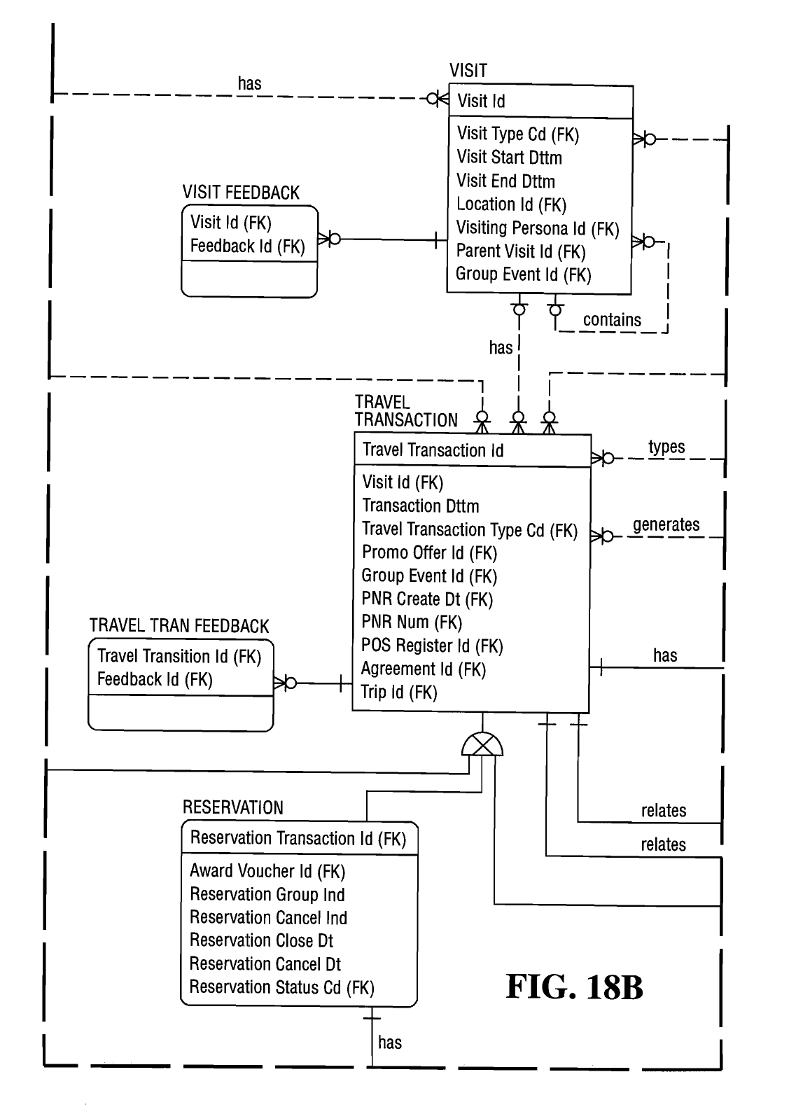

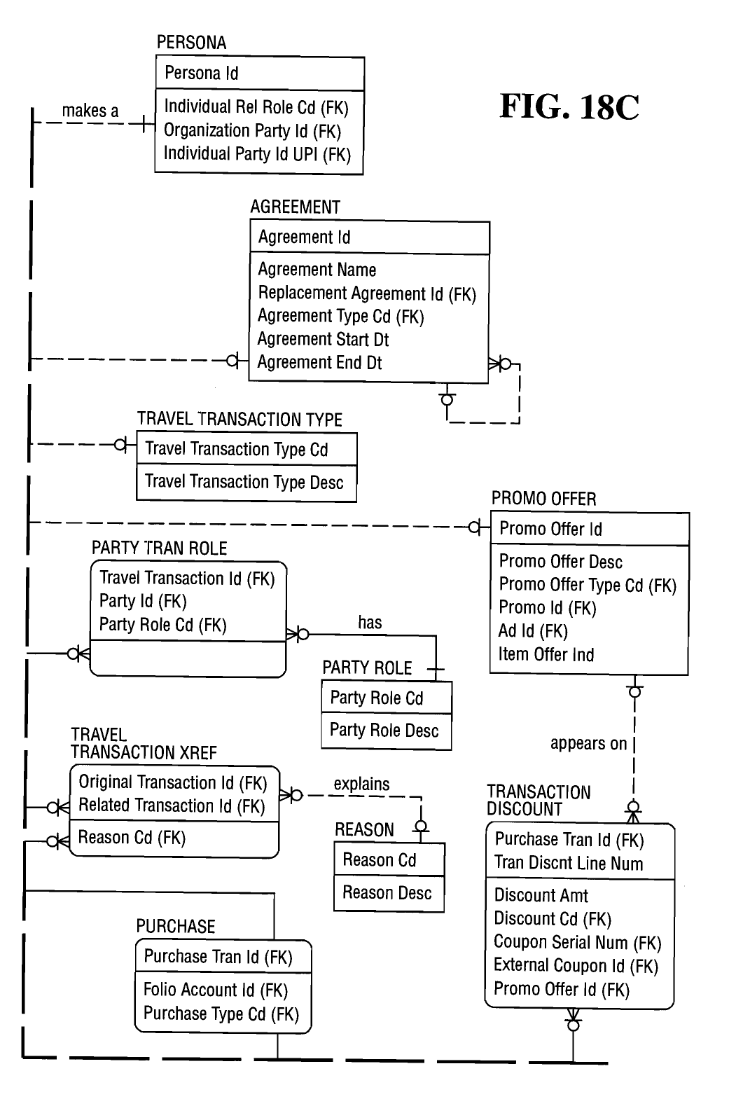

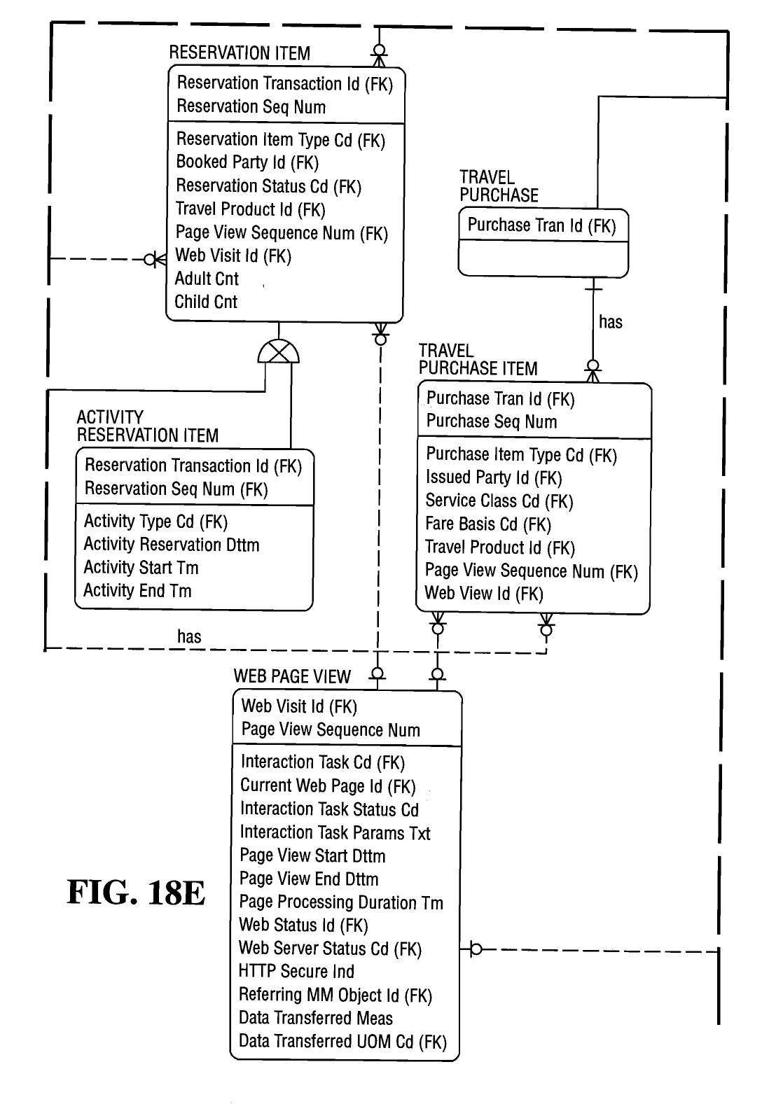

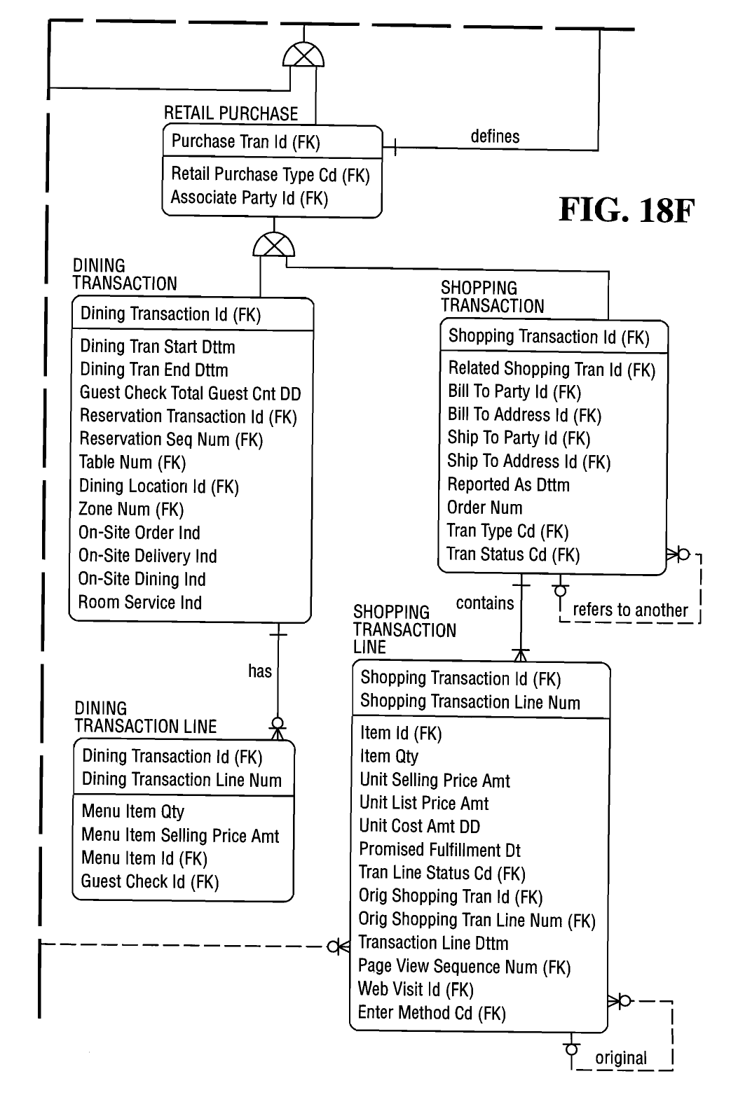

TRAVEL TRANSACTION (OVERVIEW) Subject Area, illustrated in FIG. 18;

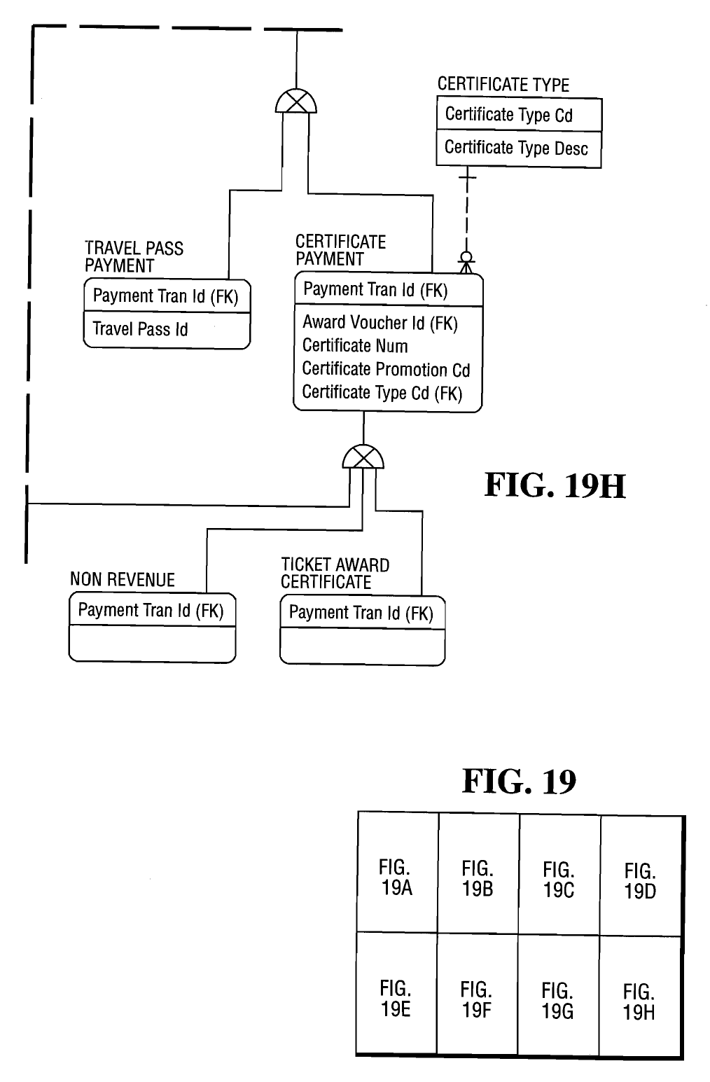

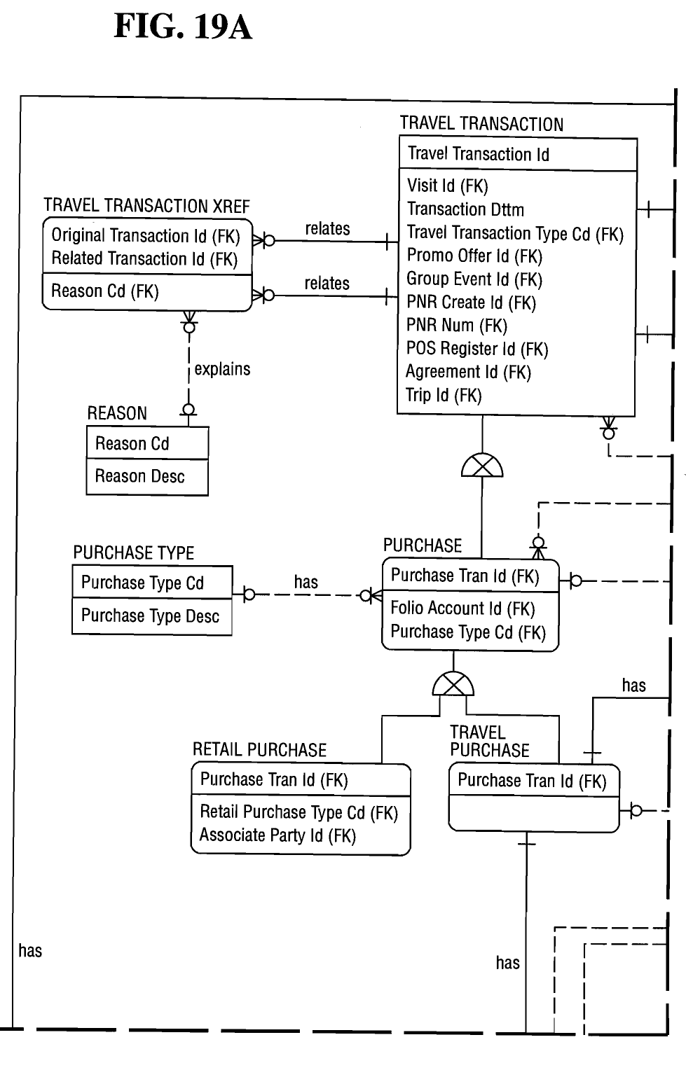

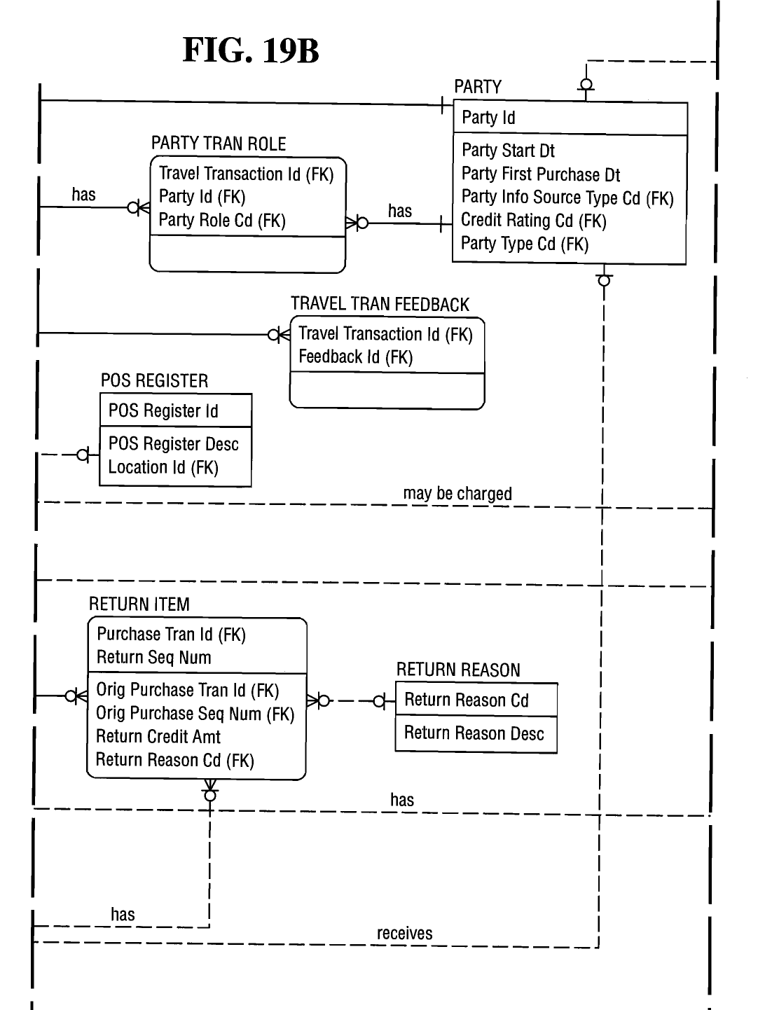

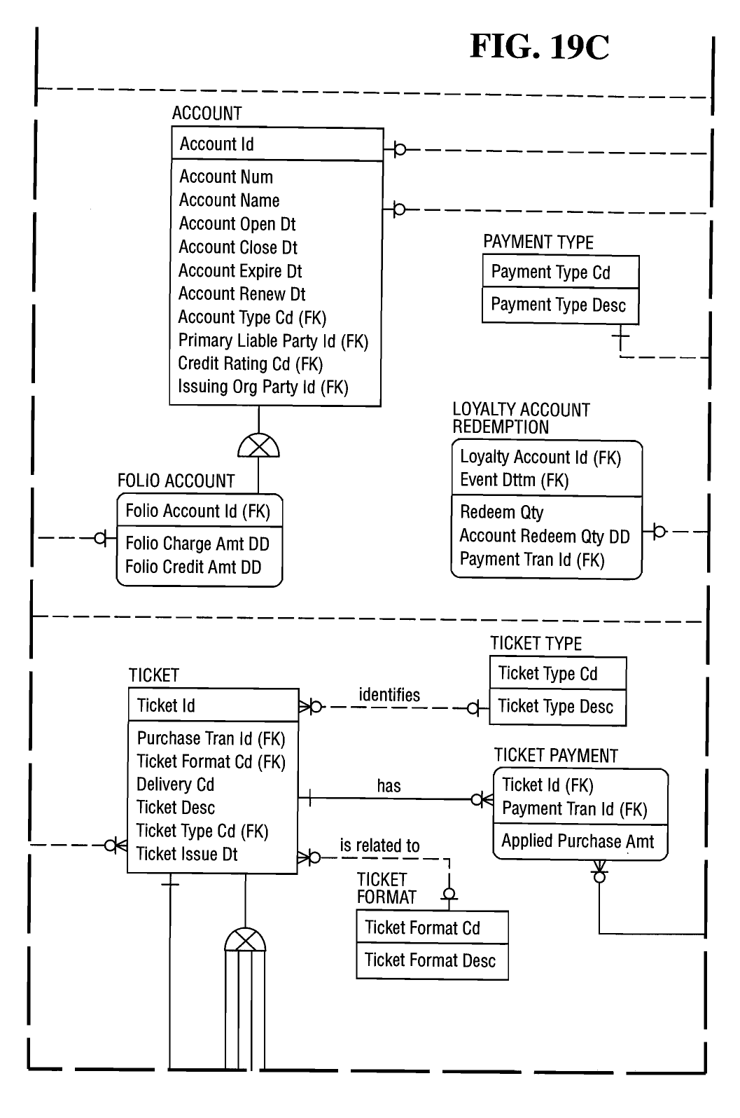

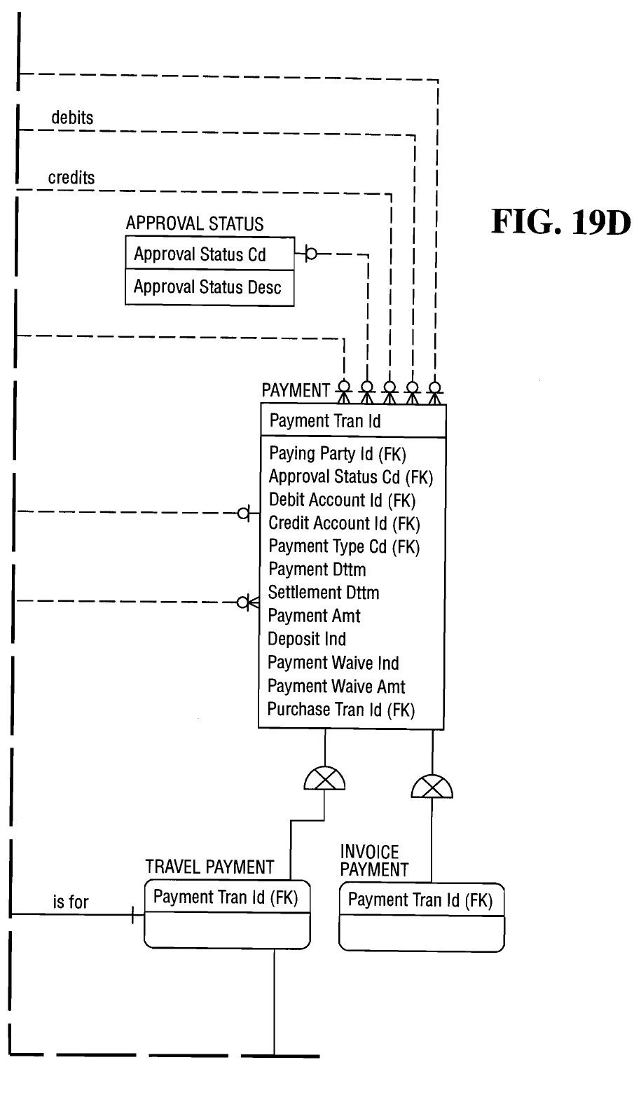

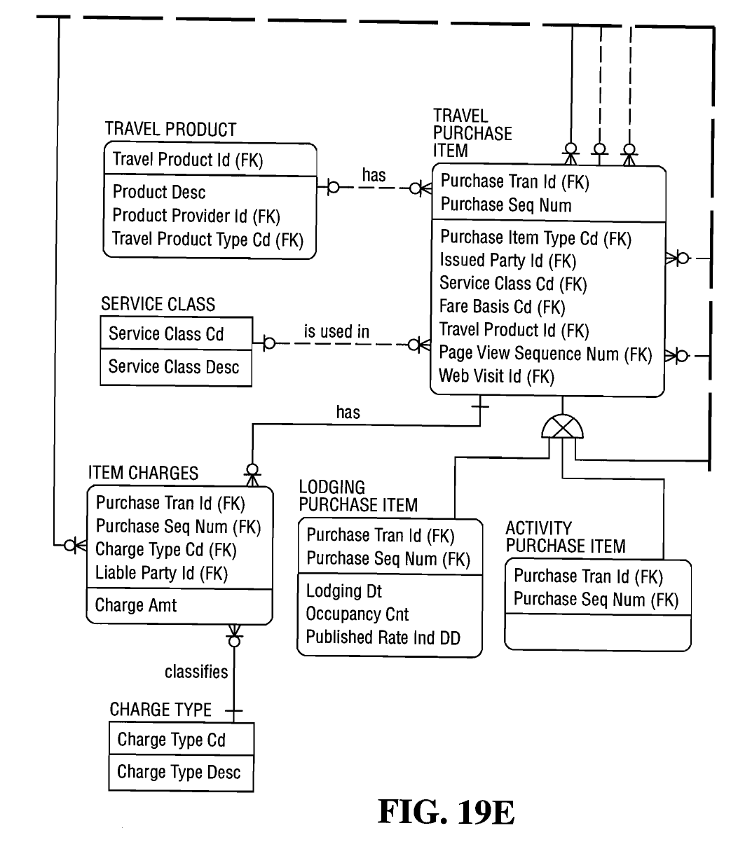

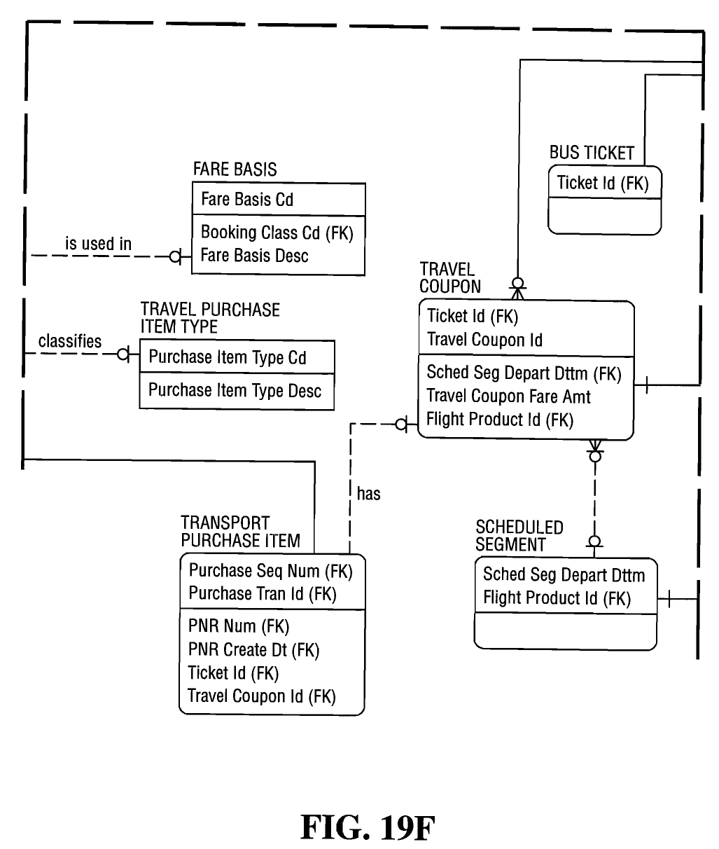

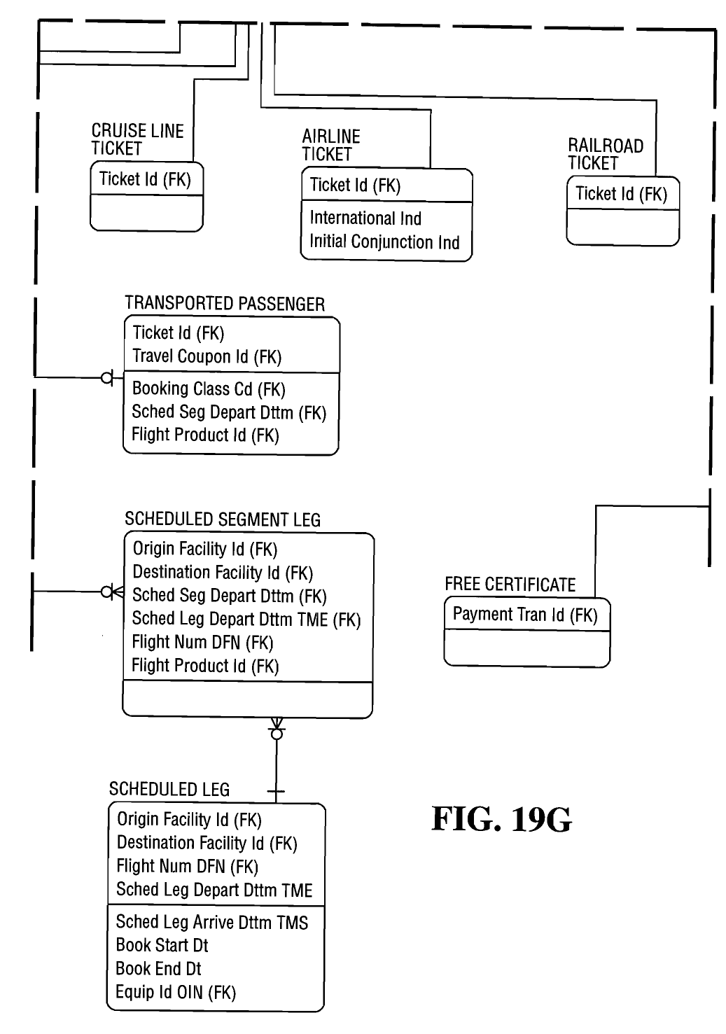

TRAVEL PURCHASE Subject Area, illustrated in FIG. 19;

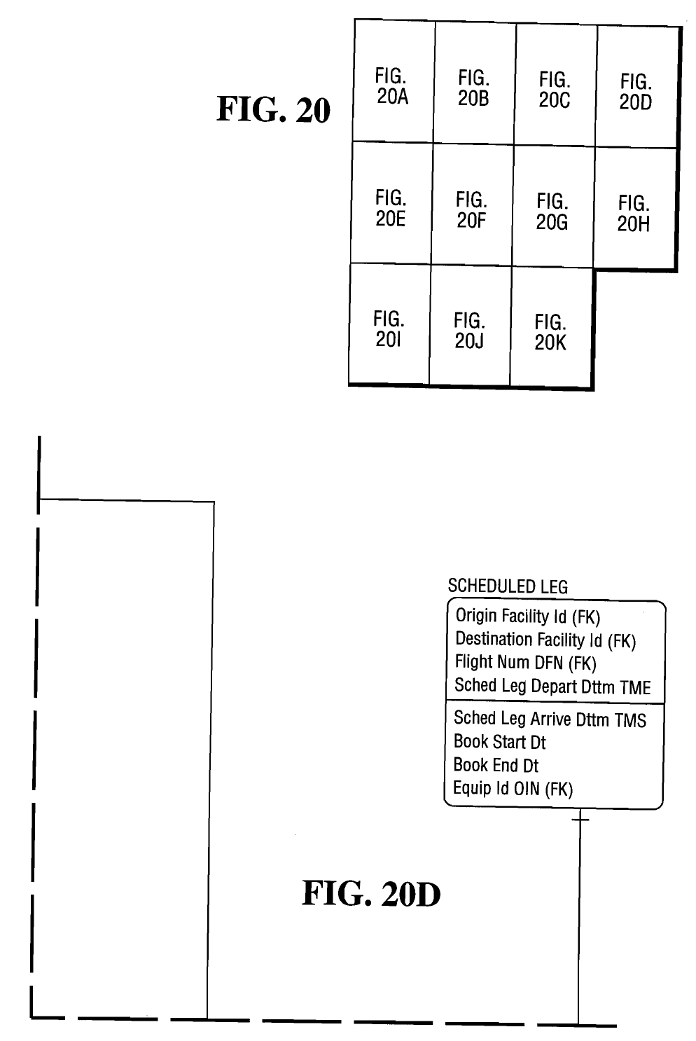

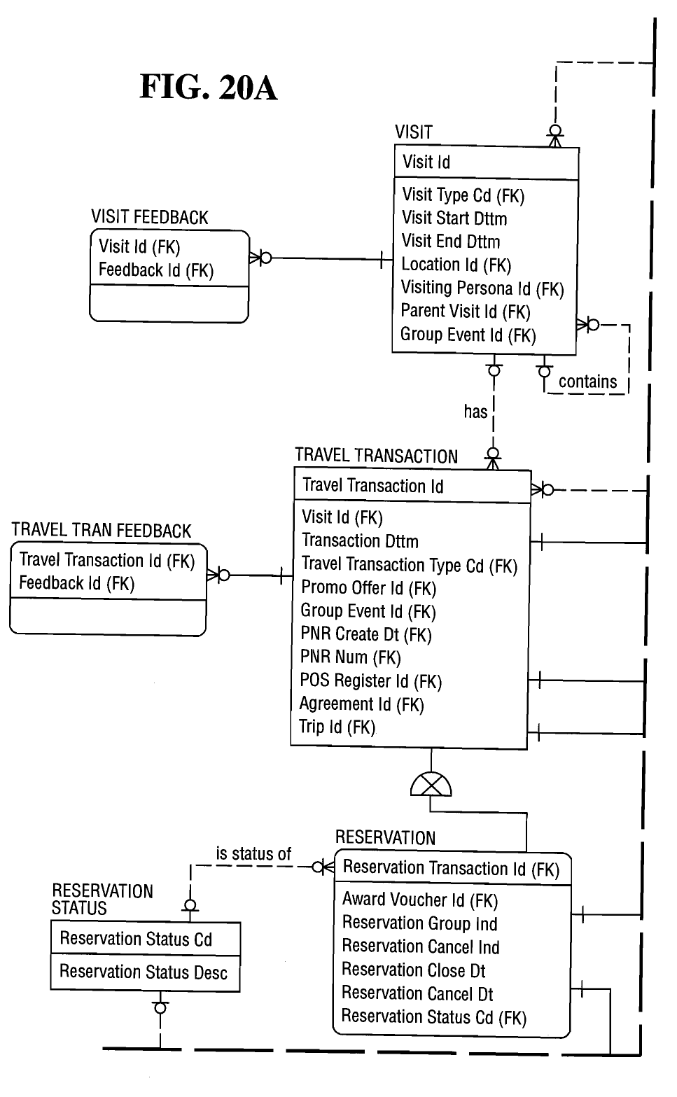

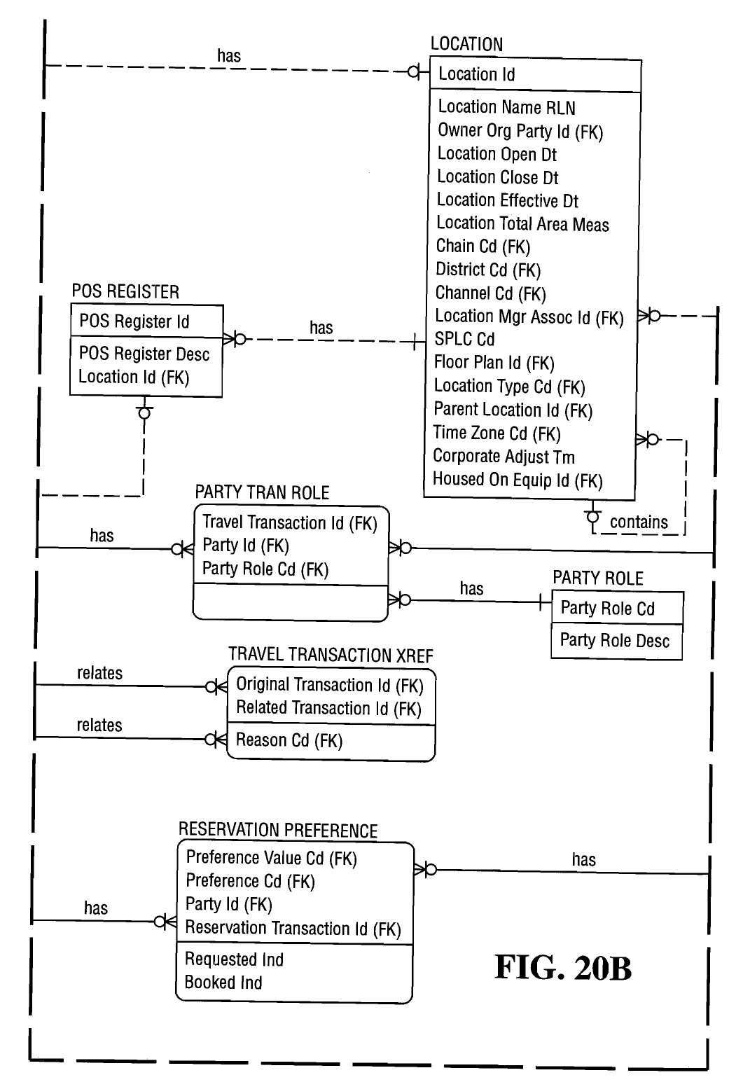

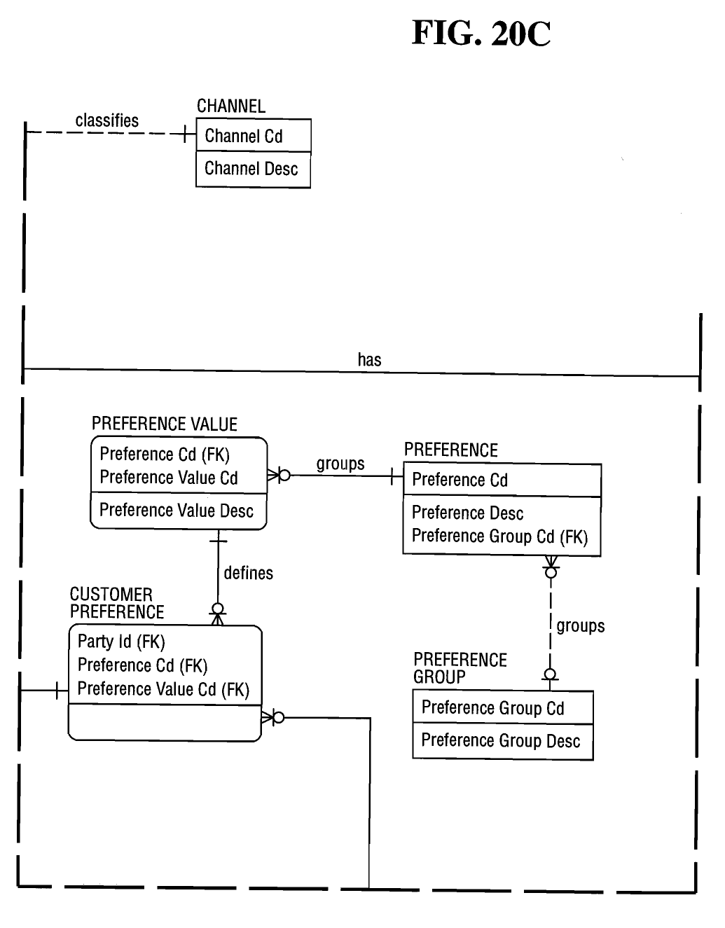

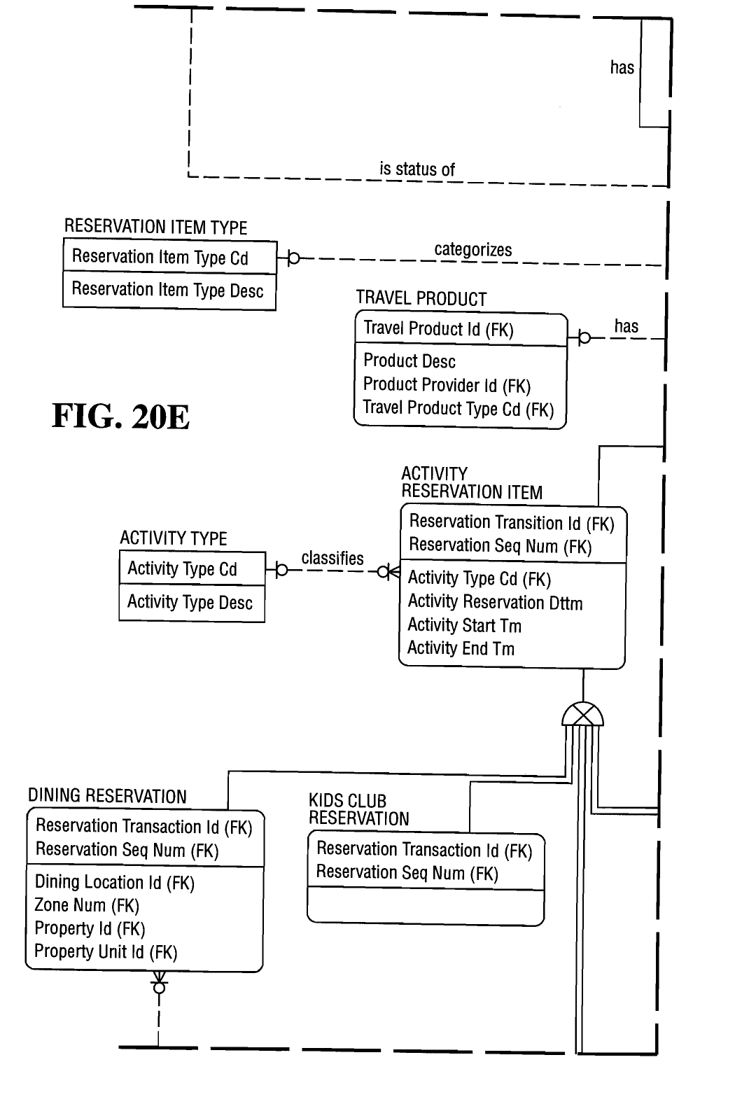

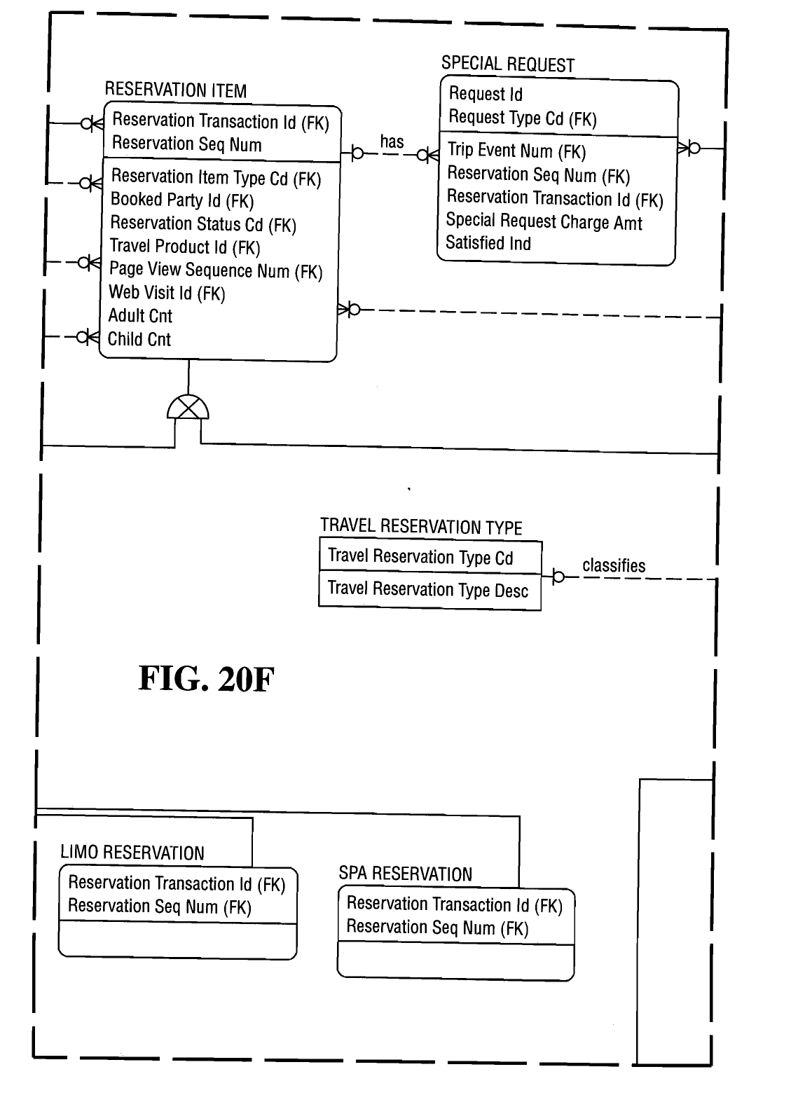

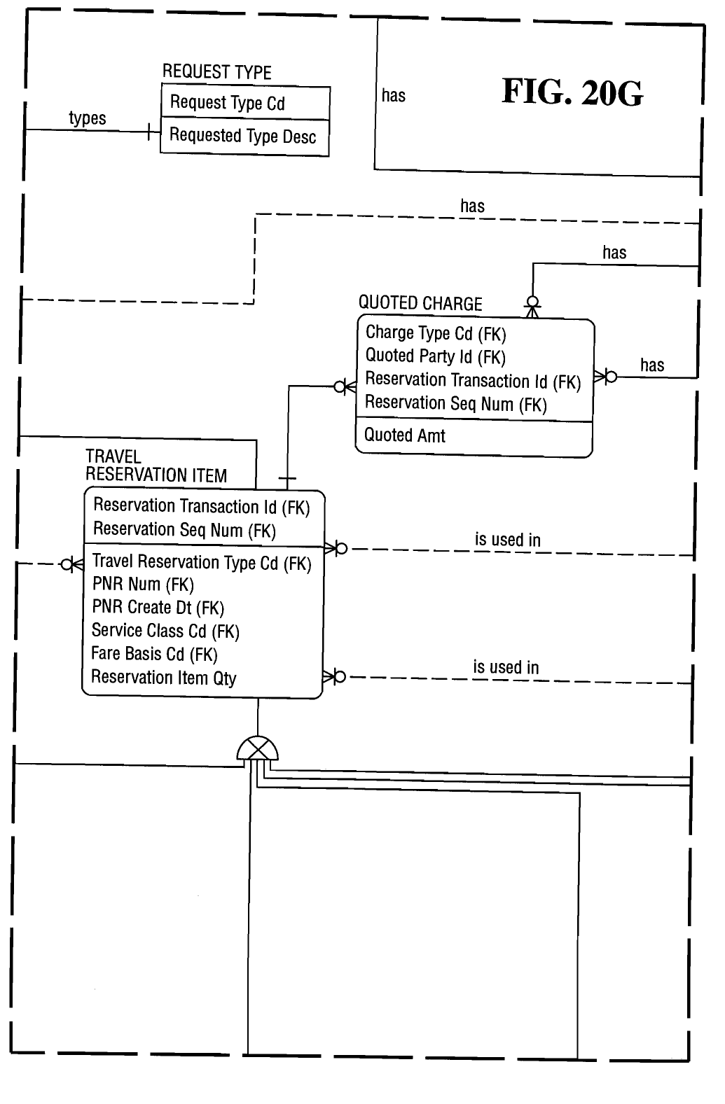

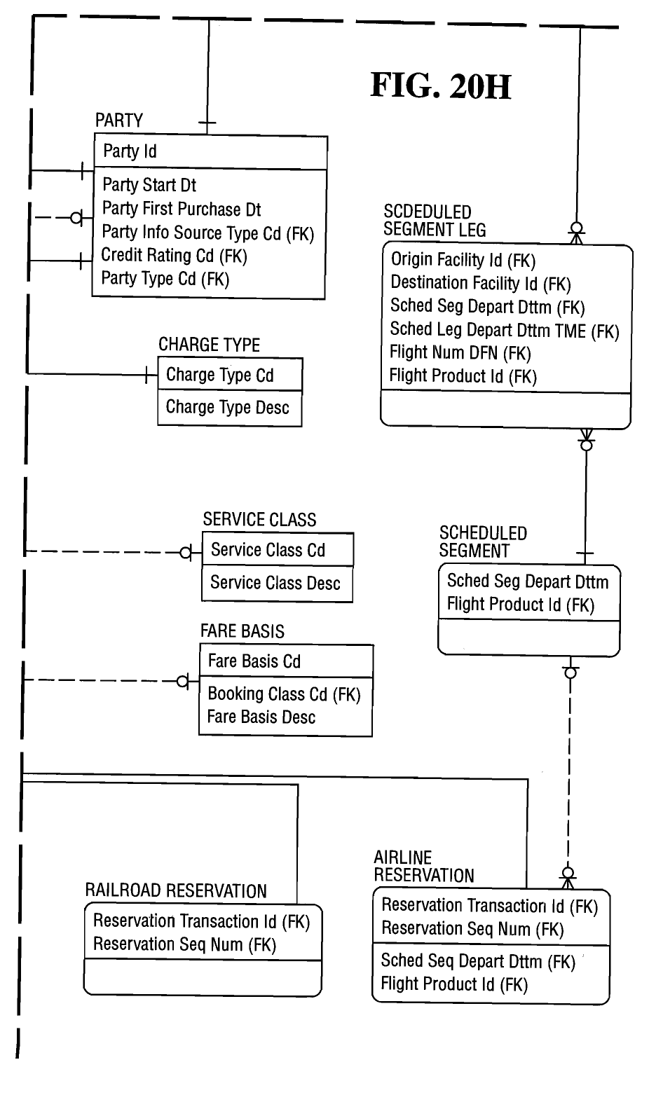

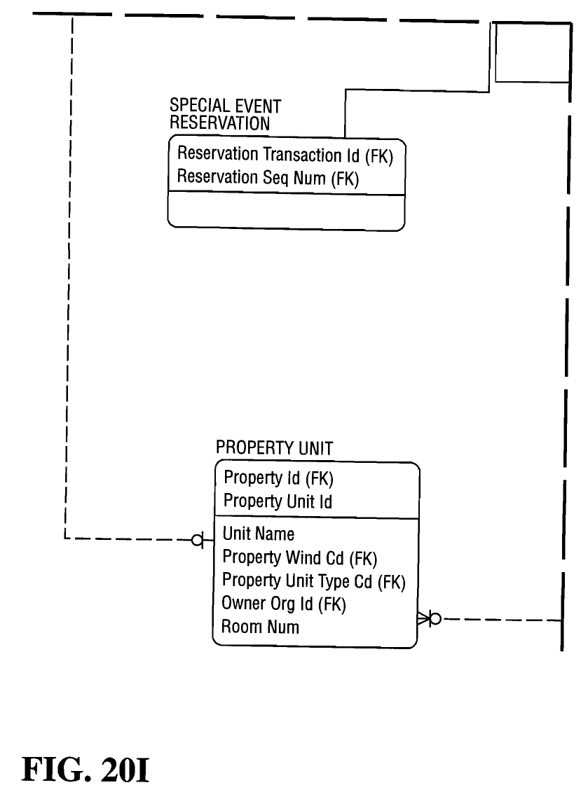

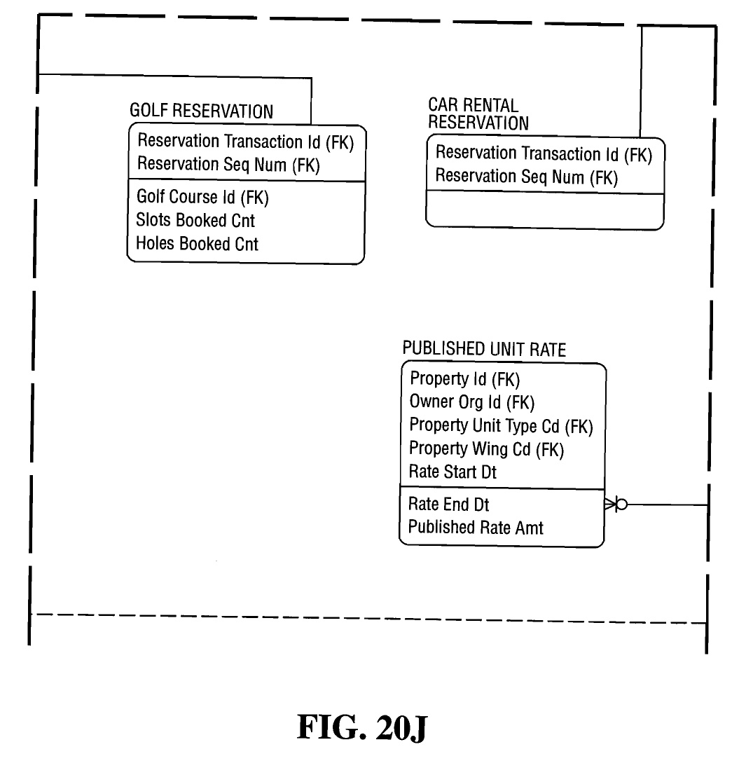

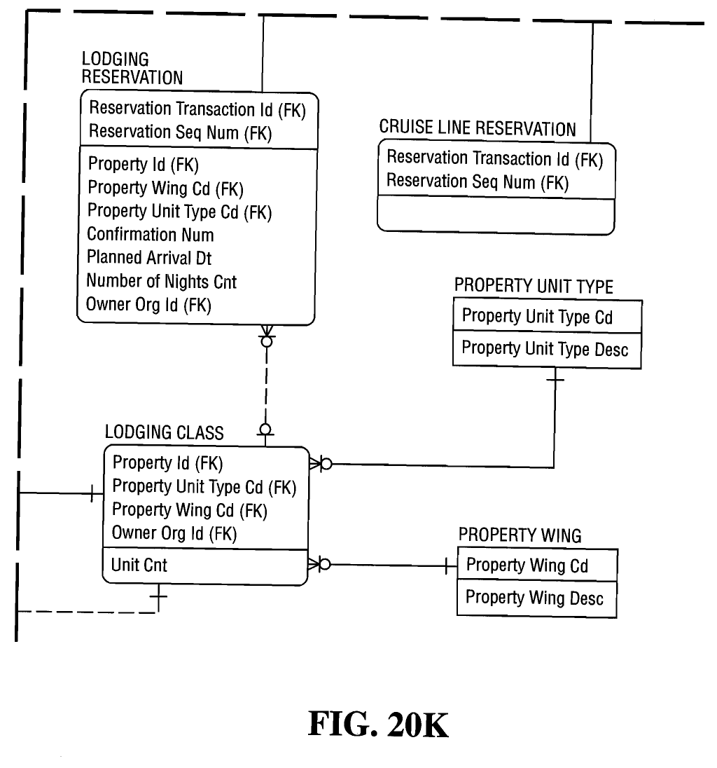

TRAVEL RESERVATION Subject Area, illustrated in FIG. 20; and

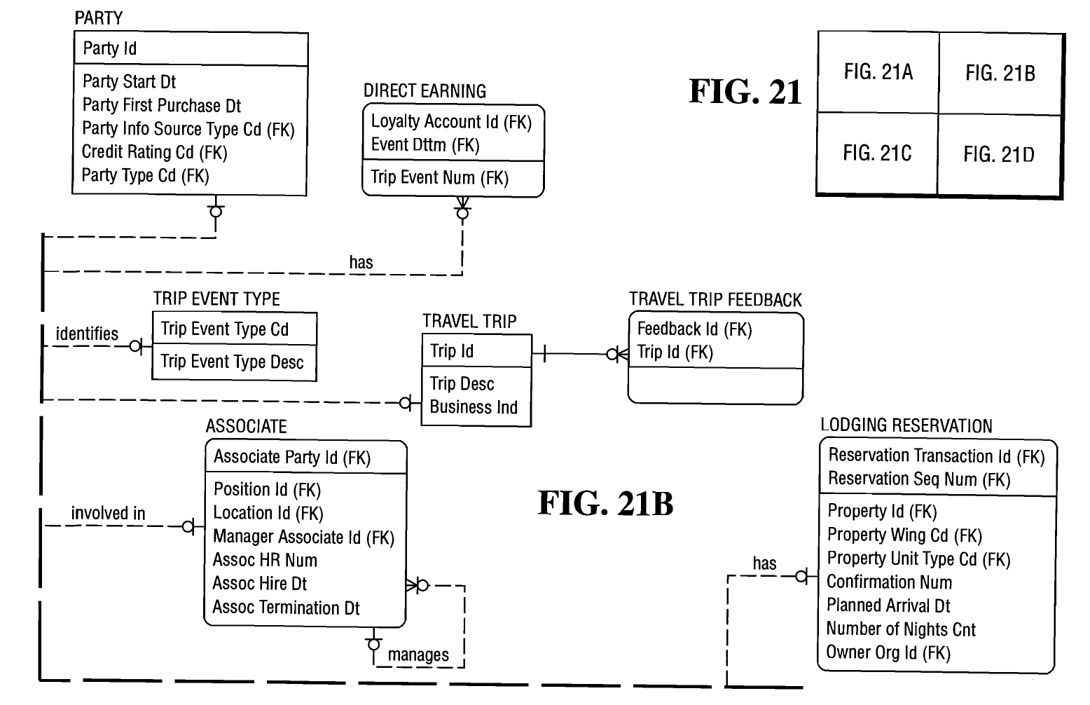

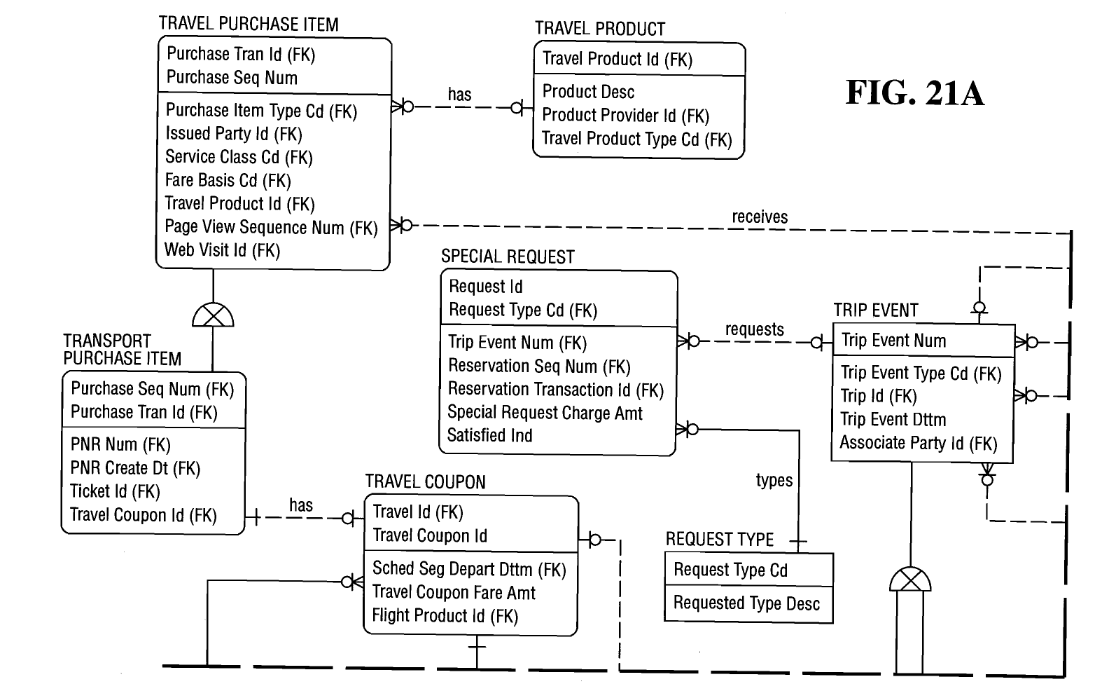

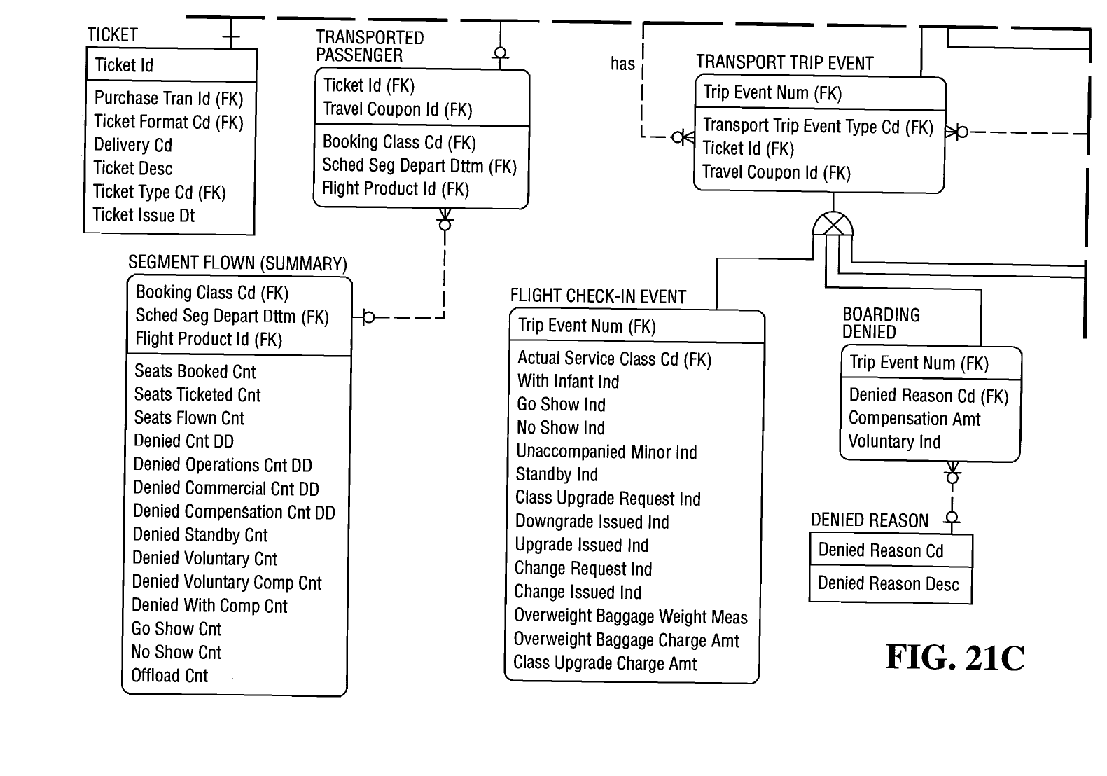

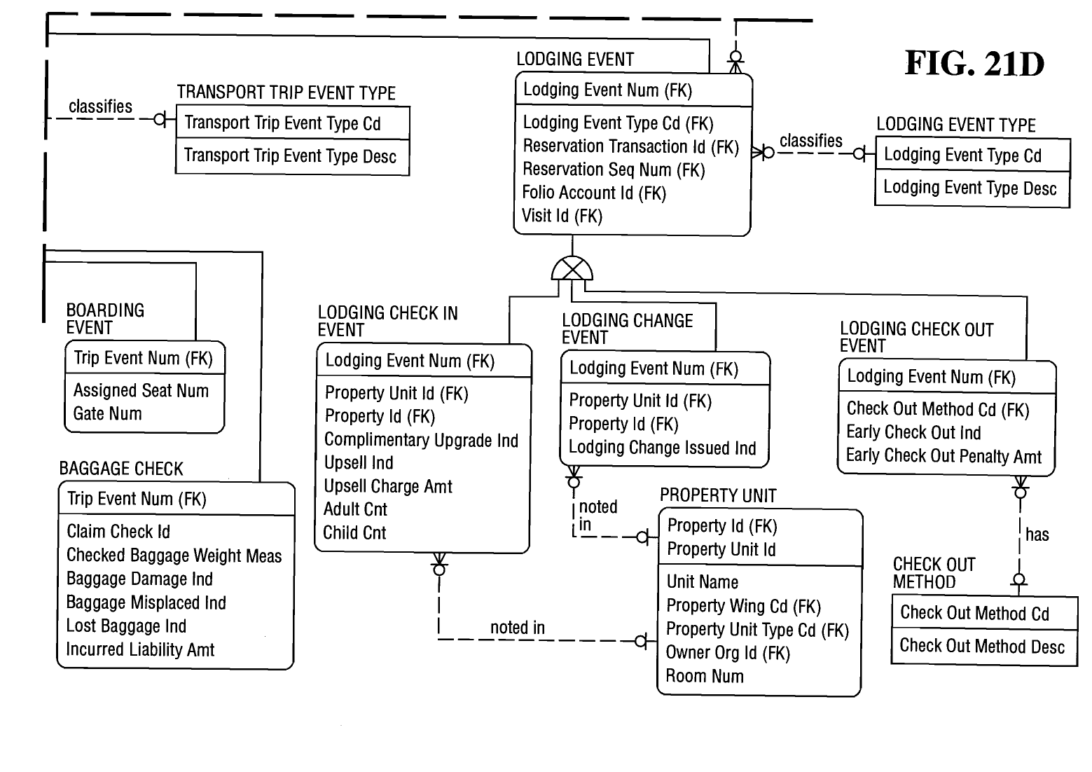

TRAVEL TRIP EVENT Subject Area, illustrated in FIG. 21.

The core areas of interest in modeling the business information needs of hospitality venue are the hospitality specific diagrams of the HOSPITALITY DINING TRANSACTION, HOSPITALITY GROUP EVENT, HOSPITALITY RETAIL PURCHASE, HOSPITALITY ROOM CHARGES, ITEM (HOSPITALITY), LOCATION (HOSPITALITY/CASINO), TRAVEL TRANSACTION (OVERVIEW), TRAVEL PURCHASE, TRAVEL RESERVATION, and TRAVEL TRIP EVENT subject areas shown in FIGS. 10, 11, 12, 13, 14, 16, 18, 19, 20 and 21, respectively. The remaining diagrams are important to allow enterprise warehouse analysis by relating hospitality information to other relevant business information and events for a more complete picture of casino information:

A listing of all the entities included within the logical data model, and those included in the subject areas illustrated in FIGS. 4 through 21, together with a brief description of each entity, is provided in Appendix B. A listing of all the attributes included within the entities listed in Appendix B, and those shown in FIGS. 4 through 21, together with a brief description of each attribute, is provided in Appendix C.

What is claimed is:

1. A relational database system for storing and managing information for a hospitality business; comprising:
a computer-implemented relational database; said information being organized within said relational database in accordance with a logical data model;
a subject area within said logical data model comprising a plurality of entities and relationships defining the manner in which information related to dining services and products provided by said hospitality business is stored within said database.

2. The relational database system in accordance with claim 1, wherein said information related to dining services and products provided by said hospitality business includes information concerning dining reservations, dining transactions, menu items, and dining guest check details.

3. The relational database system in accordance with claim 1, wherein said information related to dining services and products provided by said hospitality business includes information concerning hospitality employees who served a dining customer, a table number occupied by the dining customer, and the number of guests in a dining party.

4. A relational database system for storing and managing information for a hospitality business; comprising:
a computer-implemented relational database; said information being organized within said relational database in accordance with a logical data model;
a subject area within said logical data model comprising a plurality of entities and relationships defining the manner in which information related to financial transactions and activities associated with a customer's room stay is stored within said database.

5. A relational database system for storing and managing information for a hospitality business; comprising:
a computer-implemented relational database; said information being organized within said relational database in accordance with a logical data model;
a subject area within said logical data model comprising a plurality of entities and relationships defining the manner in which information related to activities hosted by said hospitality business to serve needs of a Group Client is stored within said database.

6. A method for managing information for a hospitality business, said method comprising the steps of:
establishing a computer-implemented relational database for storing and organizing said information; and
establishing a logical data model defining the manner in which said information is stored and organized within said relational database, said logical data model including:
a subject area comprising a plurality of entities and relationships defining the manner in which information related to dining services and products provided by said hospitality business is stored within said database.

7. The method for managing information for a hospitality business according to claim 6, wherein said information related to dining services and products provided by said hospitality business includes information concerning dining reservations, dining transactions, menu items, and dining guest check details.

8. The method for managing information for a hospitality business according to claim 6, wherein said information related to dining services and products provided by said hospitality business includes information concerning hospitality employees who served a dining customer, a table number occupied by the dining customer, and the number of guests in a dining party.

9. A method for managing information for a hospitality business, said method comprising the steps of:
establishing a computer-implemented relational database for storing and organizing said information; and
establishing a logical data model defining the manner in which said information is stored and organized within said relational database, said logical data model including:
a subject area comprising a plurality of entities and relationships defining the manner in which information related to financial transactions and activities associated with a customer's room stay is stored within said database.

10. A method for managing information for a hospitality business, said method comprising the steps of:
establishing a computer-implemented relational database for storing and organizing said information; and
establishing a logical data model defining the manner in which said information is stored and organized within said relational database, said logical data model including:
a subject area comprising a plurality of entities and relationships defining the manner in which information related to activities hosted by said hospitality business to serve needs of a Group Client is stored within said database.
